(19) United States
(12) Patent Application Publication
(10) Pub. No.: US 2017/0228953 A1
(43) Pub. Date: Aug. 10, 2017

(54) PROXIMITY ACCESS CONTROL DEVICES, SYSTEMS AND RELATED METHODS

(71) Applicant: 8857911 CANADA INC., Laval (CA)

(72) Inventor: JEFFREY LUPOVICI, MONTREAL (CA)

(21) Appl. No.: 15/501,950

(22) PCT Filed: Aug. 7, 2015
(86) PCT No.: PCT/CA2015/050750

§ 371 Date: Feb. 6, 2017

Related U.S. Application Data
(60) Provisional application No. 62/034,514, filed on Aug. 7, 2014.
(60) Provisional application No. 62/067,160, filed on Oct. 22, 2014.

(51) Int. Cl. G07C 9/00

(52) U.S. Cl. CPC G07C 9/00309; G07C 9/00896

(57) ABSTRACT

Access control systems and devices are provided. In accordance with one embodiment, a retrofit access control device is provided. The retrofit access control device is configured for interfacing with a legacy access control system having a legacy access control device that controls access to at least one access point, the legacy access control device being configured to interface with a legacy credentials device according to a first protocol to obtain from the legacy credentials device credentials information. The retrofit access control system comprising a reader configured for interfacing according to a second protocol with a retrofit credentials device to obtain from the retrofit credentials device credentials information and a processor for processing the credentials information obtained from the retrofit credentials device to generate an access signal compatible with the legacy access control system.

### FIELD OF THE INVENTION

The invention generally relates to proximity access control devices, systems and related methods.

### BACKGROUND

Access control is the selective restriction of access to places or resources. For instance, the restriction of access to places can include restricting entrance to a property, a building, a room, a cabinet drawer, or a device to authorized persons. Typically, an access control system restricts access to places within a building by determining who is allowed to enter or exit, where they are allowed to exit or enter, and when they are allowed to enter or exit.

Unlike mechanical locks and keys, electronic access control typically use credential devices (e.g., electronic access cards, FOBs, RFID devices, smart cards, etc.) in combination with a reader. Regardless of the type of credential device used, the access control system grants access based on the credential device being presented to a reader. In general, when access is granted, the door is unlocked for a predetermined time or may be reset by the door closing and the transaction is recorded. On the other hand, when access is refused, the door remains locked and the attempted access is recorded. More specifically, when the credential device is presented to the reader of the access control system, the reader sends the credential device's information, usually a number comprising of a site code identifier as well as a unique credential number, to a controller (e.g., a processor). The controller compares the credential device's number to an access control list, grants or denies the presented request, and sends a transaction log to a database. When access is denied based on the access control list, the door remains locked.

If there is a match between the credential device and the access control list, the control panel operates an electric relay or solenoid that in turn unlocks the door. Often the reader provides feedback, such as a sound or a certain coloured flashing LED depending on whether access is granted or denied.

Typically, the presenting of the credential device to a reader requires a person to hold or swipe the credential against the reader. Such a process can be tedious and/or cumbersome when a person is required to remove his/her credential device from his/her pocket, handbag or badge holder and manually place the credential device in close proximity (e.g., 2 to 3 inches) of a reader several times in a day. Furthermore, when an authorized user uses his/her credential device, existing access control systems typically do not provide a mechanism to prevent an unauthorized user (i.e., a tailgater) from following the authorized user through the door or access point.

Another disadvantage with existing access control systems with close proximity readers (e.g., 2 to 3 inches) is that they cannot be easily upgraded to be used with existing active RFID credential devices. Moreover, many of existing active RFID systems use directional UHF antennas which in some cases can be very difficult and time consuming to install. In addition, some active RFID systems have problems communicating with credential devices which are in a handbag or a back pocket.

Therefore, there is a need in the industry to provide access control devices, systems and methods that alleviate at least some of the deficiencies with existing solutions.

### SUMMARY

In accordance with one broad aspect, the present invention relates to a retrofit access control device for interfacing with a legacy access control system having a legacy access control device that controls access to at least one access point. The legacy access control device is configured to interface with a legacy credentials device according to a first protocol to obtain from the legacy credentials device credentials information. The retrofit access control system comprises a reader configured for interfacing according to a second protocol with a retrofit credentials device to obtain from the retrofit credentials device credentials information. The first protocol is such that a legacy access control device cannot interface with the retrofit credentials device to obtain credentials information. The second protocol is such that the reader cannot interface with the legacy credentials device to obtain credentials information from the legacy credentials device.

The retrofit access control system also comprises a processor for processing the credentials information obtained from the retrofit credentials device to generate an access signal compatible with the legacy access control system.

In accordance with a specific example of implementation, the legacy access control device includes a legacy reader communicating with a legacy controller, the processor being configured to communicate with the legacy controller, the access signal being configured such that it can be processed by the legacy controller.

In accordance with a specific example of implementation, the legacy access control device includes a legacy reader, the processor being configured to communicate with the legacy reader, the access signal being configured such that it can be processed by the legacy reader.

In accordance with a specific example of implementation, the legacy controller is configured for processing the access signal to make an access control decision to grant or deny access to the access point.

In accordance with one broad aspect, the present invention relates to a method for interfacing with a legacy access control system, the legacy access control system having a legacy access control device that controls access to at least one access point. The legacy access control device is configured to communicate with a legacy credentials device according to a first protocol to obtain from the legacy credentials device credentials information. The method comprises communicating according to a second protocol with a retrofit credentials device to obtain from the retrofit credentials device credentials information, the first protocol being such that a legacy access control device cannot communicate with the retrofit credentials device to obtain credentials information. The second protocol is such that the reader cannot communicate with the legacy credentials device to obtain credentials information from the legacy credentials device. The method also comprises processing the credentials information obtained from the retrofit credentials device to generate an access signal compatible with the legacy access control system.

In accordance with a specific example of implementation, the legacy access control device includes a legacy reader communicating with a legacy controller and the method further comprises communicating the access signal to the legacy reader.

In accordance with a specific example of implementation, the legacy access control device includes a legacy controller and the method further comprises communicating the access signal to the legacy controller.

In accordance with one broad aspect, the present invention relates to a method for retrofitting a legacy access control system with a new access control device, the legacy access control system having a legacy access control device that controls access to at least one access point. The legacy access control device is configured to interface with a legacy credentials device according to a first protocol to obtain from the legacy credentials device credentials information. The new access control device includes a reader configured for interfacing according to a second protocol with a new credentials device to obtain from the new credentials device credentials information. The first protocol is such that a legacy access control device cannot interface with the new credentials device to obtain credentials information. The second protocol is such that the reader of the new access control device cannot interface with the legacy credentials device to obtain credentials information from the legacy credentials device. The new access control device further includes a processor for processing credentials information obtained from the new credentials device, the processor having an output. The method comprises connecting the output of the processor to an input of the legacy access control device. The input is configured to accept an input signal derived from an interaction between the legacy access control device and the legacy credentials device. The input signal conveys credentials information derived from the legacy credentials device. The method also comprises, in response to an interaction between the new access control device and the new credentials device according to the second protocol, outputting a signal which conveys credentials information derived from the new credentials device, the signal being configured such that it can be accepted by the input.

In accordance with a specific example of implementation, the legacy access control device includes a legacy controller in communication with a legacy reader and wherein connecting the output of the processor to an input of the legacy access control device includes connecting the output of the processor to an input of a legacy access controller.

In accordance with a specific example of implementation, the interaction between the legacy access control device and the legacy credentials device includes the legacy reader reading a legacy credential device.

In accordance with one broad aspect, the present invention relates to a method for retrofitting a legacy access control system with a new access control device, the legacy access control system having a legacy access control device that controls access to at least one access point. The legacy access control device is configured to interact with a legacy credentials device according to a first protocol to obtain from the legacy credentials device credentials information. The legacy access control device includes an input for receiving an input signal derived from an interaction with the legacy credentials device the input signal conveying credentials information provided by the legacy credentials device during the interaction. The new access control device includes a reader configured for interfacing according to a second protocol with a new credentials device to obtain from the new credentials device credentials information. The first protocol is such that a legacy access control device cannot interact with the new credentials device to obtain credentials information. The second protocol is such that the reader of the new access control device cannot interact with the legacy credentials device to obtain credentials information from the legacy credentials device. The new access control device further includes a processor configured for processing credentials information obtained from the new credentials device to generate at an output an access signal that is compatible with the input such that the credentials information can be communicated to the input. The method comprises connecting the output of the processor to the input. The method also comprises preventing the legacy access control device from interacting with a legacy credentials device.

In accordance with a specific example of implementation, the legacy access control device includes a legacy controller communicating with a legacy reader and wherein connecting the output of the processor to an input includes connecting the output of the processor to an input of a legacy access controller.

In accordance with a specific example of implementation, the legacy access control device includes a legacy controller and a legacy reader wherein preventing the legacy access control device from interacting with a legacy credentials device includes disconnected the legacy reader from the legacy controller.

### BRIEF DESCRIPTION OF THE DRAWINGS

A detailed description of embodiments of the invention is provided below, by way of example only, with reference to the accompanying drawings, in which:

FIG. 1 illustrates an access control system in accordance with an embodiment of the invention.

FIG. 2A shows an example of an access point in accordance with a specific example of implementation of the invention.

FIGS. 2B, 7A, 8A, 8C, 8D, 9A, 10A, 11A, 12, 13A, 14A, 16A, 16C, 16G, 16I, 17A,18A and 19A illustrate examples of the access control system in accordance with embodiments of the invention.

FIG. 3 illustrates a reader in accordance with an embodiment of the invention.

FIG. 4 illustrates a credential device in accordance with an embodiment of the invention.

FIG. 5 illustrates a controller in accordance with an embodiment of the invention.

FIGS. 6A, 6B and 6F show examples of a legacy access control system with a modified reader in accordance with specific examples of implementation of the invention.

FIGS. 6C and 6D are flowcharts of example processes for using the reader with a legacy access control system.

FIG. 6G is a flowchart of an example process for installing a new reader to a legacy access control system.

FIGS. 6I and 6K are example waveform outputs from a legacy controller which may be read by the reader in accordance with specific examples of implementation of the invention.

FIGS. 6E, 6H, 6I, 6L, 6M 8E, 9C, 9D, 11C, 13C, 14B, 16D, 16E, 16J, 16K, 16L, 16M, 17B, 17C, 17D, 17E and 18C illustrate examples of database tables in accordance with embodiments of the invention.

FIGS. 7B, 8B, 9B, 10B, 11B, 13D, 13E, 14C, 15, 16B, 16F 17F, 18B and 19C, 19D and 19E illustrate flowcharts of the access control system in accordance with embodiments of the invention.

FIG. 13B illustrates an example of a credential device in accordance with an embodiment of the invention.

FIG. 19B illustrates an example of a video image in accordance with an embodiment of the invention.

It is to be expressly understood that the description and drawings are only for the purpose of illustrating certain embodiments of the invention and are an aid for understanding. They are not intended to be a definition of the limits of the invention.

### DETAILED DESCRIPTION

### Access Control System

In general, an electronic access control system or device comprises one or more readers, controllers, and credential devices. The access control system may also include a computing entity (e.g., a server or other computing device), which may be used to configure the access control system, among other things. The access control system is typically configured in a way to restrict access to an access point. Access control decisions are made, in general terms, by comparing an identifier of the credential device obtained by the reader to an access control list. This comparison of the identifier to the access control list can be done by a server, by a controller, or by a reader with a built in database.

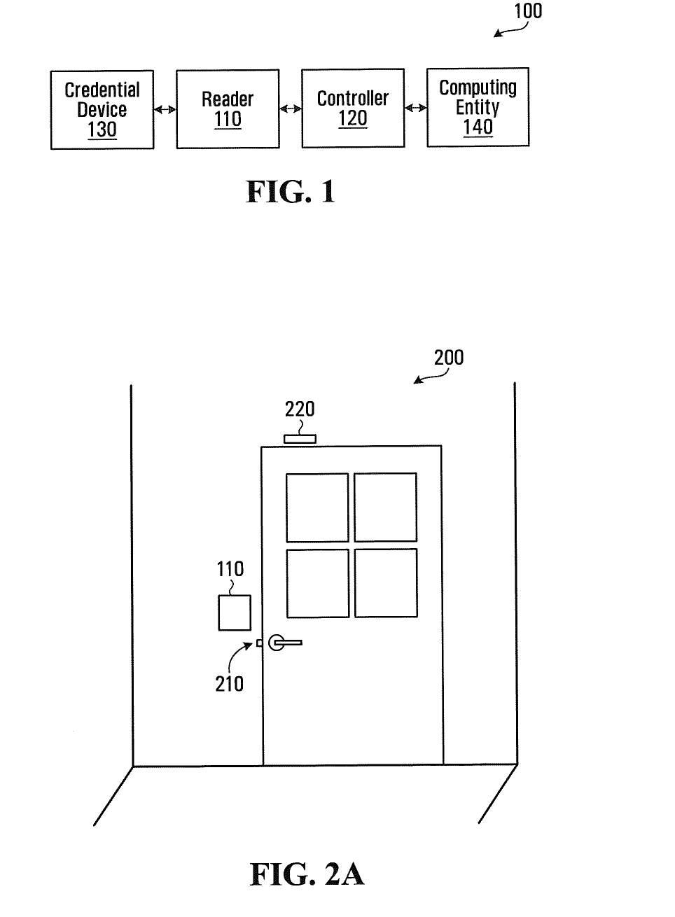

FIG. 1 shows an access control system 100 in accordance with a specific example of implementation of the invention. As illustrated, the access control system 100 may include a credential device 130, a reader 110 and a controller 120. In some cases, the access control system 100 may be referred to as an access control device. The access control system 100 may also include an optional computing entity 140. The reader 110, the controller 120, the credential device 130, the computing entity 140 and the access point may be implemented as follows:

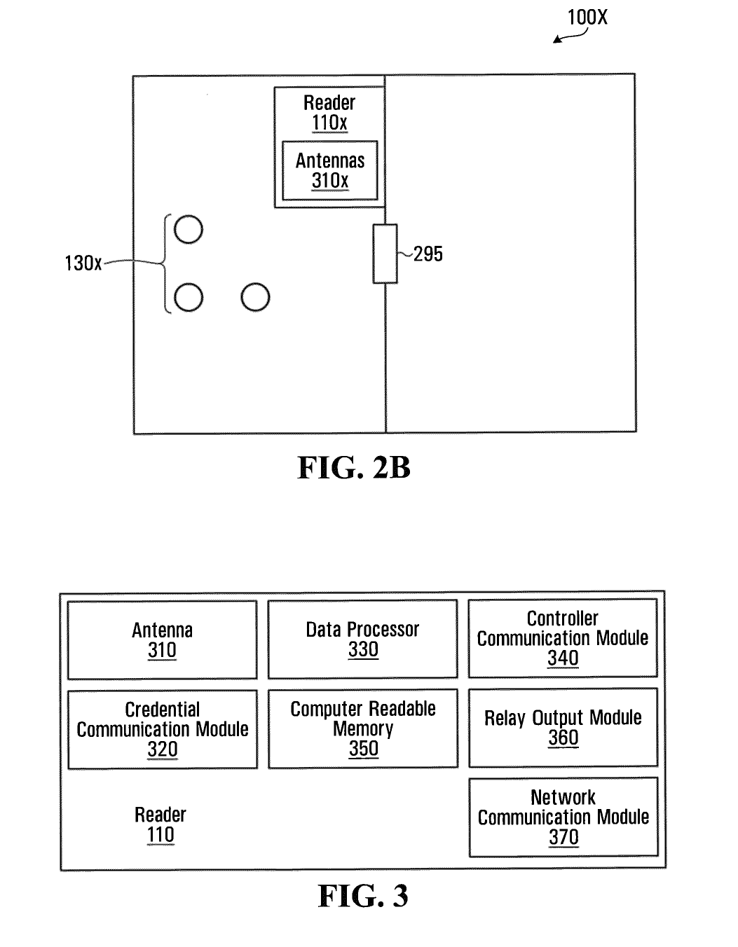

Access Point
An access point is a physical barrier that restricts access which may include a door, turnstile, parking gate, above ground vehicle barrier, buried vehicle barrier (e.g., bollards), hydraulic truck stopping systems, elevator, roof hatches, cabinets, drawers, lockers, containers or any other suitable physical barrier.
FIG. 2A illustrates an example of an access point implemented in the form of a door 200. In this example, the electronic access controlled door 200 contains several elements. At its most basic, there is an electric lock 210 and the electric lock 210 may be unlocked by the access control system 100 via the credential device 130 being read by the reader 110 and authorized by the controller 120. Typically one or more programmable relays are used for the direct locking control. In addition, the access point may include one or more sensors 220. The one or more sensors 220 may be used as inputs to the access control system 100 to provide additional security and/or functionality. For instance, a magnetic door switch or sensor may be used to monitor the position of the door 200, at which point closing of the door 200 during the open delay period would override the opening time delay and thus lock the door 200 by resetting the time delay to zero. Similarly, optical or photoelectric sensors may be used to monitor door position or whether objects are position between the doors (which is commonly used in elevators).
Many different types of sensors may be used at the access point of the access control system 100, including: infrared photo beam or infrared photo barrier, ultrasonic ranging detectors, load sensors that detect vehicles, and persons, IP video camera surveillance with intelligent video analytics, 3D laser area detection, vibration sensing utilizing mems sensors, piezo electric elements, jitter type sensors, buried loop, magnetic vehicle sensors, or any other suitable sensor.

Other components at the access point of the access control system 100 may include: request to exit sensors, interconnection to fire life safety systems, area lighting control based upon occupancy (parking lot, corridor, offices, etc.).

For many access points, such as doors, only the entry way to the door is controlled and the exit is uncontrolled. In cases where the exit is also controlled, in some access control systems a second reader is typically used on the opposite side of the door. In cases where the exit is not controlled a device called a request-to-exit may be used. Request-to-exit devices can be a push-button or a motion detector. When the button is pushed, or the motion detector detects motion at the door, the door is temporarily unlocked to allow the person to exit. Exiting a door without having to electrically unlock the door is called mechanical free egress. As discussed later on, in some embodiments of the invention, the reader 110 that may be used for gaining entrance to an access point may also be used for exiting the access point.

Reader
Access control readers may be classified by the functions they are able to perform. Generally, access control readers can be categorized as follows:
   Basic readers—simply reads credential devices' identifiers and forwards it to the controller.
   Readers with control inputs/outputs—typically have inputs and outputs necessary to control door hardware (lock, door contact, exit button, etc.), but do not make any access decisions. When a user presents a credential device the reader sends information to the controller, and waits for its response.
   Intelligent readers—have all inputs and outputs necessary to control door hardware and also have a computer readable memory and a data processer which can make access decisions. Although intelligent readers may make access decision, they may still be connected or connectable to the controller or the computing device. For example, the controller or computing device may send configuration updates and/or retrieve events from the readers.
FIG. 3 illustrates a reader 110 in accordance with an embodiment of the invention. The desired functionality of the reader 110 in general dictates the required hardware in the reader 110, and the reader 110 may include additional elements not illustrated in FIG. 3 and/or some of the elements illustrated in FIG. 3 may be excluded (i.e., some elements are optional).
The reader 110 includes one or more wakeup antennas 310 connected to one or more credential communication modules 320 for detecting the presents of the credential device 130. The wakeup antennas 310 may be any suitable radio frequency (RF) antenna or any other suitable antenna. In general, the one or more wakeup antennas 310 interact with the credential device 130 to wake-up the credential device 130 from a low-power standby mode to a mode when the credential device 130 is in range, which then allows for communications between the credential device 130 and the reader 110 via the one or more wakeup antennas 310. For instance, the one or more wakeup antennas 310 may communicate a low frequency (125 khz) wakeup pattern(s) to the credential device 130. Typically, one wakeup antenna is used for a single door where no other access controlled doors are in proximity of the range selected to open the single door. On the other hand, two wakeup antennas are typically used where a more precise access area resolution is required. For example, two wakeup antennas may be used where each wakeup antenna is installed one per side of an entry point. Each of the wakeup antennas may have adjustable range settings making it possible to accommodate access points where the antennas are not installed at equal distances from the access point (e.g., one antenna installed on the far right side of a sliding door and the second antenna installed closer to the door on the left side).
The wakeup antenna 310 is connected to the credential communication module 320 such as a Bluetooth hardware module, a ZigBee hardware module, a low frequency communication module (e.g., an ASK communication module in the 110 to 150 kHz range), an unlicensed frequency band communication module, or any other suitable device. The credential communication module 320 is used to communicate with the reader 110 via the antenna 310. The communication module 320 is connected to a data processor 330. The data processor 330 may be implemented as a central processing unit (CPU), microcontroller, field-programmable gate array (FPGA), application-specific integrated circuit (ASIC), or any other suitable device. The data process 330 is also connected to a controller communication module 340 for communicating with the controller 120. The controller communication module 340 in general is a module that communicates with the controller 120 via a communication medium (hard wired or wirelessly). The controller communication module 340 may be any type of communication module that is able to send and/or receive signals wired or wirelessly. More specifically, the controller communication module 340 may be implemented as a hardware module with standard Wiegand and/or RS-485 outputs and may be capable of outputting serial and Weigand, at the same time.
The data processor 330 may also be connected to a relay output module 360. The relay output module 360 controls one or more relays, where the one or more relays may control the locking/unlocking and/or movement of the door or access point. The relay output module 360 may be used to control other relays or drivers that are under programmable control (e.g., alarm systems, etc.). For instance, two electrical outputs over a single wire in the provided wiring harness of the reader 110 may be set to provide a High (+12 volt), or Low ground and may then be momentary or latched or timed based upon the need of the installer for the particular entry point or job site.
More specifically, in some embodiments, the reader 110 may have two relay outputs each with Single Pole Double Throw (S.P.D.T.) dry contacts. Through the utilization of Dual Coil Latching relays, the reader 100 may provide a very short duration pulse to the relay to change its state. Each relay may have two S.P.D.T. independent outputs. An interesting aspect of this configuration is that the data processor 330 of the reader 110 may utilize one set of these dry contacts so that it may be able to ascertain with certainty that the relay did in fact follow the requested command and change states. It is appreciated that such a configuration when retrofitted to an existing reader (as discussed elsewhere in this document) may allow for relays to not have to constantly draw current from the legacy proximity reader; consequently, the power supply of the legacy access controller would not have to be upgraded.
As noted above, depending on the desired functionality of the reader 110, the reader 110 may also include a computer readable memory 350 for storing one or more databases of one or more access control lists. The data processor 330 is in communication with the memory 350 and is able to compare an identifier of the credential device 130 obtained by the reader 110 to the one or more access control lists, in order to make the access control decision. In many cases, the reader is implemented as a stand alone reader with an internal database that does a lookup of a hash table and is able to provide instance access without communication with any other external devices. The reader may also include an internal RTC (Real Time Clock) that may allow for programming access levels by time of day, day of week, and holidays, etc.
In the cases where the reader 110 does not have a database storing access control lists, the data processor 330 would communicate the identifier obtained from the credential device 130 to the controller 120, which would then typically make the access control decision.
The reader 110 is also connected to a power source, which is well known in the art.
The reader 110 may also include a network communication module 370, such that the reader 110 is able to be networked to other readers. For example, the network communication module 370 may be a wired or wireless communication module, such that the reader 110 becomes part of a mesh network with other readers and/or the controller 120. In the case that the network communication module 370 is a wireless communication module, a Wi-Fi module, ZigBee module, a proprietary spread spectrum module, or any other suitable wireless communication module may be used.
In the case that the network communication module is a wired communication module, an Ethernet module, or any other suitable wired communication module may be used. Such a configuration may allow the reader 110 to become part of a self-installing network via wireless or wired links. That is, each time a new reader is installed on a site it may be able to become part of the mesh network. As more and more readers at each access point are added to the mesh network, the range of the network for reading the credential device 130 grows. In the event a specific reader in the mesh network is unable to communicate with the controller 120 via a direct radio signal, then other closer readers may be able to pick up the communicated message and forward it to the controller 120.
In some embodiments, the reader 110 may have additional features such as an LCD and function buttons for data collection purposes, touch screen, LED indicator, camera, speaker, and/or microphone.
The reader 110 may also include a SHA (secure hash algorithm) secure chip or engine may be used to provide additional security through means of encryption as well as a challenge response authentication.
The connections of the various components in the reader 110 may be over one or more data buses.
The implementation of the various components in the reader 110 may include the use of: Austria Micro Systems 3D wake up processor AS3932, oscillator, Receiver MICRF 211AYQS, high current Darlington drivers ULN2003, Driver International rectifier AS4426, Premo or equivalent 125 khz wake up antenna (winding on Ferrite rectangular bar, either packaged via heat shrink or Epoxy encapsulation), Maxim Dallas Semiconductor SHA encryption chip DS2432 or MAX66240 (containing a unique 64 bit factory identifier (I.D.) which allows multiple readers in a Wi-Fi or other network either RF or hardwired to be uniquely identified and provides for high security communication through the implementation of encryption, and authentication via the SHA engine).
The reader 110 may be configured to interface with a hand wave reader such that when the hand wave reader is activated by a person waving a hand in front of the hand wave reader, the reader 110 wakes up and transmits a wakeup signal which may be read by any nearby credential devices 130.

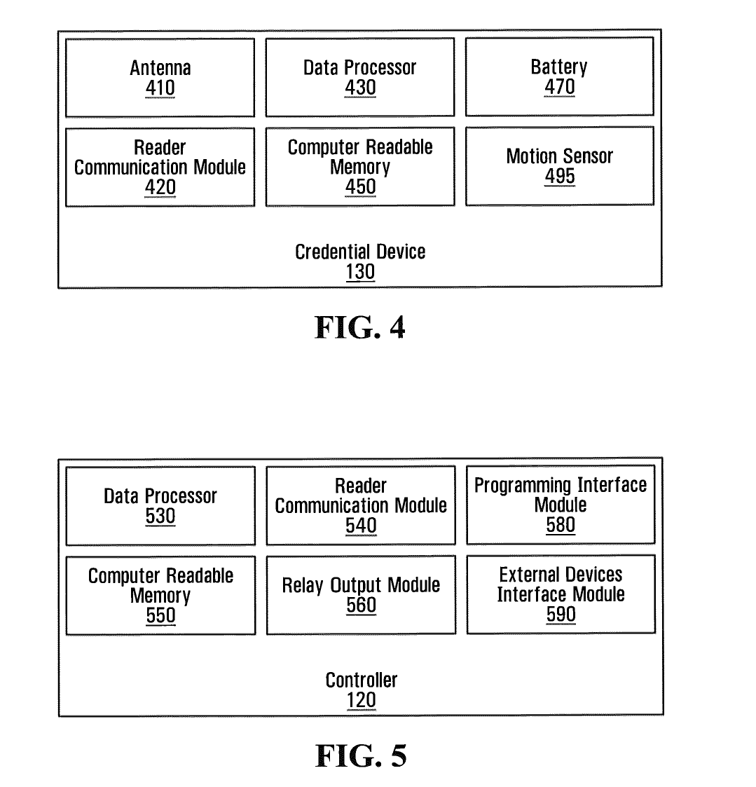

Credential Device
The credential device 130 (also referred to as credentials device) may be implemented as any small portable hardware device. For instance, the credential device 130 may be implemented as an electronic access card, FOB (i.e., a key fob), RFID device, band, badge, smart card, or any other suitable device. The credential device 130 uses a suitable power source, such as a battery to supply its internal circuitry and allow communication with the reader 110.
FIG. 4 illustrates the credential device 130 in accordance with an embodiment of the invention. The credential device 130 may include one or more antennas 410, one or more reader communication modules 420, a data processor 430, computer readable memory 450, a battery 470 and a motion sensor 495. It is appreciated that the credential device 130 may include additional elements not illustrated in FIG. 4 and/or some of the elements illustrated in FIG. 4 may be excluded (i.e., some elements are optional).
The one or more antennas 410 may be implemented by any suitable antenna arrangement, including 1D (1-dimensional), 2D (2-dimensional) or 3D (3-dimensional) antennas. The one or more antennas 410 may be connected to respective one or more reader communication modules 420 for processing the received/transmitted signals to and from the one or more antennas 410. The reader communication modules 420 may be implemented as a Bluetooth module, a ZigBee module, a low frequency communication module (e.g., an ASK communication module in the 110 to 150 kHz range), an unlicensed frequency band communication module, or any other suitable device. The combination of an antenna 410 and a communication module 420 may be referred to as a wakeup chip or wakeup receiver, which may “wake up” in the presence of a signal from a wakeup antenna 310 of the reader 110.
The data processor 430 may be implemented as a central processing unit (CPU), microcontroller, field-programmable gate array (FPGA), application-specific integrated circuit (ASIC), or any other suitable device. The data processor 430 may communicate with the one or more reader communication module 420, the computer readable memory 450 and the motion sensor 495 over one or more data buses.
The computer readable memory 450 may be used to store one or more identifiers for the credential device 130. For example, the credential device 130 may be provided with a factory programmed unique identifier. The factory programmed unique identifier may be laser etched and in this case would not be able to be altered. The factory programmed unique identifier may be used to authenticate and configure a new identifier when the credential device 130 is programmed to be used with one or more readers 110. For example, the new identifier may be based upon a particular site code and a user credential code of a particular access control system or of unique identification needs of a site or installing company. In specific non-limiting examples of implementation, the credential device 130 is configured to store two identifiers.
The battery 470 may be used to power the different components of the credential device 130 and can be any suitable battery including but not limited to lithium batteries, alkaline batteries, metal hydride batteries, nickel metal hydride batteries, printed batteries, storage capacitor with energy harvesting (e.g., from photons, temperature, movement, etc.), etc. In some embodiment the credential device 130 could be powered by the wave emission from the reader 110. More specifically, in these embodiments, a millimeter wave emission from the reader 110 (with a dipole antenna) could emit a carrier signal (e.g., at around 50 Ghz) capable of providing power to the credential device 130 at a distance matching or exceeding the distance of the credential devices 130 waking up to the low frequency (e.g., 125 khz) wakeup pattern(s).
In some embodiments, the credential device 130 also includes a motion sensor 495 for detecting different types of movement and/or motion of the credential device 130. In these embodiments, the credential device 130 may go into an ultra-low power standby mode (typically, several nano amps) and may then be woken up from the ultra-low power standby mode to the low standby mode when the motion sensor 495 detects motion. For instance, the motion sensor 495 may be connected to the data processor 430, such that the motion sensor 495 sends a signal to the data processor 430 indicating that the credential device 130 should be woken up from the ultra-low power standby mode. When the credential device 130 is in motion (or a specified period of time after motion) the credential device 130 is in a low power standby mode. In the low power standby mode the wakeup chip listens for coded signal (e.g., a wake-up pattern) from the one or more of the wake-up antennas 310.
The connections of the various components in the credential device 130 may be over one or more data buses.
The credential device 130 may include one or more input mechanisms such as a button. The button may be actuated to provide an auxiliary function. For example, the auxiliary function may be triggering of an alarm by the user holding the button down for a set period of time (e.g., 4 seconds, or any other suitable time) to causes the credential device 130 to send a signal to the reader 110 for the controller 120 to cause an alarm to be triggered. By way of another example, the button may be consecutively actuated (e.g., pushed) twice in a specific period of time (e.g., 1 second, or any other suitable time) to causes the credential device 130 to send a signal to the reader 110 for the controller 120 to cause an alarm system to be armed.
Multi-factor or dual-credential authentication may also be used, in which the credential device 130 is required to be used with another credential such as a piece of knowledge (e.g. a PIN or number), a facet of a person's physical being (e.g., biometric feature) or a secondary hardware implemented credential device. Biometric technologies include fingerprint, facial recognition, iris recognition, retinal scan, vein scan, voice, hand geometry or weight sensors (which may be used for specific applications such as freight elevators, vehicle or containers). The built-in biometric technologies found on newer smartphones can also be used as credentials (e.g., the fingerprint reader). Secondary hardware credential may include standard proximity cards, FOBs, or tokens, remote control device, Bluetooth mobile device, 3D bar codes, QR codes, and software running on a smart phone or tablet that can also turn a user's smart phone or tablet into an access device. In the case of a multi-factor or dual-credential authentication the reader 110 or a separate device may be used to read the secondary credential.
Any of the aforementioned information stored in the credential device 130 may be referred to as credential information.

Controller
FIG. 5 illustrates the controller device 120 in accordance with an embodiment of the invention. The controller may include a data processor 530, computer readable memory 550, a reader communication module 540, a programming interface module 580, a relay output module 560 and an external devices interface module 590. It is appreciated that the controller 120 may include additional elements not illustrated in FIG. 5 and/or some of the elements illustrated in FIG. 5 may be excluded (i.e., some elements are optional).
The data processor 530 may be implemented as a central processing unit (CPU), microcontroller, field-programmable gate array (FPGA), application-specific integrated circuit (ASIC), or any other suitable device. The data process 530 may be connected to the computer readable memory 550, the reader communication module 540, the programming interface module 580, the relay output module 560 and the external devices interface module 590 by one or more data buses. The controller 120 has a reader communication module 540 for communicating (i.e., transmitting and receiving data) with the reader 110 via the reader's controller communication module 340. The reader communication module 540 may be any type of communication module that is able to send and/or receive signals wired or wirelessly. More specifically, the reader communication module 540 may be implemented as a hardware module with standard Wiegand and/or RS-485 outputs and may be capable of outputting serial and Weigand, at the same time. In other words, Wiegand protocol, RS-485, RS-232 or any other suitable protocol may be used for transmitting/receiving the data between the controller 120 and the reader 110.
The relay output module 560 may be present in the controller 120 for controlling one or more relays, where the one or more relays may control the locking/unlocking and/or movement of the door or access point. The relay output module 560 may be used to control other relays or drivers that are under programmable control (e.g., alarm systems, etc.).
The computer readable memory 550 may include one or more databases for storing one or more access control lists. The data processor 530 may communicate with the computer readable memory 550 to compare an identifier of the credential device 130 obtained by the reader 110 to the access control list(s), in order to make the access control decision. In embodiments where the reader 110 contains a database for storing one or more access control lists, the comparison of the identifier may take place at the reader 110 and not at the controller 120.
The external devices interface module 590 provides connectivity to other external devices that may enhance the operation of the access control system 100. The external devices interface module 590 may connect to various sensors and/or components, such as those discussed above under the section entitled “Access Point”. For example, the external devices interface module 590 may connect to optical sensors or optical barriers, such as those found in elevator doors. In this case, the credential device 130 would only wake up when the user carrying the credential device 130 walks across the optical sensors, which may provide enhanced anti-tailgating capability under software control. Another example is the external devices interface module 590 may connect to vehicle road sensors for parking applications.
The external devices interface module 590 may also provide connectively to an alarm system or speaker. In the cases where the external devices interface module 590 is connected to an alarm system, it may be configured to send an indication to the alarm system when an alarm event occurs (e.g., the door being held open). In the case that the external devices interface module 590 is connected to a speaker, an alarm sound could be made in the case of an alarm event or an access denied sound can be made in the case that access is not granted to an unauthorized attempt with the credential device 130.
The controller 120 is also connected to a power source, which is well known in the art.
It is appreciated that the controller 120 and the reader 110 may be incorporated into a single hardware device in some embodiments. For example, when the reader 110 is implemented as an intelligent reader, the controller 120 may be omitted, as the reader 110 may contain at least some of the functionality of the controller 120. Furthermore, in other embodiments, features described herein as being implemented in the controller 120 may be implemented in the reader 110 and vise versa.
It is also appreciated that when the access control system 100 is incorporated into the legacy access control systems, the controller 120 may be omitted, as a legacy controller may be used. However, in these cases, certain functionality of the controller 120 may then be incorporated into the reader 110, and as such, features discussed as being part of the controller 120 may be implemented in these cases in the reader 110.
Although in FIG. 1 the access control system 100 is shown with only a single credential device 130, a single reader 110 and a single controller 120, the access control system 100 may actually include multiple credential devices, multiple readers and multiple controllers.
In some embodiments, the term access control device may be used to refer to a device that includes the reader 110 and the controller 120.

The Computing Entity
The computing entity 140 may be one or more servers or any other computing device. For instance, the computing entity 140 may be a cell phone, tablet, laptop or any other portable or non-portable computing device.
In some embodiments, the computing entity 140 is implemented as one or more server or host computers. For instance, the server computer may have a computer readable memory having a database storing an access control list. The access control list may be accessed by a processor of the server to compare an identifier received from the controller which corresponds to a credential device, in making the access control decision. In other embodiments where the access control decision is made at either the controller 120 or the reader 110, a computing entity 140 may not be needed to make the access control decision and the computing entity 140 may be omitted from the access control system 100. In other embodiments, the computing entity 140 is implemented as one or more server or host computers for maintaining a log or record of all access control decisions; even though the access control decisions may not necessarily be made by the computing entity 140.
In some embodiments, the computing entity 140 may be implemented as a cell phone, tablet, or any other portable or non-portable computing device. In these embodiments, the computing entity may be connected to the reader 110 and/or controller 130 by a wired or wireless connection (e.g., Wi-Fi, Bluetooth, etc.). In this case, the computing entity 140 may be used in the process of programming the credential devices 130 to the readers 110 and/or controllers 120, which is discussed in further detail elsewhere in this document.

Different possible aspects, features and implementations of the access control system 100 will now be described by way of the following examples:

### Door Access Control System

FIG. 2B illustrates an example of an access control system 100ₓ which includes a reader 110ₓ to be used with a plurality of credential devices 130ₓ for use in access control to a door 295. The access control system 100ₓ is a specific non-limiting implementation of the access control system 100. Similarly, the reader 110ₓ and the credential devices 130ₓ are a specific non-limiting implementation of the reader 110 and the credential device 130, respectively.

In this example, the access control system 100ₓ uses a plurality of credential devices 130ₓ each of which is implemented as active RFID tag with integral battery, and communicate via RF radio linkage to the one or more wakeup antennas 310ₓ of the reader 110ₓ. The wakeup antennas 310ₓ of the reader 110ₓ are configurable to read for a distance of approximately 3 feet to 20 feet for wakeup and automatic identification of the credential device 130ₓ requesting access through the access point 295 (e.g., a door, garage, gate, elevator, machine operation, etc.).

The reader 110ₓ has a built in database (not illustrated) allowing it to be autonomous and capable of learning the credential devices based upon an automated process in which each credential device is learned by a pattern of shaking the credential device while the reader is in the programming mode (as discussed elsewhere in this document). Each unique factory identifier may be read, and then rewritten to the particular site code and card code as is done in the Wiegand 26 bit or greater standard, or other RS-485 type card standards. In other cases, the unique factory identifier is not rewritten, but an additional identifier (e.g., site code and card code) may be added to the credential devices.

The reader 110ₓ is capable of working in stand-alone, or can be piggy backed to an existing Wiegand or RS-485 readers. The reader design may allow for hands free long range access control of new and existing installations.

The access control system 100ₓ is suitable for door access, elevator floor access, gate control, garage parking entry exit, wandering patient, machinery and equipment safety, guard tour, prisoner home monitoring systems, and any other suitable type of access control.

### Retrofitting the Access Control System to Existing Readers/Systems

The access control system 100 is designed to be able to “piggy back” or be retrofitted onto legacy access control systems, such as any legacy access control system that uses industry standard Wiegand or RS-485 readers/controllers. Such legacy readers may include HID, Kantech, Mircom, RBH, Casi-Rusco, Guardall, Keyscan, CDVI, Paradox R915, Paradox R910, Paradox R890 or any other suitable legacy reader.

In is appreciated that the prefix “legacy” is used to define any preexisting access control system, access control devices, readers or credentials devices. Similarly, the prefix “retrofit” is used to define any newly provided access control system, access control devices, readers or credentials devices. The term legacy access control device may be use to refer to legacy access controller and a legacy access reader.

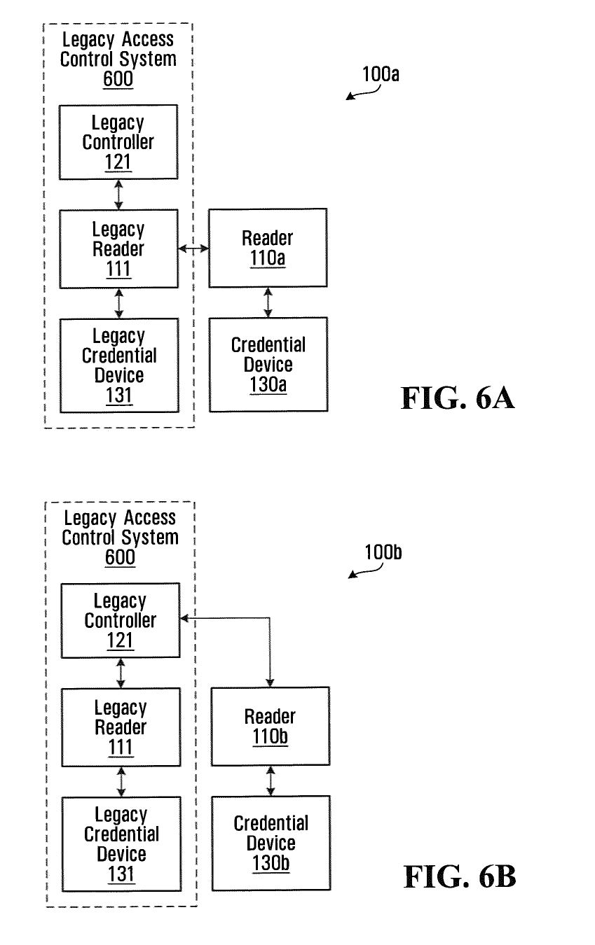

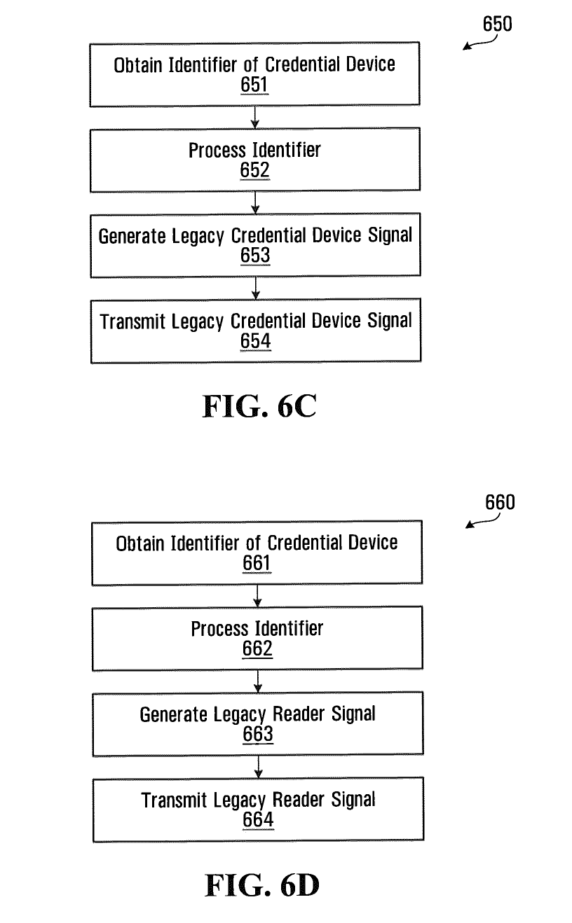

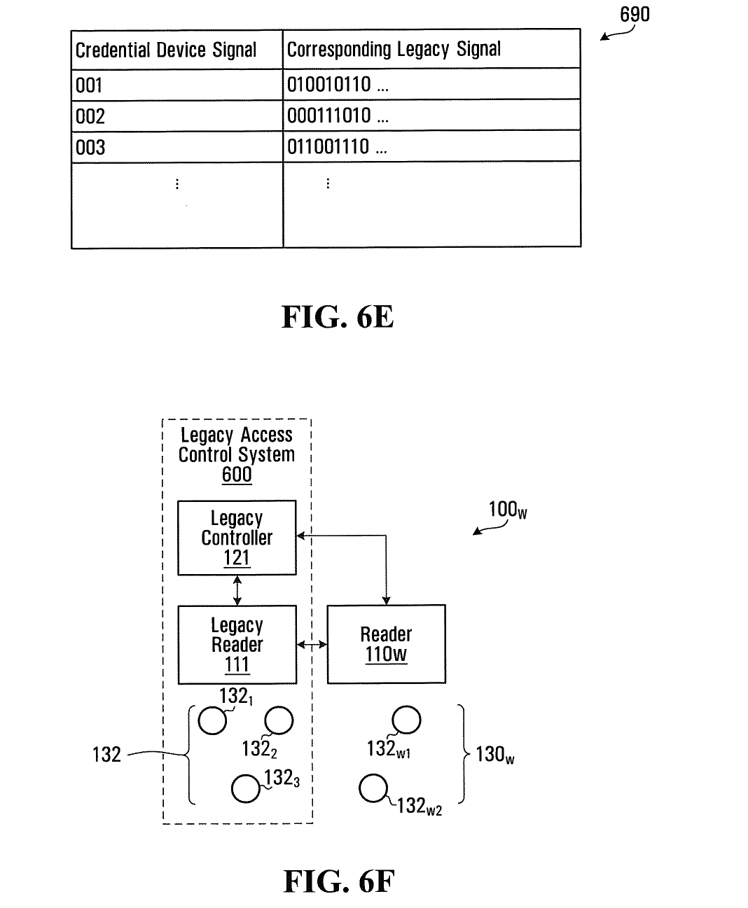

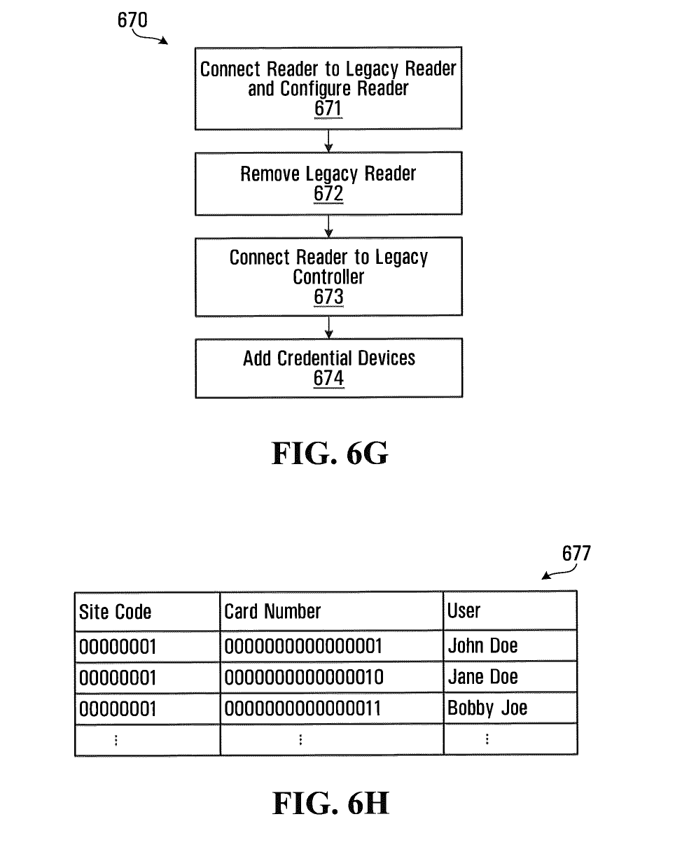

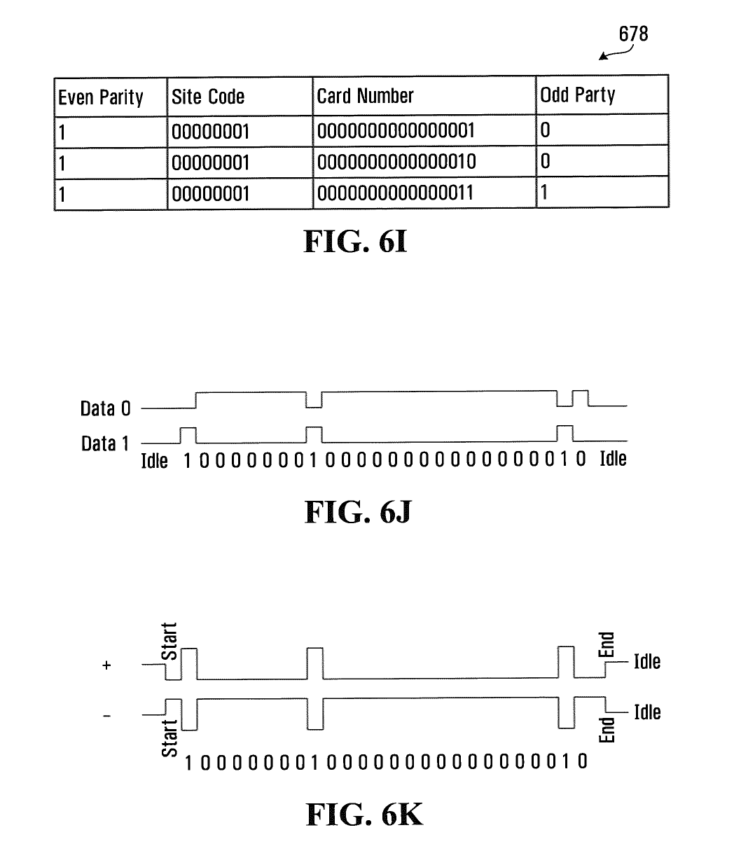

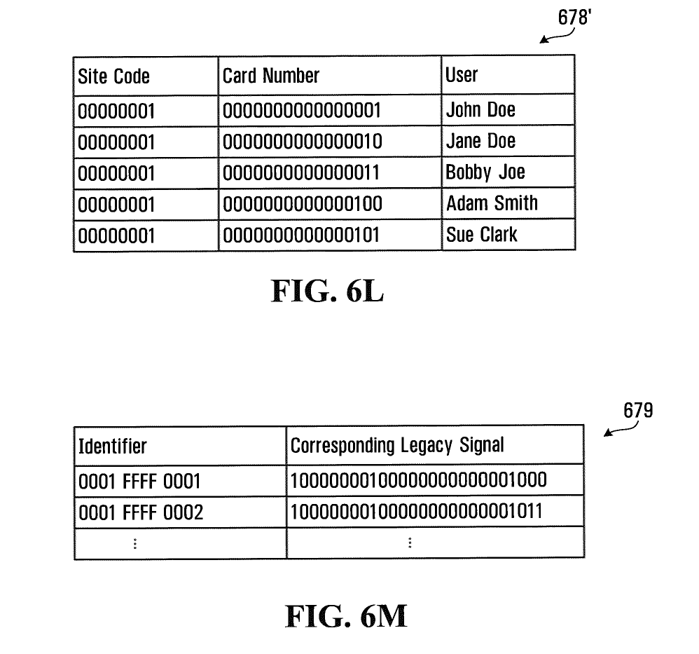

FIG. 6A illustrates a first example of a legacy access control system 600 which is modified to include the reader 110ₐ to be used with the credential device 130ₐ of the access control system 100ₐ. The access control system 100ₐ is a specific non-limiting implementation of the access control system 100. Similarly, the reader 110ₐ and the credential device 130ₐ are a specific non-limiting implementation of the reader 110 and the credential device 130, respectively. In this example, a legacy controller 121 is in communication with a legacy reader 111 via a wired or wireless connection and the reader 110ₐ is connected wired or wirelessly to the legacy reader 111. For instance, the reader 110ₐ may have a communication module which emulates the communications of legacy credential devices (e.g., emulates the signal and protocol of the legacy credential device). Such a configuration, would allow for a legacy credential device 131 to still communicate with the legacy reader 111, while allowing additional credential devices not part of the legacy system, such as the credential device 130ₐ to also communicate with the reader 110ₐ and thus allowing both the legacy credential device 131 and the credential device 130ₐ to be operational. In this example the reader 110ₐ after reading the credential device 130ₐ emulates a legacy credential device. This emulation may include generating a communication message to be sent from the communication module where the message corresponds to what would typically be read by the legacy reader 111 when presented with a legacy credential device 131 to the legacy reader 111 (e.g., same type of signal and protocol).

FIG. 6C is a flowchart of an example process 650 for using the reader 110ₐ with the legacy access control system 600. At step 651 the identifier of the credential device 130ₐ is obtained. Then at step 652 the identifier is processed by the reader 110ₐ. This processing may include determining if the credential device 130ₐ is authorized to obtain access to the access point, which may include comparing the identifier to the access control lists stored in the database in the computer readable memory 350. Based on the processing of the identifier, if it is determined that the user with the credential device 130ₐ is authorized to gain access, then at step 653 a legacy credential device signal is generated. For example, as illustrated in FIG. 6E, the database access and signal generation may include looking-up the obtained identifier in a lookup table 690 which stores a plurality of identifiers where each identifier has a specific signal and using the signal stored in the lookup table for the obtained identifier. This signal corresponds to a signal that once received and processed by the legacy access control system 600 the legacy access control system 600 would allow for access to the access point. Once the signal is generated, which may include adding preamble, or parity/check bits to the signal obtained in the lookup table, at step 654 the signal can then be transmitted to the legacy reader device 111. The generation and transmission of the signal may be according to Wiegand or RS-485 standards.

FIG. 6B illustrates a second example of a legacy access control system 600 which is modified to include the reader 110_{b} and credential device 130_{b} of the access control system 100_{b}. The access control system 100_{b} is a specific non-limiting implementation of the access control system 100. Similarly, the reader 110_{b} and the credential device 130_{b} are a specific non-limiting implementation of the reader 110 and the credential device 130, respectively. This second example is similar to the first example, however, the reader 110_{b} is connected directly either wired or wirelessly to the legacy controller 121. For instance, the reader 110_{b} may use the controller communication module 340 which is configured to emulate the communication signal and protocol of legacy reader. In this example the reader 110_{b} after reading the credential device 130_{b} emulates the legacy reader 111. This emulation may include generating a communication message to be sent from the controller communication module where the message corresponds to what would typically be sent by the legacy reader 111 to the legacy controller 121 when presented with a legacy credential device 131 (e.g., same type of signal and protocol). In other words, in this second example, instead of “piggy backing” on to the legacy reader 131, the reader 110_{b} communicates directly with the legacy controller 121 without the need for the legacy reader 111. It is appreciated that such a configuration may allow for the legacy reader 111 and legacy credential device 131 to still be in operation when the reader 110_{b} is in operation. This configuration may also allow for the legacy reader 111 to be removed from the legacy access control system 600, for example, at a later time once the legacy readers are no longer needed, or even allow for adding new access points to a legacy system.

FIG. 6D is a flowchart of an example process 660 for using the reader 110_{b} with the legacy access control system 600. At step 661 the identifier of the credential device 130_{b} is obtained. Then at step 662 the identifier is processed by the reader 110_{b}. This processing may include determining if the credential device 130_{b} is authorized to obtain access to the access point, which may include comparing the identifier to the access control lists stored in the database in the computer readable memory 350. Based on the processing of the identifier, if it is determined that the user with the credential device 130_{b} is authorized to gain access, then at step 663 a legacy reader signal is generated. This signal corresponds to a signal that once received and processed by the legacy access control system 600, the legacy access control system 600 would allow for access to the access point. For example, as illustrated in FIG. 6E, the database access and signal generation may include looking-up the obtained identifier in a lookup table which stores a plurality of identifier where each identifier has a specific signal and using the signal stored in the lookup table for the obtained identifier. Once the signal is generated, which may include adding preamble, or parity/check bits to the signal obtained in the lookup table, at step 664 the signal can then be transmitted to the legacy controller device 121. The generation and transmission of the signal may be according to Wiegand or RS-485 standards.

The embodiments of FIGS. 6A and 6B, illustrate that a retrofit access control device (e.g., the reader 110 and/or the reader 110 and the controller 120) may be interfaced with a legacy access control system 600 having a legacy access control device (e.g., the legacy reader 111 or the legacy reader 111 and the legacy controller 121), where the legacy access control system 600 controls access to at least one access point, the legacy access control device being configured to interface with a legacy credentials device 131 according to a first protocol to obtain from the legacy credentials device credentials information. The first protocol refers to a first format of communications that are exchanged between the various devices in the legacy access control system 600 and in some cases the format of communications exchanged between the legacy credentials device 131 and the legacy reader 111. As shown, the retrofit access control system includes a reader 110 configured for interfacing according to a second protocol with a retrofit credentials device 130 to obtain from the retrofit credentials device 130 credentials information. The second protocol refers to a second format of communications that are exchanged between the retrofit credentials device 130 and the retrofit reader 110. It is appreciated that the first protocol is in format such that a legacy access control device cannot interface with the retrofit credentials device 130 to obtain credentials information and the second protocol is in a format such that the reader 110 cannot interface with the legacy credentials device 131 to obtain credentials information from the legacy credentials device. The retrofit access control system also includes a processor 330 for processing the credentials information obtained from the retrofit credentials device 130 to generate an access signal compatible with the legacy access control system 600. Reference to the access signal refers to the signal that conveys information (e.g., credential information) that when processed an access control decision to deny or grant access to an access point may be made.

As shown in FIG. 6B, the legacy access control device includes the legacy reader 111 communicating with the legacy controller 121, and the processor 330 is configured to communicate with the legacy controller 121. In such cases, the access signal is configured such that it can be processed by the legacy controller 121. It is appreciated that the legacy controller 121 may be configured for processing the access signal to make an access control decision to grant or deny access to the access point.

In some cases, the legacy reader 111 is configured to communicate with the legacy controller 121 over one or more wires, and the processor 330 is configured to interface with the one or more wires.

As shown in FIG. 6B, the legacy access control device includes a legacy reader 111 and the processor 330 is configured to communicate with the legacy reader 111. In such cases, the access signal is configured such that it can be processed by the legacy reader 111.

In some cases, processing the credentials information obtained from the retrofit credentials device 130 includes determining if the retrofit credentials device 130 is authorized to obtain access to the access point. In some cases, the processor 330 is configured to wired or wirelessly communicate with the legacy reader 111 or legacy controller 121. Moreover, the access signal may be configured such that it emulates a typical signal of the legacy access control system 600 such as a typical signal between the legacy reader 111 and the legacy controller 121 when the legacy reader 111 reads the credential device 131.

It is appreciated that the legacy controller 121 may be remote from the legacy reader 121 or proximate to the legacy reader 121.

Although not illustrated, the legacy access control system in some embodiments includes a computing entity for interfacing with the legacy controller 121, wherein the computing entity is configured for making an access control decision to grant or deny access to the access point.

It is appreciated that this flexibility of the embodiments in FIGS. 6A and 6B allows for the reader 110ₐ or 110_{b} to coexist with legacy systems, thus possibly reducing cost to implement different aspects of the invention. Furthermore, specific timing analysis of the legacy reader 111 can be done to learn when an RS-485 legacy reader, such as the Paradox 915, has to communicate its test pattern, such that the reader 110ₐ and/or 110_{b} will avoid interference in such communications.

In some embodiments, the reader 110ₐ and/or 110_{b} may be configured to auto learn the timing and data profiles of the legacy access control system 600 through its initial power up sequence. For instance, the installer or administrator may simply present several of their legacy credential devices 131 to the legacy reader 111 while the new reader 110ₐ and/or 110_{b} has been electrically wired to the DATA 0 (sometimes referred to as “Data Zero”) and DATA 1 (sometimes referred to as “Data One”) (which is standard in most card readers that use Wiegand) as well as D.C. power of the existing door access reader or in the case of an RS-485 Reader to the serial data and the D.C. power. The reader 110ₐ and/or 110_{b} could then be configured to be in a copy program mode where the reader 110ₐ then stores the data profiles of the legacy credential device 131 (e.g., the credential devices identifier) in a database in the reader 110ₐ and/or 110_{b}.

FIG. 6F illustrates a third example of a legacy access control system 600 which can be modified to include the reader 110_{w}, where the reader 110_{w} can be used with one or more credential devices 130_{w} of the access control system 100_{w}. The access control system 100_{w} is a specific non-limiting implementation of the access control system 100. Similarly, the reader 110_{w} and the credential devices 130_{w} are a specific non-limiting implementation of the reader 110 and the credential device 130, respectively. In this example, a legacy controller 121 is in communication with a legacy reader 111 via a wired or wireless connection, where a plurality of legacy credential devices 132 can be used by presenting one of the legacy credential devices 132 in close proximity to the legacy reader 111 to gain access to an access point (not illustrated).

FIG. 6G is a flowchart of an example method 670 which may be done by an installer when retrofitting the legacy access control system 600 with the reader 110_{w} and credential devices 130_{w}. At step 671 an installer may connect the reader 110_{w} to the legacy reader 111, which may include connecting the reader 110_{w} to the DATA 0 and DATA 1 lines or the serial data lines, along with the D.C power, of the legacy reader 111. In other words, the reader 110_{w} is connected to the data output lines of the legacy reader 111 that are connected to the legacy controller 121, such that the reader 110_{w} is able to read the output signal when one of the legacy credential devices 132 is read by the legacy reader 111. By reading the output signal, the reader 110_{w} is able to obtain the data pattern for each legacy credential device 132. It is also appreciated that the connection to the D.C. power may be used by the reader 110_{w} as voltage reference when reading the output signal from the legacy reader 111.

FIG. 6H illustrates an example of a database table 677 stored in a database in the legacy controller 121. As illustrated, the database table 677 lists the site codes, card numbers, and users associated with the card numbers. In this example, the credential device 132₁ has site code of “00000001” a card number of “0000000000000001” and is associated with the user John Doe; the credential device 132₂ has site code of “00000001” a card number of “0000000000000010” and is associated with the user Jane Doe; and the credential device 132₃ has site code of “00000001” a card number of “0000000000000011” and is associated with the user Bobby Joe. It is appreciated that the database table stored in a database in the legacy controller 121 is not necessarily limited to the example illustrated in FIG. 6H. For instance, the database table stored in a database in the legacy controller 121 may not list the users associated with the card numbers, may only list a plurality of allowable card numbers, and may know that all of the card numbers are associated with the same site code.

It will be appreciated by a person of skill in the art that in this example, the format of the site code (8 bits) and the card number (16 bits) may allow for data pattern to be formatted according to the common proximity format 26-bit Wiegand. This format uses a site code, sometimes also called a facility code. The site code is a unique number common to all of the cards in a particular set. For instance, an organization may have their own site code and a set of numbered credential devices incrementing from 1 and another organization has a different facility code and their credential devices set also increments from 1. Thus different organizations can have credential devices sets with the same card numbers but since the site codes differ, the credential devices only work at one organization. It is appreciated that the use of a site code may be useful when there are multiple organizations within a building and the access control system is maintained by building management. In the 26-bit Wiegand format, bit 1 is an even parity bit, bits 2-9 are the site code, bits 10-25 are the card number and bit 26 is an odd parity bit. Although in this example a 26-bit Wiegand format is used, it is appreciated that the format used is not necessarily limited to 26-bit Wiegand format. For instance, 34 and 56 bit Wiegand format could be used or any other suitable bit length and format may be used. Furthermore, in the examples discussed in this document, some of the examples are illustrated using the 26-bit Wiegand format; however, it would be understood by a person of skill in the art that other formats could be used and that the use of the 26-bit Wiegand format is for illustrative purposes only.

FIG. 6I illustrates an example of a table 678 where the bit 1 even parity bit and the bit 26 odd party bits are calculated. The even parity bit is based on bits 2-13, such that the number of 1's in bits 2-23 plus the parity bit is an even number. Similarly, the odd parity bit is based on bits 14-25, such that the number of 1's in bits 14-25 plus the parity bit is an odd number.

In this example, once the reader 110_{w} is connected to the data output lines of the legacy reader 111 one of the legacy credential devices 131, for example legacy credential device 131₁, can then be placed in close proximity to the legacy reader 111 such that reader 110_{w} can then read the output waveform of the legacy reader 111. In other words, the RF signal of the legacy credential device 131₁ is read by the legacy reader 111 to obtain the site code, the card number and the parity bits, then the legacy reader 111 transmits the site code and card number including the parity bits to the legacy controller 121. It is appreciated that in some cases the parity bits are stored on the legacy credential devices 131 while in other cases the parity bits are not stored on the legacy credential devices 131 and are added by the legacy reader 111 prior to transmitting the data signal to the legacy controller 121.

FIG. 6J illustrates an example waveform in the case where the legacy reader 111 has DATA 0 and DATA 1 Wiegand outputs. In this example, the legacy credential device 131₁ is placed in close proximity to the legacy reader 111 and the waveform illustrated in FIG. 6J is read from the output of the legacy reader 111 by the reader 110_{w}. As illustrated, the even parity bit is “1” and is followed by the site code of “00000001” which is followed by the card number of “0000000000000001” and the odd parity bit of “0”. In this example, the DATA 0 line goes “high” when there is a “0” being transmitted and the DATA 1 line goes “high” when there is a “1” being transmitted.

FIG. 6K illustrates an example waveform in the case where the legacy reader 111 has serial outputs (e.g., RS-232, RS-422, or RS-485). In this example, the legacy credential device 131₁ is placed in close proximity to the legacy reader 111 and the waveform illustrated in FIG. 6K is read from the output of the legacy reader 111 by the reader 110_{w}. As illustrated, in this example, the transmitted signal starts with a start bit then the even parity bit “1” and is followed by the site code of “00000001” which is followed by the card number of “0000000000000001” and then the odd parity bit of “0” which is then followed by an end bit. In this example, the “+” line goes “high” when there is a “1” being transmitted and the “−” line goes “high” when there is a “0” being transmitted.

The output waveform can then be analyzed by the reader 110_{w} such that reader knows which format is being used (e.g., Wiegand vs. serial output). In other words, the bit pattern and timing pattern is read to determine whether Wiegand or serial data output is being used. In alternative embodiments, the installer may know whether the legacy reader has Wiegand or serial outputs and sets the settings on the reader 110_{w} by either pushing a button on the reader 110_{w} or by connecting to the reader 110_{w} via a computing entity, such as a tablet or cell phone, to change the settings of the reader 110_{w} so the reader 110_{w} knows which type of waveform it is receiving (e.g., Wiegand vs. serial output).

From the waveform a data pattern or bit pattern may be determined at the reader 110_{w}.

If the data pattern format is known (e.g., the number of bits for the site code, the number of bits for the card number and the location of the bits for the site code and the card number) then the site code and card number can be obtained from the data pattern. For instance, the installer may know the data pattern format and set the settings on the reader 110_{w} by either pushing a button on the reader 110_{w} or by connecting to the reader 110_{w} via a computing entity, such as a tablet or cell phone, to change the settings of the reader 110_{w} so the reader 110_{w} knows the data pattern format. For example, the installer may set the number of bits in the data pattern, the bit locations of the site code, the card number and the parity bit(s), and the settings/rules associated with the parity bit(s). In other cases, the installer may select the data pattern format from a list of available data pattern formats (or card formats) which is presented to the installer via a display on the reader 110_{w} or via a display on the computing entity.

In other cases the installer may not know the data pattern format but the site code and card number is known and in these cases the reader can process the data pattern to determine the data pattern format. This processing step may include presenting one after each other multiple legacy credential devices 132 where the site code and card number is known of each of the multiple legacy credential devices 132. The reader 110_{w} can then process the data pattern from each waveform for the respective legacy credential devices 132 by comparing it to the known site codes and card codes of the respective legacy credential devices 132. It is appreciated that such a processing step may be useful when the data pattern format is a propriety format which is unknown to the installer. It is also appreciated that when the multiple legacy credential devices 132 have the same site code, the presenting of multiple legacy credential devices 132 one after each other may be used to determine the site code by comparing each data pattern to see the portion that remains the same between the multiple legacy credential devices 132.

In some embodiments, the reader 110_{w} can auto learn the data pattern format. For instance, the reader 110_{w} may analyze the waveform (e.g., the bit pattern and the timing pattern) and compare this information with a database. More specifically, the database may contain information pertaining to different data pattern formats, which may include: the number of bits in the data pattern; the number of bits for the site code; the number of bits for the card number; the number of bits for the parity bit(s); the location of the bits for the site code; the location of the bits for the card number; the location of the bit(s) for the parity bit(s); the settings/rules associated with the parity bit(s) and any other suitable information. By way of a non-limiting example, the database may contain information pertaining to the data pattern format for each of the following card formats:
26 Bit Wiegand Standard Card Format,
34 Bit Wiegand HID N1002 Card Format,
37 Bit Wiegand HID H10304 Card Format,
36 Bit Wiegand HID Simplex Card Format,
35 Bit Wiegand HID Corporate 1000 Card Format,
33 Bit Wiegand HID D10202 Card Format,
26 Bit Wiegand HID Card Format,
37 Bit Wiegand HID H10302 Card Format,
32 Bit Wiegand HID Check Point Card Format,
33 Bit Wiegand RS2-HID (R901592C) F/C 3 Card Format,
32 Bit Wiegand Kastle Systems Card Format,
34 Bit Wiegand AWID RS2 Card Format,
37 Bit Wiegand Farpointe H10304 Card Format,
200 Bit Wiegand PIV Card Format,
40 Bit Wiegand XceedID RS2 Card Format,
33 Bit Wiegand DSX-HID (D10202) F/C 17 ASSA Abloy IP Lockset Card Format,
37 Bit Wiegand HID H10302 ASSA ABLOY IP Lockset Card Format,
75 Bit Wiegand PIV Card Format,
107 Bit Wiegand PIV Card Format,
37 Bit Wiegand HID PointGaurd MDI Card Format,
37 Bit Wiegand RS2-HID (H10304) F/C 900 ASSA ABLOY IP Lockset Card Format,
33 Bit Wiegand RS2-HID (R901592C) F/C 3 ASSA Abloy IP Lockset Card Format,
31 Bit Wiegand HID ADT Card Format,
40 Bit Wiegand Casi Card Format,
12 Digit Magstripe Casi F/2F Card Format,
128 Bit Wiegand PIV-I Card Format,
75 Bit Wiegand pivClass Card Format,
or any other suitable card format

Thus, based on the information in the database and the waveform obtained, the reader 110_{w} can then determine the data pattern format and/or card format used. Based on this determination the reader can then be auto-configured to use the data pattern format in any future communications with the legacy controller 121. In other words, by connecting the reader 110_{w} to the legacy controller 121, the reader 110_{w} is able to read the output signal from the legacy reader 111 to the legacy controller 121 when one of the legacy credential devices 132 is read by the legacy reader 111, such that the reader 110_{w} can process the information obtained from the output signal and compare it with information in a database so the reader 110_{w} can then be automatically configured to use the data pattern format in any future communications with the legacy controller 121.

More specifically, the reader 110_{w} has a number of different configuration options, each option being associated with a respective legacy data pattern format, such as anyone of the formats identified in the above list. Each configuration option essentially sets the reader 110_{w} to be “seen” by the legacy controller as a legacy reader outputting data according to the legacy data format. In a specific example of implementation, the configuration of the reader 110_{w} is set via software. The configuration options are thus individual instructions sets, each set directing the hardware to behave in a manner that will make it compatible with a legacy controller working according to the data format associated with the selected configuration option.

During the installation process, when the reader 110_{w} senses the data pattern output by the legacy reader, it processes the data pattern by comparing it to a number of known data patterns stored in memory. The data patterns stored in memory are associated with respective configuration options, such as once a data pattern stored in memory has been recognized the respective configuration option is loaded and enabled. During the comparison process, if the a data pattern in memory matches the observed data pattern, the corresponding configuration option is automatically enabled and the reader 110_{w} is ready for use.

Then at step 672, the installer may then remove the legacy reader 111 from the legacy access system 600 point and at step 673 connects the reader 110_{w} to the legacy controller 121. At these steps the legacy reader 111 may be disconnected from the Data 0, Data 1, Data Return lines that connect to the legacy controller 121 and then the reader 110_{w} can then be connect to the Data 0, Data 1, Data Return lines, in the case that Wiegand protocol is used. In the case that serial (e.g., RS-232, RS-422 or RS-485) transmission protocol is being used, the serial data lines could be disconnected from the legacy reader 111 and connected to the reader 110_{w}. In addition, a power connection could then be disconnected from the legacy reader 111 and could be connected to the reader 110_{w}. In other cases, the installer may choose to leave the legacy reader 111 installed, so that the legacy credential devices 132 can still be used.

Then at step 674 the installer can add new credential devices 130_{w} to the reader 110_{w}. The general process of adding new credential devices to the reader is discussed in detail elsewhere in this document (e.g., see the section entitled “Programming of Credential Devices”). It is appreciated that this replacing of the legacy credential devices 132 with the new credential devices 130_{w} is typically done because the legacy credential devices 132 are proximity cards which are required to be approximately within 3 inches of the legacy reader 111, while the new credential devices 130_{w} are designed to be operable at a longer range (e.g., up to 3 to 20+ feet away from the reader 110_{w}; e.g., 3 feet, 7 feet, 15 feet and 19 feet are possible distances). In other words, the replacement of legacy credential devices 132 which are typically of a short range is replaced with the new credential devices 130_{w} which are typically of a long range.

In adding the new credential devices 130_{w} to the reader 110_{w}, each of the new credential devices 130_{w} may have a factory set identifier. For example, the factory set identifier may be a site code and a card number. To program the new credential devices 130_{w} so that they work with the reader 110_{w} and the legacy controller 121, the reader 110_{w} may be put into a “programming mode” (as discussed in the section entitled “Programming of Credential Devices”), which may be done by the installer (or other person responsible for programming the credential devices 130_{w}). For instance, a button may be pushed on the back of the reader 110_{w} or a computing entity (such as a cell phone or tablet) may be used to connect to the reader 110_{w} to put the reader 110_{w} in the programming mode. Then the installer may set the identifiers (e.g., the site code and the card number) of the new credential devices 130_{w} based on the identifiers of legacy access control system 600 (e.g., same site code that the legacy access control system 600 was using and the next in line or available card numbers).

In some cases, if the installer would like to add the credential device 130_{w1} to the reader 110_{w}, the installer may set the reader 110_{w} to the programmable mode and then determine or obtain the next available card number from the legacy controller 121. For example, the installer may connect to the legacy controller 121 via a computing entity to see which card numbers are available or are next in line. Then the installer can configure the reader 110_{w} to program the next credential device that is to be programmed with the card number and site code. For example, the installer may use push buttons and use a display on the reader 110_{w} to setup the site code and card number that is to be programmed on to the next credential device. In other cases, the installer may connect to the reader 110_{w} via a computing entity (e.g., cell phone or tablet) to setup the site code and card number that is to be programmed on to the next credential device.

In other cases, the legacy controller 121 may be set to a programming mode where it transmits a data signal to the reader 110_{w} to indicate the site code and the card number to be programmed. Then the reader 110_{w} knows which site code and card number to use in programming the next credential device.

In other cases, the site code may not need to be entered into the reader 110_{w} by the installer or be obtained/received from the legacy controller 121 as the reader 110_{w} may have obtained the site code in the process of auto learning the data pattern format, as the reader 110_{w} may have obtained the site code at that time.

To transfer the identifier (e.g., site code and the card number) to the credential device 130_{w1} the installer may shake the credential device 130_{w1} or in other cases enter into the reader 110_{w} or a computing entity connected to reader 110_{w} a serial number associated with the credential device 130_{w1}. More specifically, the steps of transferring an identifier on to the credential device 130_{w1} may take place as discussed in the section entitled “Programming of Credential Devices”.

By way of a specific and non-limiting example, the installer may shake the credential device 130_{w1} after entering the reader 110_{w} in to the programming mode and setting up on the reader 110_{w} that next credential device to be programmed has the site code “00000001” and card number “0000000000000100”. The site code and the card number are then transferred to the credential device 130_{w1}. After the site code and card number are programmed into the memory of the credential device 130_{w1}, the reader 110_{w} may indicate to the user (e.g., sound, light or on a display of the computing entity) that the identifier of the credential device 130_{w1} has been updated. Then the installer can then indicate to the reader 110_{w} that another credential device is to be added, which may include indicating to the reader 110_{w} the identifier (e.g., site code “00000001” and card number “0000000000000101”) to be programmed on to the credential device 130_{w2}. In other cases, the reader 110_{w} may be set to an auto increment mode where it automatically increments the card number so the installer does not have to manually enter in the next card number. Similar to the case above, the installer can then shake the credential device 130_{w2} which is then updated with the site code “00000001” and card number “0000000000000101”. The installer may also indicate to the legacy controller 121 the users associated with each credential device 130_{w}. For example, as illustrated in FIG. 6L, the installer can indicate to the legacy controller 121 that Adam Smith is associated with the card number “0000000000000100” and Sue Clark is associated with the card number “0000000000000101”, which is then stored in the record 678′ that is stored in a database in the memory of the legacy controller 121.

It is appreciated that such a configuration may allow for the legacy controller 121 to still be used when longer range credential devices 130_{w} are desired to be used. In other words, the replacing of the legacy reader 111 and legacy credential devices 132 (of a short range) with the reader 110_{w} and credential devices 130_{w} (of a long range) may allow for longer range readings of credential devices, as the credential devices 130_{w} store an identifier in the format of the legacy credential devices 132 which may be read by the reader 110_{w} (when in range) and transmitted to the legacy controller 121 which can then make access control decisions without knowledge that the legacy reader 121 and legacy credential devices 132 have been replaced.

By way of another example, in some cases the identifier (e.g., the site code and card number) is not transferred to the credential devices 130_{w} but is stored in a record in a database in memory in the reader 110_{w}. For example, the reader 110_{w} and the credential devices 130_{w} may use a specific format that is unique to the access control system 100_{w}. For instance, in programming the credential devices 130_{w} instead of transferring the site code and the card number to the credential devices 130_{w} the site code and the card number are stored in the form of the 26 bit Wiegand format in a record 679 in a database stored in memory of the reader 110_{w}, as illustrated in FIG. 6M. As illustrated, the data pattern “10000000100000000000001000” corresponding to the card number “0000000000000100” is associated with the identifier “0001FFFF0001” and the “10000000100000000000001011” corresponding to the card number “0000000000000101” is associated with the identifier “0001FFFF0002”. In this example, when the credential device 130_{w1} is programmed, the identifier used is “0001FFFF0001” and similarly when the credential device 130_{w2} is programmed, the identifier used is “0001FFFF0002”. As such, when the credential device 130_{w1} is read by the reader 110_{w} the identifier “0001FFFF0001” is transmitted to the reader 110_{w} which then compares the identifier to the database record 679 to determine the corresponding data pattern, which can then be transmitted to the legacy controller 121. The legacy controller 121 can then make the access control decision based on the data pattern obtained.

It is appreciated that such a configuration may allow for the legacy controller 121 to still be used when longer range credential devices 130_{w} are desired to be used. In other words, the replacing of the legacy reader 111 and legacy credential devices 132 (of a short range) with the reader 110_{w} and credential devices 130_{w} (of a long range) may allow for longer range readings of credential devices, as the credential devices 130_{w} when the reader 130_{w} obtains the identifier from one of the credential devices 130_{w}, the reader 130_{w} then determines a corresponding data pattern which can be transmitted to the legacy controller 121 which can then make access control decisions without knowledge that the legacy reader 121 and legacy credential devices 132 have been replaced.

In the examples above the card numbers were not reused; however, in other cases, the existing cards numbers may be re-used, which may be the case if the legacy reader 111 is removed and/or the legacy credential devices 132 are no longer planned to be used.

It is appreciated that such a configuration may allow for the legacy controller 121 to be removed at a later time and replaced with a new controller that is able to communicate with the readers via the readers' network communication module 370 (e.g., Wi-Fi or Ethernet).

It is appreciated that a method for retrofitting the legacy access control system with a new access control device is provided. In such cases, the legacy access control system 600 has the legacy access control device 121 that controls access to at least one access point, the legacy access control device 121 is configured to interface with the legacy credentials device 121 according to the first protocol to obtain from the legacy credentials device credentials information, the new access control device including the reader 110 configured for interfacing according to a second protocol with a new credentials device 130 to obtain from the new credentials device 130 credentials information, the first protocol being such that the legacy access control device cannot interface with the new credentials device 130 to obtain credentials information, the second protocol being such that the reader 110 of the new access control device cannot interface with the legacy credentials device 131 to obtain credentials information from the legacy credentials device 131, the new access control device further including a processor 330 for processing credentials information obtained from the new credentials device 130, the processor 333 having an output. For example, the output may be one or more data buses configured to interact with an output module or interface such as the controller communication module 340. This method includes connecting the output of the processor 333 to an input of the legacy access control device, where the input is configured to accept an input signal derived from an interaction between the legacy access control device and the legacy credentials device, the input signal conveying credentials information derived from the legacy credentials device. For example, the input may be an interface or module of the legacy controller 121 or of the legacy reader 111. This method also includes that in response to the interaction between the new access control device and the new credentials device 130 according to the second protocol, outputting a signal (e.g., an access signal) which conveys credentials information derived from the new credentials device 130, the signal being configured such that it can be accepted by the input. In some cases, the interaction between the legacy access control device and the legacy credentials device 131 includes the legacy reader 111 reading a legacy credential device 131.

In some cases, where the legacy access control device includes the legacy controller 121 in communication with the legacy reader 111, connecting the output of the processor 330 to the input of the legacy access control device includes connecting the output of the processor 333 to an input of a legacy access controller 121.

It is appreciated that another method for retrofitting a legacy access control system 600 with the new access control device is provided. In this case, the legacy access control system includes the legacy access control device that controls access to at least one access point, the legacy access control device being configured to interact with a legacy credentials device 131 according to the first protocol to obtain from the legacy credentials device 131 credentials information, the legacy access control device including the input for receiving an input signal (e.g., a signal from the legacy credential device 131 to the legacy reader 111 or a signal between the legacy reader 111 and the legacy controller 121 when a legacy credential device 131 is read by the legacy reader 111) derived from an interaction with the legacy credentials device 131 the input signal conveying credentials information provided by the legacy credentials device 131 during the interaction, the new access control device includes the reader 110 configured for interfacing according to the second protocol with the new credentials device 130 to obtain from the new credentials device 130 credentials information, the first protocol being such that a legacy access control device cannot interact with the new credentials device 130 to obtain credentials information, the second protocol being such that the reader 110 of the new access control device cannot interact with the legacy credentials device to obtain credentials information from the legacy credentials device 131, the new access control device further including the processor 330 configured for processing credentials information obtained from the new credentials device 130 to generate at the output an access signal that is compatible with the input such that the credentials information can be communicated to the input. The method includes connecting the output of the processor 330 to the input and preventing the legacy access control device from interacting with a legacy credentials device 131.

In some cases, where the legacy access control device includes the legacy controller 121 communicating with the legacy reader 111, the connecting of the output of the processor 330 to an input may include connecting the output of the processor 330 to an input of a legacy access controller 121.

In some cases, where the legacy access control device includes the legacy controller 121 and the legacy reader 111, the preventing of the legacy access control device from interacting with a legacy credentials device includes disconnected the legacy reader 111 from the legacy controller 121. Other cases may include physically removing the legacy reader 111 or decommissioning access to the legacy credential devices 131.

In the various embodiments discussed, reference is made to a processor 330; however, in other embodiments the reference to the processor 330 may include reference to the controller 120 and in such cases, the controller 120 and the reader 110 may be provided in a single device which may be referred to an access control device.

### Multiple Credential Detection

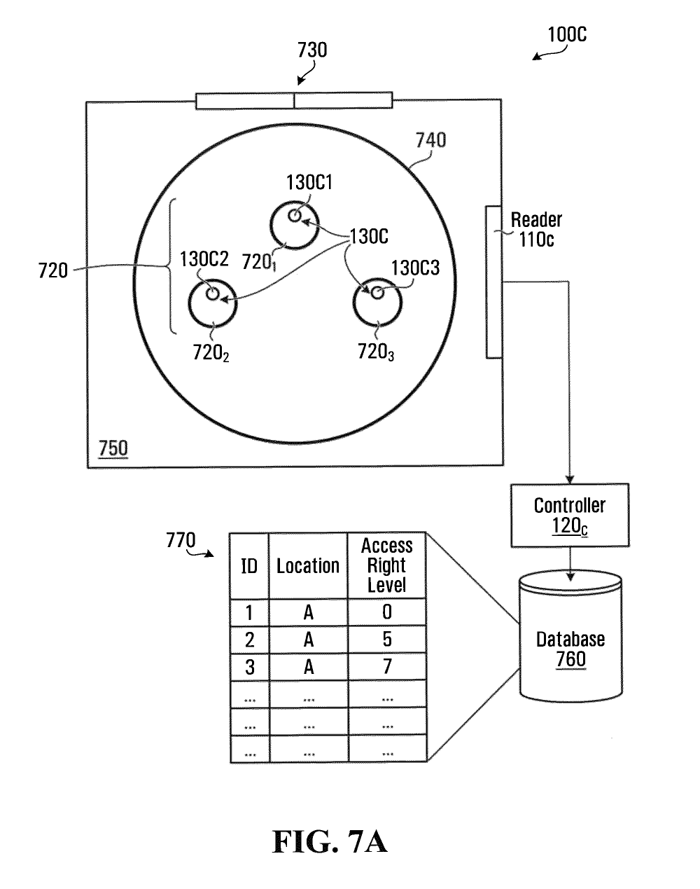

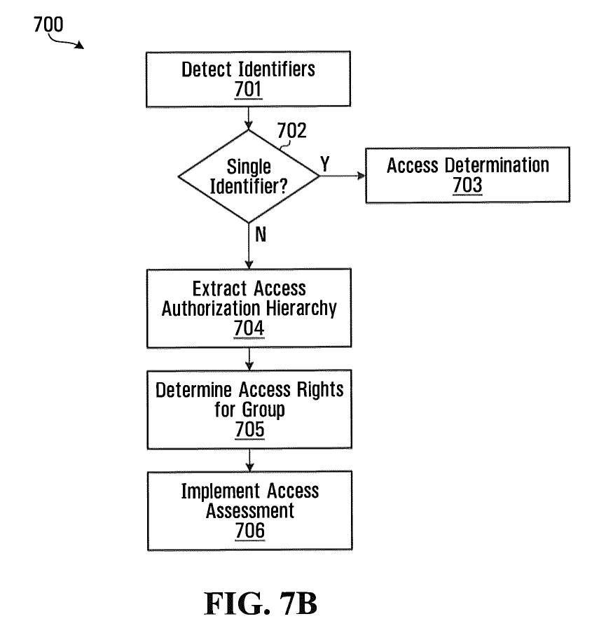

FIG. 7A illustrates an example of an access control system 100_{c} which includes a reader 110_{c} to be used with a plurality of credential device 130_{c}. The access control system 100_{c} is a specific non-limiting implementation of the access control system 100. Similarly, the reader 110_{c} and the credential devices 130_{c} are a specific non-limiting implementation of the reader 110 and the credential device 130, respectively. As illustrated, a plurality of people 720 are in a room 750 with a desire to enter the access point 730 (e.g., a door). The reader 110_{c} comprising one or more antennas 310 which are configured to read the plurality of credential devices 130_{c} of the people 720 in the field of range 740 of the one or more antennas 310. In this example, three people 720₁, 720₂ and 720₃ are in the field of range 720. More specifically, the reader 110 obtains the identifiers for each of the credential devices 130_{c1} 130_{c2} 130_{c3} (which correspond respectively to the three people 720₁, 720₂ and 720₃) present in the field of range 740. Each of the credential devices 130_{c1} 130_{c2} 130_{c3} have respective identifiers “1”, “2” and “3”. The reader communicates to the controller 120_{c} the identifiers obtained by the reader from the credential devices 130_{c} of the plurality of people 720. The controller 120_{c} may be part of the reader 110_{c} or may be a separate hardware device. The controller 120_{c} is in communication with a database 760, which has a database table 770. The database 760 may be located in computer readable memory 450 within the controller 120_{c} on may be located in computer readable memory on one or more remote servers or host computers. As illustrated, the database table 770 stores a list of identifiers for all of the credential devices 130_{c}, a list of locations or access points in a building and an access right level for each of the locations for each of the identifiers. The database table 770 in this example contains for location “A” (which corresponds to the room 750) that the user with a credential device having an identifier “1” has an access rights level of “0”, the user with a credential device having an identifier “2” has an access rights level of “5”, and that the user with a credential device having an identifier “3” has an access rights level of “7”.

FIG. 7B illustrates an example method 700 which may be executed by the access control system 100_{c}. At step 701 the reader 110_{c} detects the identifiers of the credential devices 130_{c} in the field 740. In this example, the reader 110_{c} obtains the identifiers “1”, “2” and “3” from the credential devices 130 of the people 720₁, 720₂ and 720₃ in the field 740. Then, at step 702 the controller 120 determines whether a single identifier is detected. If only a single identifier is obtained (e.g., only a single person having a single credential device is present in the field 740), then an access determination can be made at step 703. If more than one identifier is obtained, then an access decision process (which starts at step 704) takes place based on an access authorization hierarchy. In this example, at step 702, as three identifiers “1”, “2” and “3” were obtained (previously at step 701), a single identifier is not present and the process proceeds to step 704 to make an access control decision based on multiple credential devices 130. At step 704, the controller obtains, for the specified location, the access rights for each identifier. In this example, the controller uses the identifiers “1”, “2” and “3” to extract the access authorization hierarchy for the current location of room 750 which is identified as location “A” in the database table 770. As illustrated in FIG. 7A, identifiers “1”, “2” and “3” have respective access rights “0”, “5” and “7” for location “A”. At step 705, a determination is made on the access rights of the group and at step 706 the access assessment is made (e.g., whether to open the door or not). The determination of the access rights of the group may be made in numerous ways by access control logic which determines whether the group as a whole can gain access. For example, a database table (not illustrated) may list the access level requirements for each of the access points in a building. For example, for location “A” the access requirements could be that people with an access right of “7” or higher are authorized to obtain access and people with an identifier of “5” or “6” can enter when accompanies by a user with an access right of “7” or higher. Using the access requirement in the example above, the access point 730 would not open at step 706 as authorization would not be granted at step 705 as person 720₁ has an access right of “0” which results in the access requirement previously discussed not being met. By way of another example, if person 720₁ with identifier “1” was to leave the field of range 740, then at step 705 access to the access point 730 would be granted as person 720₂ with an access right of “5” is accompanied by a person 720₃ with an access right of “7” and the access requirement previous described is met.

Although in the example above the controller 120_{c} and the reader 110_{c} are illustrated as two separate devices, in other embodiments the controller 120_{c} and the reader 110_{c} may be implemented in a single hardware device. In other words, in some embodiments the functionality of the controller 120_{c} described above may take place in the reader 110_{c}.

The concept of multiple credential devices will be discussed in further detail in the section entitled “Clashing Credential Devices & Readers”.

### Dual Wakeup Antennas

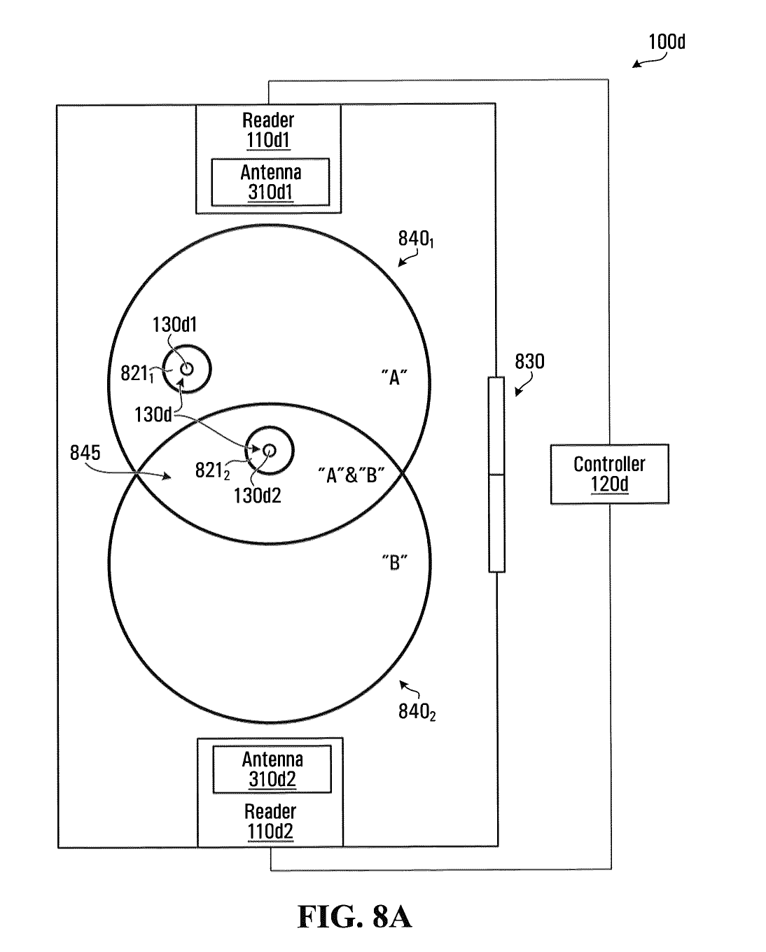

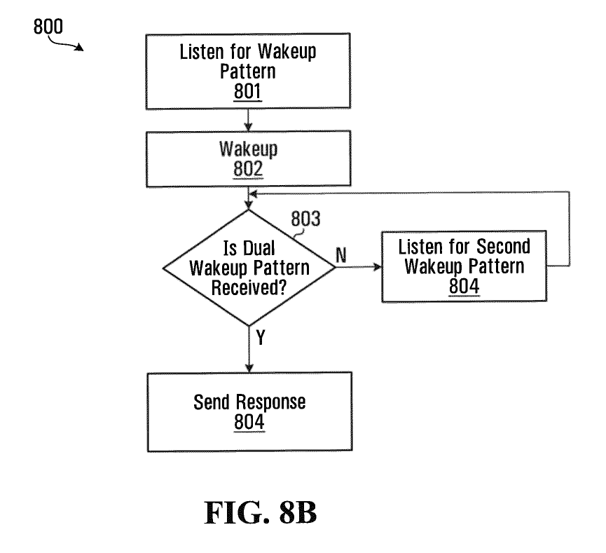

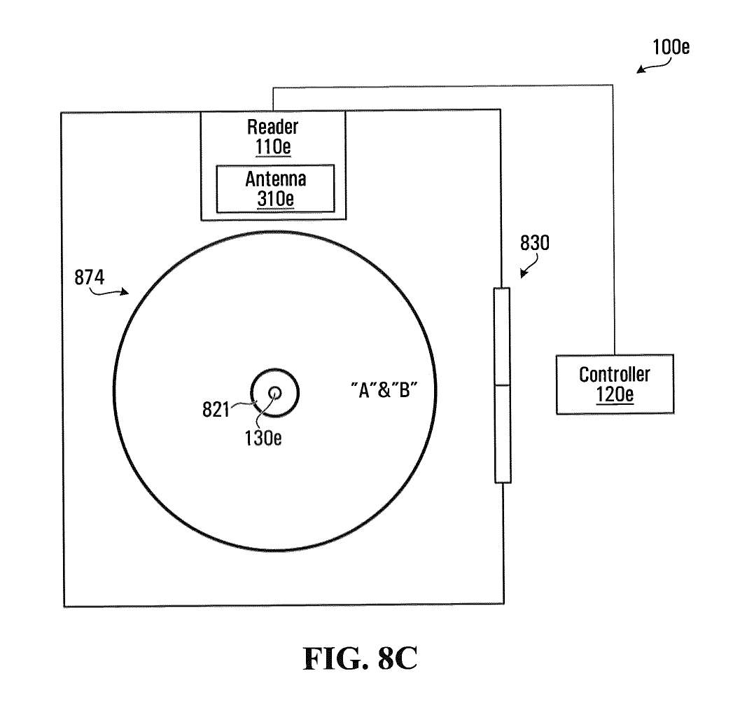

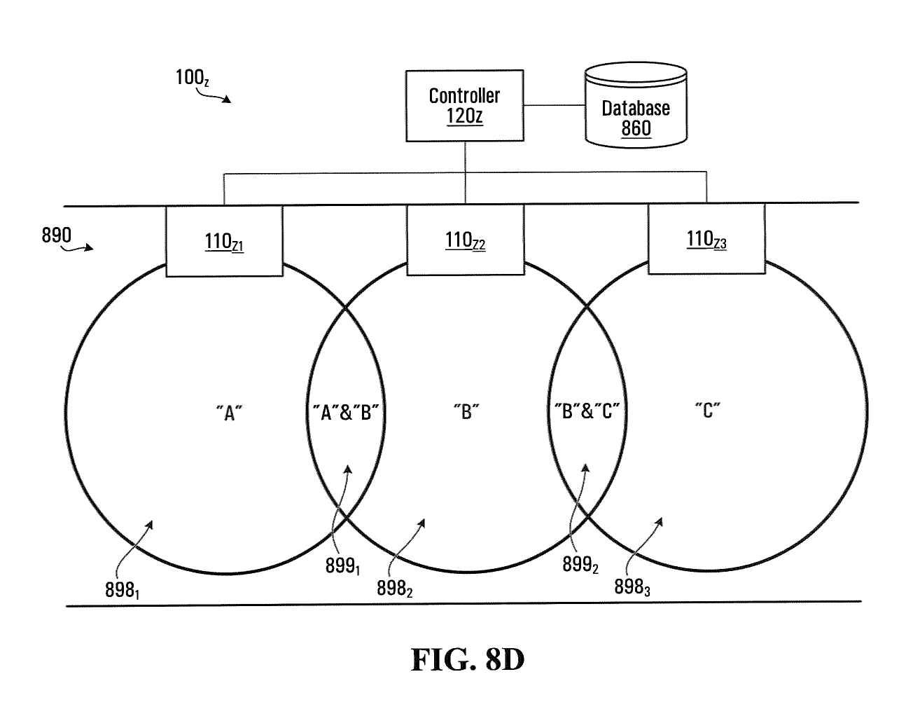

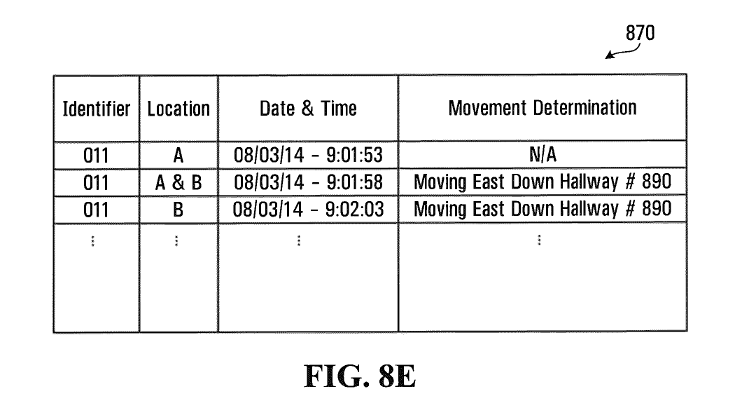

FIG. 8A illustrates an example of an access control system 100_{d} which includes two readers 110_{d1} 110_{d2} to be used with a credential device 130_{d}. The access control system 100_{d} is a specific non-limiting implementation of the access control system 100. Similarly, the readers 110_{d1} 110_{d2} and the credential device 130_{d} are a specific non-limiting implementation of the reader 110 and the credential device 130, respectively. As illustrated, the wakeup antenna 310_{d1} of the reader 110_{d1} has a field of range 840₁ and the wakeup antenna 310_{d2} of the reader 110_{d2} has a field of range 840₂, and where the field of range 840₁ and the field of range 840₂ overlap form an overlapping field of range 845. As illustrated at a time t=1 the person 821₁ (where the subscript indicates the person at time t=1) with the credential device 130_{d1} (which corresponds to the credential device 130_{d} at time t=1) is in the field of range 840₁. At a later time t=2 the person 821₂ (where the subscript indicates the person at time t=2) with the credential device 130_{d2} (which corresponds to the credential device 130_{d} at time t=2) enters additionally into the field of range 840₂ such that the person 821₂ is in the overlapping field of range 845.

The readers 110_{d1} 110_{d2} are in communication (wired or wirelessly) with a controller 120_{d} via the readers 110_{d1} 110_{d2} controller communication module 340 and the reader communication module 540 of the controller 120_{d}. At startup of the system 100_{d} the controller 120_{d} determines the number of readers and more specifically the number of wakeup antennas in use. In this example, as there are two readers 110_{d1} 110_{d2} each having a respective wakeup antenna 310_{d1} 310_{d2}, the controller determines that a total of two wakeup antennas are in use and configures the respective credential communication modules 320 of the readers such that each wakeup antenna transmit a distinct wakeup pattern. For example, the wakeup antenna 310_{d1} could be configured to transmit wakeup pattern “A” and the wakeup antenna 310_{d2} could be configured to transmit wakeup pattern “B”.

The credential device 130_{d} is configured to transmit only upon being in the presence of both wakeup fields 840₁ 840₂ of the two wakeup antennas 310_{d1} 310_{d2} (i.e., it is configured to wake up in the presence of both wakeup patterns “A” and “B”). In other words, the dual antennas 310_{d1} 310_{d2} continuously emit/radiate a dual antenna wakeup pattern “A” and “B” which the credential device 130_{d} listens for, prior to leaving low power standby mode. For instance, the antenna 410 of the credential device 130_{d} receives wireless signals corresponding to wakeup patterns, the reader communication module 420 processes the received wireless signals to obtain the wakeup patterns and transmits the signals to the data processor 430 which then makes a determination as to which wakeup pattern(s) are received.

FIG. 8B illustrates an example method 800 which may be executed by the credential device 130_{d} of the access control system 100_{d}. At step 801 the credential device 130_{d} listens for the wakeup pattern and then at step 802 wakes up from the low power standby mode if a wakeup pattern is received. For example, as the person 821₁ enters the field 840₁ the credential device 130_{d1} wakes up, as the credential device 130_{d1} receives the wakeup pattern “A”. Then at step 803 the wakeup pattern is processed by the database processor 430 to determine if a dual wake up pattern is received or not. In this example, as only the single wakeup pattern “A” is received, the credential device 130_{d1} then listens for a second wakeup pattern, as indicated at step 804. The credential device 130_{d1} continuously monitors the received wakeup pattern signals until the credential device 130_{d1} either receives a second wakeup pattern or the credential device 130_{d1} is no longer in the field of range of the first wakeup pattern. In this example, at a later time the person 821₂ is in field of range 845 and receives both wakeup patterns “A” and “B”. Then at step 803 it is determined that two wakeup patterns are received and that the credential device 130_{d2} should send a response including the credential device's identifier to the readers 110_{d1} 110_{d2}. Once the credential device 130_{d2} sends its response including its identifier to the readers 110_{d1} 110_{d2}, the readers 110_{d1} 110_{d2} may then communicate this identifier to the control 120_{d} and the controller 120_{d} may then make the access control decision and make a determination whether to grant access to the access point 830.

It is appreciated that the dual antenna configuration may allow for the door or entry portal to be well defined, as the precise detection area may be configured based on the position of the two wakeup antennas. Additionally, the use of two antennas may help in reducing or eliminating false activations when a person may be walking with a credential in an adjacent area in which a single antenna would activate the credential. In other words, by using two wakeup antennas, in this specific example, the credential was configured to only reply when the two patterns are identified. Applications that may use dual wakeup antennas include, inter alia, chock points for active RFID tracking, article surveillance, and people counting.

Although in the example above two readers 110_{d1} 110_{d2} each having respective antennas 310_{d1} 310_{d2} were illustrated, in other embodiments a single reader may be provided where the single reader houses two antennas.

FIG. 8C illustrates an example of an access control system 100ₑ where a single readers 110ₑ having a single antenna 310ₑ is configured to function as a dual wakeup antenna system with a credential device 130ₑ. The access control system 100ₑ is a specific non-limiting implementation of the access control system 100. Similarly, the readers 110ₑ and the credential device 130ₑ are a specific non-limiting implementation of the reader 110 and the credential device 130, respectively. As illustrated, the wakeup antenna 310ₑ of the reader 110ₑ has a field of range 874. In this example the credential device 130ₑ is configured in the same way as the credential device 130_{d}, that is the credential device 130ₑ only wakes up and sends a response in the presence of the two wakeup fields “A” and “B”. As such, the controller 120ₑ at startup of the access control system 100ₑ determines that only a single wakeup antenna 310ₑ is in use as that the wakeup antenna 310ₑ should be configured to transmit a dual wake up pattern “A-B”.

It is appreciated that in the examples above the controllers make a determination at startup to determine the mode of operation of the wakeup antennas as to whether a specific wakeup antenna should transmit a single wakeup pattern or a combination of two standard wakeup patterns. As illustrated in embodiments above, when only a single wakeup antenna is present (or available), the controller 120ₑ make the determination that only a single wakeup antenna is present or available and that a single mode of operation should be selected where a single wakeup antenna is configured to constantly emits the dual wakeup pattern “A-B”. On the other hand, when two wakeup antennas are present (or available), the controller 120ₑ makes the determination that a dual wakeup antenna mode of operation should be selected where a first wakeup antenna emits only part of the wakeup pattern “A” and the a second wakeup antenna emits the other part of the wakeup pattern “B”.

It is also appreciated that this automatic recognition of the number of readers may be useful when new systems are being implemented and a single wakeup antenna is to be used temporarily until the second wakeup antenna is installed. In other cases, the automatic recognition of the number of readers may be useful where one of the dual wakeup antennas fails.

The use of the dual wakeup pattern and the dual wakeup antennas may be configured based upon the actual door or other access or monitoring needs. For instance, one antenna with the dual wakeup pattern “A-B” may be used for simple door access without directionality, or possibility of adjacent door interference; while, the two antenna connection may be used in cases where directional control is required. In other words, a credential device may be configured to only wakeup in the presents of a dual wakeup pattern (e.g., “A” and “B”) and some readers in a building may use two antennas where a first antenna transmits a first wakeup pattern (e.g., “A”) and a second antenna transmits a second wakeup pattern (e.g., “B”), while others readers in a building may use a single antenna that transmits the dual pattern (e.g., “A-B”).

### Example of Multiple Antennas for Determining Position:

FIG. 8D illustrates an example of an access control system 100_{z} which includes three readers 110_{z1} 110_{z2} 110_{z3} implemented in a hallway 890. The access control system 100_{z} is a specific non-limiting implementation of the access control system 100. Similarly, the readers 110_{z1} 110_{z2} 110_{z3} are a specific non-limiting implementation of the reader 110. As illustrated, the reader 110_{z1} has a field of range 898₁ where the wakeup pattern “A” is receivable, the reader 110_{z2} has a field of range 898₂ where the wakeup pattern “B” is receivable, and the reader 110_{z3} has a field of range 898₃ where the wakeup pattern “C” is receivable. The field of range 898₁ and the field of range 898₂ have an overlapping part 899₁ where the wakeup patterns “A” & “B” are receivable and the field of range 898₂ and the field of range 898₃ have an overlapping part 899₂ where the wakeup patterns “B” & “C” are receivable.

By way of an example, as a person with a credential device (not illustrated) walks down the hallway 890 the credential device may be configured to wake up in the presence of any of the wakeup patterns “A”, “B”, “C”, or combination thereof. In other words, as the credential device wakes up, it transmits its identifier to one or more of the readers 110_{z1} 110_{z2} 110_{z3}, the controller 120_{z} can be configured to track the receipt of the identifiers from the credential device via the readers to determined motion. For instance, if a credential device moves in the field of range 898₁ and receives the wakeup pattern “A”, the credential device would then transit its identifier to the reader 110_{z1}, the reader 110_{z1} then transmits the identifier along with the time of receipt of the identifier to the controller 120_{z}, the controller 120_{z} upon receipt of the transmission then has a record of the identifier, the reader from which the identifier was received and the time of the reading of the identifier by the reader. Then as the credential device continues to moves to the overlapping field of range 899₁, it receives the wakeup pattern “A” & “B”, the credential device would then transit its identifier to the readers 110_{z1} and 110_{z2}, the readers 110_{z1} 110_{z2} the then transmits the identifier along with the time of receipt of the identifier to the controller 120_{z}, the controller 120_{z} upon receipt of the transmissions then has a record of the identifier, the readers from which the identifier was received and the time of the reading of the identifier by the readers. Then as the credential device continues to moves to the field of range 898₂ (and out of the field of range 898₁) and receives the wakeup pattern “B”, the credential device could continuously transmit its identifier to the reader for the respective field of range that it is located in. The credential device would then transit its identifier to the reader 110_{z2}, the reader 110_{z2} then transmits the identifier along with the time of receipt of the identifier to the controller 120_{z}, the controller 120_{z} upon receipt of the transmission then has a record of the identifier, the reader from which the identifier was received and the time of the reading of the identifier by the reader. As the controller 120_{z} continuously receives the transmissions from the readers 110_{z1} 110_{z2}, the controller 120_{z} has a record of the credential device as a function of time and location (as defined by the field of ranges 898₁ 898₂ and overlapping field of range 899₁), which can then be used to determine the direction in which the credential device is traveling. For instance, FIG. 8E illustrates an example of a data record 870 of the database 860 which may be stored in the computer readable memory 550 of the controller 120_{z}. As illustrated, the data record 870 stores the identifier the location, the date and time of the identifier was read in a specific location and a movement determination based upon the location and date/time reading.

In the example above the credential device transmitted its identifier to the reader(s) regardless of whether the credential device received a dual wakeup pattern. In other cases, the credential device could be configured to only transmit its identifier to the reader(s) when a dual wakeup pattern is received. For instance, if a credential device moves in the field of range 898₁ and receives the wakeup pattern “A”, the credential device would not transit its identifier to the reader 110_{z1}. Then as the credential device moves to the overlapping field of range 899₁, it receives the wakeup pattern “A” & “B”, the credential device would then transit its identifier to the readers 110_{z1} and 110_{z2}, the readers 110_{z1} 110_{z2} then transmits the identifier along with the time of receipt of the identifier to the controller 120_{z}, the controller 120_{z} upon receipt of the transmissions then has a record of the identifier, the readers from which the identifier was received and the time of reading of the identifier by the reader. Then as the credential device continues to moves to the field of range 898₂ (and out of the field of range 898₁) and receives the wakeup pattern “B”, the credential device would stop transmitting to the readers 110_{z1} 110_{z2}. Then as the credential device moves to the overlapping field of range 899₂, it receives the wakeup pattern “B” & “C”, the credential device would then transit its identifier to the reader 110_{z2} and 110_{z3}, the readers 110_{z2} 110_{z3} then transmits the identifier along with the time of receipt of the identifier to the controller 120_{z}, the controller 120_{z} upon receipt of the transmissions then has a record of the identifier, the readers from which the identifier was received and the time of reading of the identifier by the reader. As the controller 120_{z} receives the transmissions from the readers 110_{z1} 110_{z2} 110_{z3}, the controller 120_{z} has a record of the credential device as a function of time and location (as defined by the overlapping field of ranges 899₁899₂), which can then be used to determine the direction in which the credential device is traveling.

Although the examples above were given in the context of the application where a credential device moves down a hall 890, the invention is not limited to such application. Other applications for multiple antennas for directional control may include automatic time and attendance, guard tour, inventory management and control, file management and control, wandering patients, and any other suitable application.

### Clashing Credential Devices & Readers

Readers that employ non-clashing credential devices allow authentication of a person's credential device at a reader of an access point while a second credential device is also being read by the reader. In contrast, readers that employ clashing may deny access to credential devices where more than one credential device is at an access point and being read by the reader.

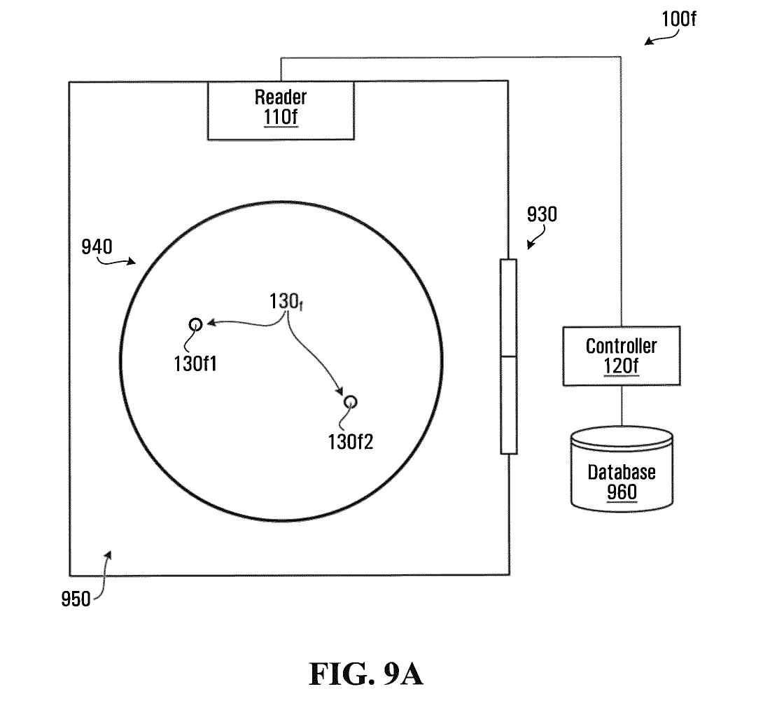

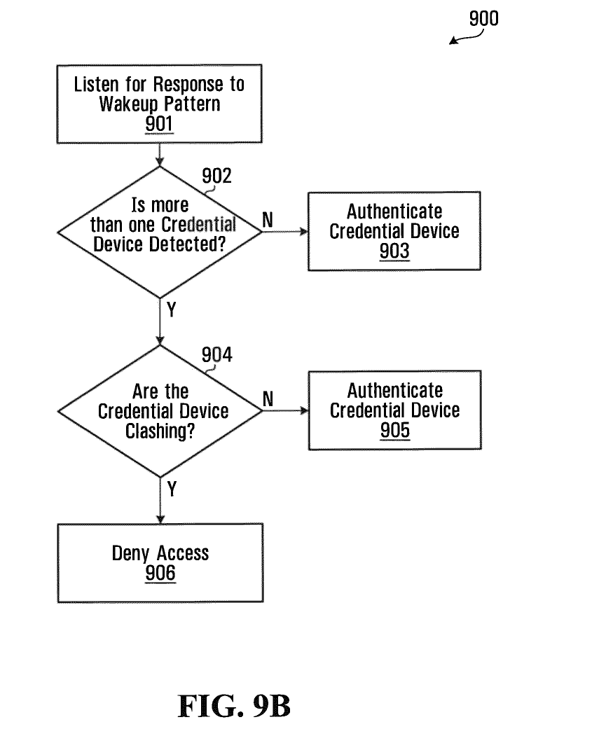

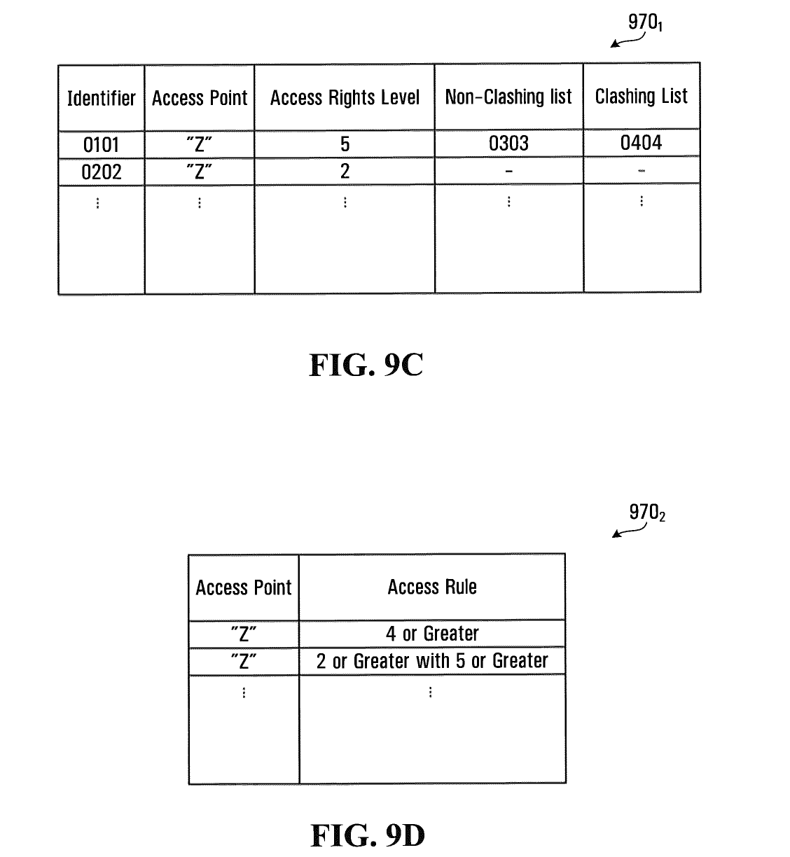

FIG. 9A illustrates an example of an access control system 100_{f} which includes a reader 110_{f} to be used with a plurality of credential device 130_{f}. The access control system 100_{f} is a specific non-limiting implementation of the access control system 100. Similarly, the reader 110_{f} and the credential devices 130_{f} are a specific non-limiting implementation of the reader 110 and the credential device 130, respectively. As illustrated, a plurality of credential devices 130_{f} is in a room 950 and a person associated with at least one of the credential devices 130_{f} has a desire to enter the access point 930 (e.g., a door). The reader 110_{f} comprises one or more antennas 310 which are configured to read the plurality of credential devices 130_{f} in the field of range 940 of the one or more antennas 310. More specifically, the reader 110_{f} obtains the identifiers for each of the credential devices 130_{f1} 130_{f2} present in the field of range 940. The reading of the credential devices 130_{f1} may take place sequentially (i.e., one after each other) such that it appears that they are all read at once. Each of the credential devices 130_{f1} 130_{f2} have respective identifiers “0101” and “0202”. The reader 110_{f} communicates to the controller 120_{f} the identifiers obtained by the reading from of credential devices 130_{f}. The controller 120_{f} may be part of the reader 110_{f} or may be a separate hardware devices (as illustrated). The controller 120_{f} is in communication with a database 960, which has one or more database tables 970₁ 970₂. The database 960 may be located in computer readable memory 450 within the controller 120_{f} or may be located in computer readable memory on one or more remote servers or host computers or even at the reader 110_{f}. The database table 970₁ stores a list of identifiers for all of the credential devices 130_{f}, a list of access points, an access right level for each of the access point for each of the identifiers, and a listing of identifiers for which clashing (i.e., access should be denied) or non-clashing exists (i.e., access should be granted). As illustrated in FIG. 9C, the database table 970₁ contains for access point “Z” (which corresponds to the door 930 of the room 950) that the user with a credential device having an identifier “0101” has an access rights level of “5”, the user with a credential device having an identifier “0202” has an access rights level of “2”. In addition, as illustrated, for access point “Z” the credential device with identifier “0101” can access this access point when the credential device “0303” is also present (i.e., these two credential device never clash at this location). Similarly, as illustrated, for access point “Z” the credential device with identifier “0101” cannot access this access point when the credential device with identifier “0404” is also present (i.e., these two credential device always clash at this location). As illustrated in FIG. 9D, the database table 970₂ contains for location “Z” that access will be granted for credential devices with an access rights level of “4” or greater and that access will also be granted for credential devices with an access rights level of “2” or greater when accompanied by a credential device having an access rights level of “5” or greater.

FIG. 9B illustrates an example method 900 which may be executed by the access control system 100_{f}. At step 901 the reader 110_{f} receives one or more identifiers of one or more credential devices in the field of range 940 of the reader 100_{f}, in response to the reader's wakeup pattern. At step 902 the reader 110_{f} determines if more than one credential device is detected. In the case that a single credential device is in the field of range 940 of the reader 100_{f}, then at step 903 the single credential device is authenticated and access is either granted or denied. If there is more than one credential device present in the field of range 940 of the reader 100_{f}, then at step 904 it is determined if the credential devices are clashing or not. As illustrated in FIG. 9A there are two credential devices 130_{f1} and 130₂ present in the field of range 940 with respective identifiers “0101” and “0202” and as such a determination is then made to determine if access can be granted or not. In some embodiments, the reader may enforce absolute clashing enforcement. That is, in some embodiments, if more than one reader is present in the field of range 940, then access will always be denied. However, in other embodiments, access may be made based on an access hierarchy. For example, if the access hierarchy set out in FIGS. 9C and 9D is applied to the credential devices 130_{f1} and 130₂ having respective identifiers “0101” and “0202”, then no clashing would be determined and access would be granted, as the credential device 130_{f1} and 130_{f12} with respective identifiers “0101” and “0202” are not clashing identifiers as set out in the clashing list of table 970₁. However, if the credential device 130_{f2} had the identifier 0404, then there would be clashing and access would be denied, as indicated at step 906. Continuing with the example where the credential device 130_{f1} and 130_{f12} have respective identifiers “0101” and “0202”, at step 905 authentication of the credential devices would occur, and access would be granted. In this example, access is granted because the credential device 130_{f1} has authorization for access to this access point (as its access rights level is “5”, which is greater than “4”) and the credential device 130_{f2} has authorization for access to this access point when accompanied with the credential device 130_{f1} (as credential device 130_{f2} can gain access when with a credential device that has an access rights level of “5” of greater).

As discussed in the example above, it is appreciated that the access control system 100_{f} may be configured to enforce clashing in different ways, for example based on absolute clashing (i.e., two credential devices can never by in the field of the reader at once), based on a list of clashing and/or non-clashing identifiers of credential devices, or based on access rights levels and rules for an access point. As the latter two configurations were discussed above, the first configuration (i.e., absolute clashing) will be briefly discussed below.

There may be specific applications in which an administrator of an access control system would want absolute clashing. In this case, if two users with credential devices are in the field of the reader, one of the users would have to exit the field area momentarily and then re-enter to be once again authenticated. For instance, at this point the reader may emit a continuous beeping indicating to others wish to gain access that there is a need for one of the credential devices to leave the field of the reader as the door will not open. The credential devices may only be polled once for the authentication process and the reader(s) would be programmed to not read if more than one credential device is in the area. In other words, an access control system that implements absolute clashing may be configured such that it would only allow for one credential device to be in the field of the reader(s) for the reader(s)/controller to authenticate the credential device.

In general, the applications of readers that employ any of the clashing techniques above may include article surveillance in which as an example, a computer, or other high value item (such as artwork, files, folders, drug carts, rolling medical carts, rolling tool chests, or any other suitable item), would be tagged with a credential device and exit from the area would not be possible. Where a credential device is coupled to a high value item, exit from the area may not possible because the user taking the high value item would have to use his/her credential device to exit the area and the clashing of the two credential devices in the reader's field area would prevent the opening of the doors to leave the area.

However, in the context of the example above, if the identifier of the credential device of the user taking the high value item (having a credential device coupled to it) out of an access point has access rights associated with the high value item (e.g., as stored in an access rights list in a database), then access could then be granted.

Although in the embodiments discussed above, an access hierarchy was applied based on access rights levels and by the use of list of identifiers of classing and non-clashing credential devices, the access control system may be implemented solely on a list of clashing and/or non-clashing identifiers to make the access point authentication decision (i.e., the use of the access rights levels and rules may be optional in some embodiments of the invention).

### One-Time Recognition

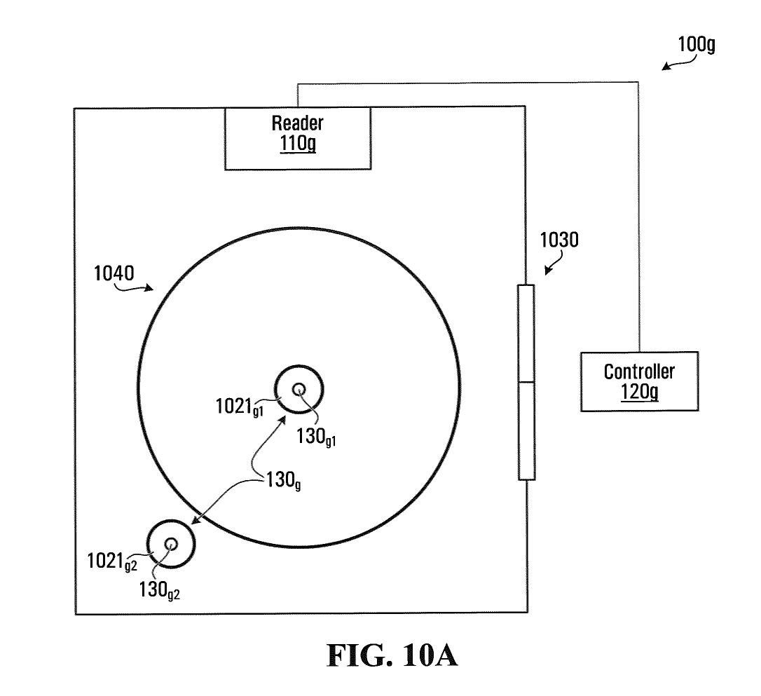

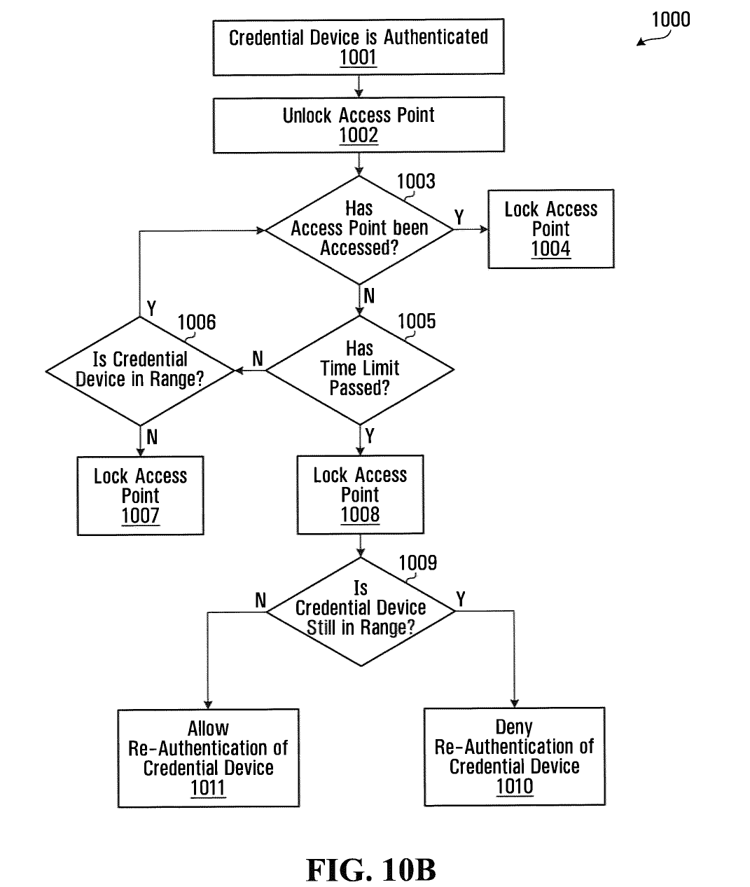

FIG. 10A illustrates an example of an access control system 100_{g} which includes a reader 110_{g} to be used with a credential device 130_{g}. The access control system 100_{g} is a specific non-limiting implementation of the access control system 100. Similarly, the reader 110_{g} and the credential device 130_{g} are a specific non-limiting implementation of the reader 110 and the credential device 130, respectively. In this example, the wakeup antenna 310 of the reader 110_{g} has a field of range 1040. As illustrated at a time t=1 the person 1021₁ (where the subscript indicates the person at time t=1) with the credential device 130_{g1} (which corresponds to the credential device 130_{g} at time t=1) is in the field of range 1040. At a later time t=2 the person 1021₂ (where the subscript indicates the person at time t=2) with the credential device 130_{g2} (which corresponds to the credential device 130_{g} at time t=2) leaves the field of range 1040 such that the credential device 130_{g2} of the person 1021₂ is no longer receiving the wakeup pattern from the reader 110g.

The reader 110_{g} may be in communication (wired or wirelessly) with a controller 120_{g} via the reader's controller communication module 340 and the controller's reader communication module 540.

FIG. 10B illustrates an example method 1000 which may be executed by the access control system 100_{g} at either the reader 110_{g} and/or the controller 120_{g}. As illustrated, at step 1001, the credential device is authenticated to determine if access is to be granted or not. If access is granted, then at step 1002 the access point 1030 is unlocked. Then at step 1003 the access point 1030 is monitored to determine if the access point has been accessed or not. If the access point is accessed (e.g., checking a door status contact that the door did open) then the access point is locked after access has been made, as illustrated in step 1004. On the other hand, if the access point is not accessed then at step 1005 a determination is made as to whether a predefined time limit has past. If the time limit has not past the access point remains unlocked, and then at step 1006 a determination is made as to whether the credential device 130_{g} is still in range. If the credential device 130_{g} has not left the field of range 1040, as illustrated by the credential device 130_{g1}, then the method goes back to step 1003. However, if the credential device 130_{g} has left the field of range 1040, as illustrated by the credential device 130_{g2}, then the access point is locked at step 1007. At step 1005, if the set time limit has past, then at step 1008 the access point is locked. Next, at step 1009 a determination is made as to whether the credential device 130_{g} is still in range. If the credential device is still in range, re-authentication of the credential device cannot take place until the credential device 130_{g1} leaves the field of range 1040. Once the credential device 130_{g} leaves the field of range 1040, as illustrated by the credential device 130_{g2}, then the access control system 100_{g} may allow authentication of the credential device 130_{g}, once the credential device 130_{g} re-enters the field of range 1040.

It is appreciated that the access control system 100_{g} as configured may provide one-time recognition to cases where the access point is a door. In this case, a user with a credential device enters the field of range area of the wakeup antennas and the door is unlocked, but the user does not open the door within a set period of time and the door locks. In this case, if the user does not exit the field area of the wakeup antennas, the doors remain locked. In order for the user to re-unlock the door, the credential device of the user must exit and re-enter the wakeup antenna's field area.

A sounder output may be provided by the reader which could continuously pulse a sounding signal (via onboard piezo speaker as well as a driver output wire) thus providing an audible indication to the user that they must try again once the set time limit has expired.

The set time limit in some implementation of the embodiment discussed above may be in range of 3 to 5 seconds, but could be any number of seconds, minutes, or hours depending upon the functionality needed.

This one-time time recognition may be incorporated in to a system with video surveillance which may provide additional and useful information to a guard or remote monitoring station.

### Programming of Credential Devices

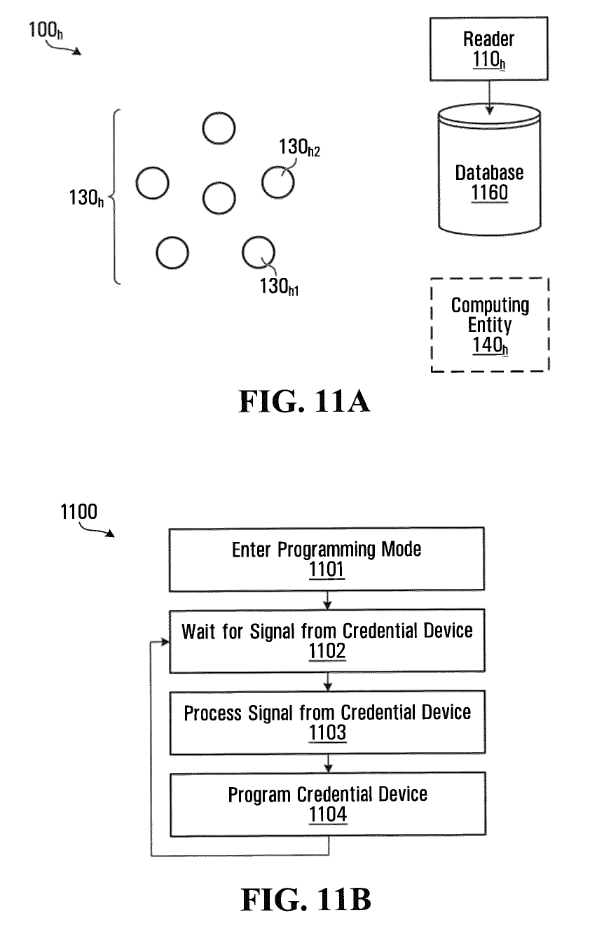

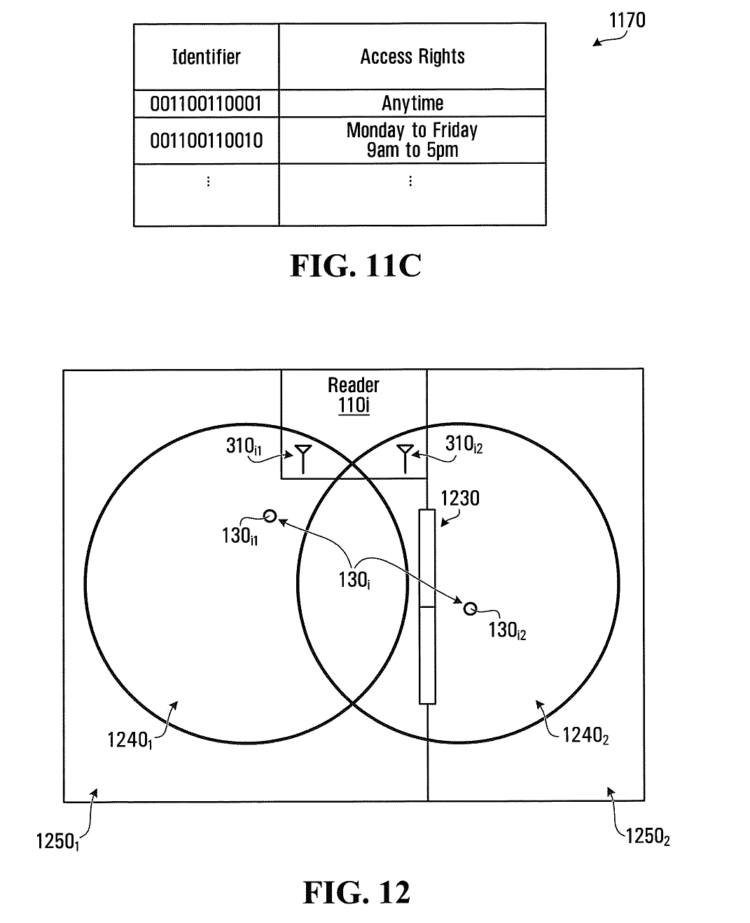

FIG. 11A illustrates an example of an access control system 100ₕ for use in programming a plurality of credential device 130ₕ via a reader 110ₕ. The access control system 100ₕ may also be configured to be used with an optional computing entity 140ₕ (i.e., the computing entity 140ₕ is illustrated by a dotted line to indicate that it is optional). The access control system 100ₕ is a specific non-limiting implementation of the access control system 100. Similarly, the reader 110ₕ, the credential devices 130ₕ, and computing entity 140ₕ are a specific non-limiting implementation of the reader 110, the credential device 130 and the computing entity 140, respectively.

FIG. 11B illustrates an example method 1100 which may be executed by the access control system 100ₕ. At step 1101 the reader 110ₕ enters a programming mode. For example, the programming mode may be entered into by pushing one or more buttons in the inside or back of the reader 110ₕ after the reader 110ₕ is powered up. The use of one or more push buttons is typically used in the embodiments where the computer entity 140ₕ is not used for programming the computing entity 140ₕ. In cases where the computing entity 140ₕ is used, the reader 110ₕ may be connected wired or wirelessly (e.g., Wi-Fi, Bluetooth, or any other suitable form of wireless communication) to the computing entity 140ₕ (which may be a laptop, or other device such as a smart phone, tablet, or any other suitable device). The programming mode may then be entered into by the computing entity 140ₕ connecting to the reader 110ₕ and then adjusting the settings of the reader 110ₕ such that it enters into the programming mode. One or more indicators on the reader 110ₕ such as visual indicator (LED, LCD, etc.) and/or audio indicator (e.g., piezo sounder, etc.) may be presented to the user to indicate to the user that the reader is in the programming mode. In the cases where the computing entity 140ₕ is used, the display and/or speakers of the computing entity 140ₕ may present an indication to the user that the reader is in the programming mode.

In this example the program mode is set for adding credential devices; however, the programming mode could be applied to updating and/or removing access of the credential devices 130ₕ. Each credential devices 130ₕ contains a factory preset initial identifier (e.g., a 48 bit identifier number or any other suitable bit length alpha and/or numeric identifier) which may be the credential devices' 130ₕ first transmitted signal to the reader, in this example of adding credential devices 130ₕ to the reader 110ₕ. When reader 110ₕ is in the programming mode, the credential devices 130ₕ can be placed in the range of the wakeup antenna 310 of the reader 110ₕ, allowing the credential devices 130ₕ and the reader 110ₕ to possibly communicate with each other.

At step 1102, the reader 110ₕ waits for the signal from one of the credential devices 130ₕ. For instance, when one of the credential devices 130ₕ₁ is placed in the range of the wakeup antenna 310 of the reader 110ₕ and is shaken for a predetermined period of time (e.g., 3 or more seconds, or any other suitable time), the credential device 130ₕ₁ could then go into a preparation mode. The preparation mode may include the credential device 130ₕ₁ sending a signal to the reader 110ₕ that includes its initial identifier and an indication that it is able to receive programming instructions. The preparation mode may also include the credential device 130ₕ₁ waiting for instructions from the reader 110ₕ including the receipt of a new identifier.

The pattern of shaking may be a soft shaking pattern which is in rhythm with the movement of a hand shaking the credential device 130ₕ₁, may be short in duration and amplitude, or any other suitable shaking pattern. The credential device 130ₕ₁ may have an algorithm stored in memory 450 which is executed by the data processor 430 based on data provided by the motion sensor 495 which senses the shaking movement, to determine if the credential device 130ₕ₁ is being shaken according to the pattern. Once the data processor 430 of the credential device 130ₕ₁ determines that the credential device 130ₕ₁ is being shaken, it directs the reader communication module 420 to send the initial identifier to the reader 110ₕ via the antenna 410.

At step 1103 the reader 110ₕ processes the received signal from the credential device 130ₕ₁ and determines that the credential device 130ₕ₁ is ready for receiving programming instructions. For example, when the reader 110ₕ receives the initial identifier, it may then create a short programming sequence which would then transmit to the credential device 130ₕ₁ a new unique identifier. The changing of the initial identifier to the new unique identifier may be according to sequential identifiers as per the site of use of the credential device 130ₕ₁ and the initial identifier number of the credential device 130ₕ₁. In addition to updating the identifier of the credential device 130ₕ₁, the reader 110ₕ may also set the optional RSSI range (discussed elsewhere) as well as perform a diagnostic test (including battery performance) for FAIL or PASS of the credential device 130ₕ₁. An indicator such as visual indicator (LED, LCD, etc.) and/or audio indicator (e.g., piezo sounder, etc.) may be presented to the user to indicate to the user that the device has been successfully added or not. At this step the database 1160 stored in the memory 350 of the reader 110ₕ is then updated to indicate the addition of the credential device 130ₕ₁ (e.g., the credential device's identifier is stored) and the credential device's access rights. FIG. 11C illustrates an example of the table 1170 of the database 760, which maintains a list of identifiers and corresponding access rights.

Once the credential device 130ₕ₁ is programmed, the method 1100 goes back to step 1102 and waits for a second credential device 130ₕ₂ to be shaken and sends a signal for programming. This process can be repeated tens of times, hundreds of times, thousands of times, and so forth, until the reader 110ₕ receives an indication that it is to exit the programming mode. The exit of the programming mode could be done by pushing a button in the inside or back of the reader or may be done by the computing entity 140ₕ connecting to the reader 110ₕ and then adjusting the settings of the reader 110ₕ such that it exits the programming mode.

It is appreciated that such a method for programming the credential devices 130ₕ may allow for only one (e.g., 130ₕ₁) of many credential devices 130ₕ in the field or range area of the reader 110ₕ to be identified at a specific instance.

Although the example above was given in the context of added a credential device 130ₕ₁, the programming mode may be used to update and/or delete credential devices.

When added credential devices 130ₕ to the reader 110h, the programming mode may be configured such that the credential devices 130ₕ have access restricted based on time of day, time of the week, etc. For example, the credential device 130ₕ₁ could be added such that it can only gain access Monday to Friday and between 9 AM and 5 PM. As such, in this example, at a later time it may be desirable for the credential device 130ₕ₁ to be updated to change the access time so the credential device 130ₕ₁ can gain access at any time. In this case the credential device 130ₕ₁ could be updated by entering the program mode for updating the credential device 130ₕ₁. Similar to the case of adding the credential device 130ₕ₁, one or more buttons could be pushed to enter the programming mode and the credential device 130ₕ₁ could then be shaken to update the credential device 130ₕ₁. In other cases, the access of the credential device 130ₕ₁ may be deleted. Similar to the case of adding the credential device 130ₕ₁, one or more buttons could be pushed to enter the programming mode and the credential device 130ₕ₁ could then be shaken to remove access rights to the credential device 130ₕ₁.

In other words, after the pushing of one or more buttons on the back or inside of the reader 110ₕ to enter the program mode an indicator such as visual indicator (LED, LCD, etc.) and/or audio indicator (e.g., piezo sounder, etc.) may be presented to the user to indicate to the user which programming mode of operation it is in (e.g., add with no time/day constraints, add with specified time/day constraints, update, delete) then the user can shake the credential device 130ₕ₁ to indicate that this devices is to be added, update or deleted, depending on the program mode set. In the cases where a computing entity 140ₕ is used, the indication of the programming mode could be displayed on a display of the computing entity 140ₕ.

An SHA secure chip may also be used to provide in the reader 110ₕ to provide additional security through means of encryption as well as a challenge response authentication.

It is appreciated that such a method for programming the credential devices 130ₕ may allow for different modes of program.

For example, in a first mode of program a specific limited number of credential devices 130ₕ may be programmed in sequence. In this example, the number of credential devices 130ₕ is set to 10, but any suitable number could be used. An installer of the reader 110ₕ could push and hold the programming button until a buzzer emits a series of sound pulses. Then the button would be released and the LED could now stay on indicating that it is ready to accept the first credential 130ₕ₁. Each credential device 130ₕ could be sequentially added as the shaking pattern is first detected.

A second mode of programming may allow an installer to program the reader 110ₕ to auto learn 1000 or more (or any other suitable number) credential devices 130ₕ in sequence of presenting them to the reader 110ₕ. In this example, the installer could push and hold the programming button until the buzzer emits a series of sound pulses. Then the button could be released and may be pressed again to set the mode to add a credential device. At this point the LED could now stay on indicating that it is ready to accept the first credential device 130ₕ₁. The credential device 130ₕ₁ from many could be held and shaken to a pattern for approximately 3 seconds. The reader 110ₕ could then program the credential 130ₕ₁ into its internal database. The LED could then flash several times indicating a successful addition and then could remain lit again ready for the next credential device 130ₕ₂ and so on. When the programming of the credential devices 130ₕ has been completed the installer could once again press and hold the button until the buzzer emits a series of sound pulses indicating that programming has been exited. A series of sound pulses of different sequence could also be automatically generated during sequential programming in the event that the maximum number of credentials has been stored by the reader.

In some embodiments a 3 digit 7 segment LED display with decimal points could be used in the programming of the credential devices. It is appreciated that 1 to 7 programming modes could be accommodated with the small 3 digit display and a single push button. For example, the button on the reader could be pushed and held until the LED indicates “-1-”. This “-1-” indicates the step to add credential devices. Then when user presses the button again a “-2-” could be displayed which indicates the step to remove credential devices. The user could then push and hold the button which could then scroll the display through all the available credential devices and then it could be pressed again to remove the desired credential device. Holding the button scrolls slowly through 001 to 999, then scrolling speeds up, releasing the button allows scrolling speed to slow down, which may include an increment of one credential device at a time (e.g., 001-002-003-004). The other modes of programming could include the time of day, unit number (e.g., unit number of the reader where there a multiple readers in use), relay time, relay output type (e.g., normally opened vs. normally closed) and a copy mode (e.g., to copy settings for one credential to another or to copy from legacy readers).

It is appreciated that in the first and second mode of programming, the computing entity 140ₕ may not be required to be used to program the credential devices 130ₕ.

In a third mode of programming the computing entity 140ₕ is utilized. In this example, the computing entity 140ₕ is a cell phone (but any portable computing entity could be used), which can connect via WiFi or Bluetooth (or any other suitable means) to the reader 110ₕ. The programming mode may then be entered into by the computing entity 140ₕ connecting to the reader 110ₕ and then adjusting the settings of the reader 110ₕ such that it enters into the programming mode. At this point the display of the cell phone may indicate that it is ready to accept the first credential device 130ₕ₁. The credential device 130ₕ₁ from many would be held and shaken to a pattern for approximately 3 seconds. The reader 110ₕ would then program the credential 130ₕ₁ into its internal database. Another indication may be made on the display of the cell phone to indicate a successful addition and that the next credential device 130ₕ₂ can be added.

### Credential Device Shaking

Once the credential devices 130 have been programmed, the shaking pattern (previously discussed) may be used for various other applications including signaling such as remote controlling of auxiliary relays for increased functionality, or to allow a person to signal a danger or panic situation.

An example of the case where an auxiliary relay may be used is in the case where the credential device 130 is in the range of the reader 110, the reader 110 may unlock (via a first relay) an electronic lock on a door. Then if the user with the credential device 130 shakes the credential device 130, then the door may automatically open (via a second relay).

An example of the case where a danger or panic situation is in a highly secure facility where a user can shake their credential device 130 which may cause all of the access points to be locked down.

An example of the case where a danger or panic situation is in a medical care facility, a patient or resident may shake their credential device, or press and hold a button on the credential device for a number of seconds such as 3 seconds or more (to avoid false activations from momentary presses) 130 when they need emergency assistance.

In these cases the motion sensor 495 of the credential device 130 detects the shaking and transmits the motion data to the data processor 430. The credential device 130 may have an algorithm stored in memory 450 which is executed by the data processor 430 based on data provided by the motion sensor 495 to determine if the credential device 130 is being shaken according to a specific pattern. Once the data processor 430 of the credential device 130 determines that the credential device 130 is being shaken according to the specific pattern, it directs the reader communication module 420 to send a panic signal to the reader 110 via the antenna 410. The reader 110 can then set an alarm, forward the panic signal to the controller 120, and/or notify the appropriate personnel of the emergency situation. This panic signal may also be used to initiate an automatic lockdown of any or all doors being normally unlocked during regular working hours, These may include but not limited to main lobby doors, school classroom doors, research areas, etc.

The communication module 420 can be designed to encode the data stream from the credential device 130 to the reader 110 in a manner to convey the panic situation. For instance, certain bits can be changed, which the reader 110 is designed to recognize indicative of a panic. In turn, the reader 110 can convey a message to the controller 120 to perform the desired response to the panic situation.

Note that the reader 110 can be programmed to recognize the panic situation even when the credential device 130 is not one to which access can be granted. In this fashion, the arrangement of readers 110 in a building or other facility can be used to sense emergency events for anyone that carries a credential device 130 and not merely those for which access can be granted.

### Adjustable Range Settings

In some embodiments, one or more multi-position slide switches, or selectable terminal connector blocks are provided in the readers 110 which can be configured to set the power level of the wakeup antenna(s) 310. The setting of the power of the wakeup antennas 310 determines the range in which the credential devices 130 would wake up. For example, for each wakeup antenna 310, a three position switch may be provided which has settings of short, medium and long. As such, each wake up antenna may be set at a different range setting from the other, in the event that two wake up antennas are used at the same access point. For example, the short setting may be approximately 3 feet, the medium setting may be approximately 6 feet, and the long setting may be approximately 12 to 18 feet. Short may be for most single door or elevator access control situations, whereas medium and long may be used for garage door control, monitoring valuables, guard tour, large automated entrance doors, retirement homes, etc. In the case that two wakeup antennas 310 are provided, two switches could be provided for a technician to independently adjust the range of each wakeup antenna 310.

In other embodiments, the manual switches could be replaced by controllable power drivers that could be controlled onside or remotely by a computing entity 140. The controllable power drivers could provide an incremental range control which is not limited to the three set positions discussed above. The reader 110 in this case would be able to step up or down the power needed, as well as storing the setting in memory 350 which can be remotely accessed and changed by those having been granted authority to do so. This remote control may reduce site service visits for simple changes and may eliminate the need for the installer to remove a reader that was installed in a wall just to change the setting. By way of example, the reader 110 may be accessed by the computing entity 140 in the form of a portable computing device, such as a tablet or cell phone, which can connect via WiFi or Bluetooth (or any other suitable means) to the reader 110 and adjust the power range of the antennas 310. In other cases, the computing entity 140 may be any suitable computing device which accesses the reader remotely via data connection, such as a WAN, LAN or Internet connection, to adjust the power range of the antennas 310.

In other embodiments, the manual switches could be replaced by a print head driver IC which has 8 programmable outputs, and the current flowing to the one or more wakeup antennas 310 could be incremented in logical steps via the programming of the reader 110.

In other embodiments, the use of slide switches for setting range can be eliminated by use of the received signal strength indicator (RSSI signal) provided by the communication module 420 (such as available in chips available from Austria Micro) in the credential device 130. In this manner, the range can be precisely programmed into the credential device 130 based on the RSSI signal value. For instance, the memory 450 of the credential device 130 may store a range indicator of low, medium or high range. The communication module 420 could output an RSSI signal to the data processor 430 which compares the signal to the range indicator. More specifically, if a low RSSI signal is received and the range indicator is set to high, the data process could determine that the credential device 130 should communicate with reader 110. However, if a low RSSI signal is received and the range indicator is set to high, data process would determine that the credential device 130 should not communicate with reader 110, but should wait till a high RSSI signal is received.

The programming of the range may be done by the installer during the programming of the credential devices 130. For example, the installer may elect to have all credential devices 130 for that site or client set to short, medium or long range. Alternatively, the installer may elect to have a specific group of credential devices set to a specific range and a different group of credential devices set to a different specific range.

It is appreciated that of a plurality of credential devices 130, several can be uniquely tailored to the specific needs of the site. For instance, persons with mobility issues can have their credential devices set for a long range. Similarly, wandering patients credentials can be set for longer range whereas employees such as nurses or caregivers can have the standard range set by the reader for the particular access point. In other words, a first credential device can have a different range setting for first reader and a different range setting for a second reader, and a second credential device can have a different range setting for a first reader and a second reader that differs from the first credential device.

In other cases, the reader 110 may be programmed to provide a signal to the credential devices 130 that indicates the range at which the credential device 130 is to respond to the wakeup pattern of the reader 110. For instance, several unique wakeup patterns may be provided by the reader 110 which would let the credential devices 130, attempting to gain access of an access point, known that the access point has a predetermined range. For example, a reader 110 with a three foot setting could emanate a 125 kHz wake up signal for different preprogrammed distances, which broadcasts to credential devices 130 to inform the credential devices 130 that the distance required is three feet. The credential device would then immediately calculate the received RSSI and only transmit at this distance.

### Battery Level Monitoring

Battery level monitoring may be integrated into the credential devices 130 where the data processor 430 may have a dedicated analog input to read the battery voltage upon transmittal of the identifier to the reader 110. At this transmittal event, the current needed by the credential device 130 may be at its highest point (as opposed to a periodic wakeup, or deep sleep when there is no movement of the credential) and if the voltage falls below a preprogrammed level, the credential device 130 sends this additional data to the reader 110 at the point of access. The reader 110 can be set to sound its piezo sounder with a unique tone or frequency to alert the user. The reader may also send the identification of the credential device 130 with low battery signal to the system administrator by means of a text message, e-mail alert, etc. It is appreciated that when the batter level is low, a notice is sent to a computing entity associated with a user, wherein the user is associated with the retrofit credentials device

### Dual Wakeup Antennas & Exit Control

Dual wakeup antennas may be used in a single reader where one antenna is used for gaining access and the other antenna is used for exiting the access controller area.

### Dual Wakeup Antennas for a Doorway Access Point:

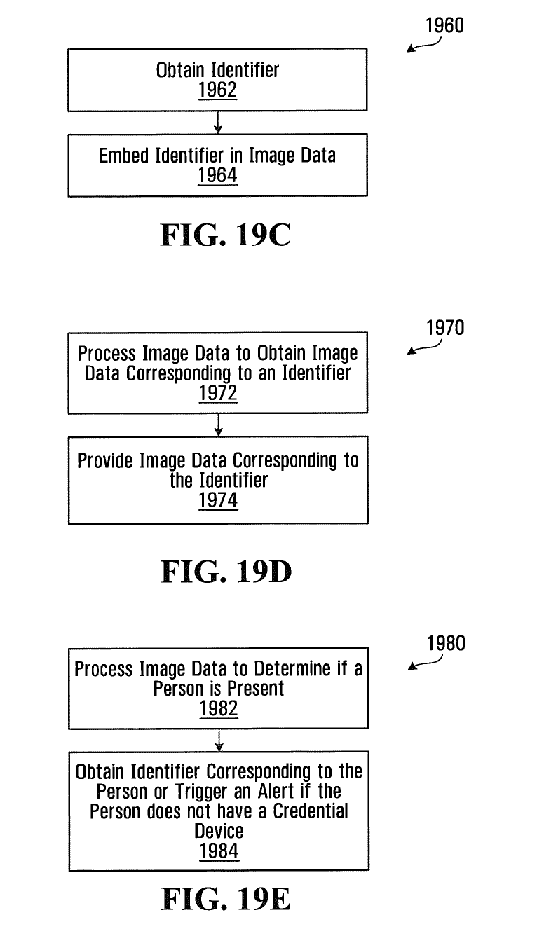

FIG. 12 illustrates an example of an access control system 100ᵢ which includes a reader 110ᵢ to be used with a plurality of credential devices 130ᵢ. The access control system 100ᵢ is a specific non-limiting implementation of the access control system 100. Similarly, the reader 110ᵢ and the credential devices 130ᵢ are a specific non-limiting implementation of the reader 110 and the credential device 130, respectively. As illustrated, the reader 110ᵢ comprises two wakeup antennas 310ᵢ₁ 310ᵢ₂. The two wakeup antennas 310ᵢ₁ and 310ᵢ₂ are positioned such that each antenna defines a field of range 1240₁ and 1240₂, respectively. As illustrated, the range 1240₁ of the first wakeup antennas 310ᵢ₁ is substantially on the exterior of the access appoint 1230, while the range 1240₂ of the second wakeup antennas 310ᵢ₂ is substantially on the interior of the access appoint 1230.

By using two separate wake up antennas 310ᵢ₁ 310ᵢ₂, each antenna may be configured to transmit a unique 125 kHz unique wakeup pattern to define unique field of ranges 1240₁ 1240₂. As such, a single reader 110ᵢ may determine the direction of a credential 130ᵢ with respect to the access control point 1230. If a credential 130ᵢ₁ positioned on the exterior 1250₁ of the access point 1230 responds to an entering area wakeup pattern from the antenna 310ᵢ₁ on the exterior 1250₁ of the access point 1230, then the reader 110ᵢ may assume this is a credential device attempting to entering the access point 1230, on the other hand if a credential device 130ᵢ₂ on the interior 1250₂ of the access point 1230 responds to the exiting area bit pattern from the second antenna 310ᵢ₂, then the reader 110ᵢ may assume that the credential device 130ᵢ₂ is exiting the area 1250₂.

Such a configuration may allow for the location status of the credential device 130ᵢ. For instance, the reader 110ᵢ may track where the credential device 130ᵢ entered the access point, entered the range of the antenna but did not enter the access point, is currently positioned in a range of one of the antennas, exited the access point, entered the range of the antenna but did not exit the access point, etc.

Additionally, an anti-tailgating functionality may be implemented by providing a barrier beam at the access point 1230.

### Dual Wakeup Antennas for a Gate or Garage Access Point:

The access control system 100; may also be used for gate and garage entry and exit control. For example, as illustrated in FIG. 12 a single reader 110ᵢ has two wakeup antennas 310ᵢ₁ and 310ᵢ₂ and the antennas are positioned/placed so that a vehicle containing a credential device 130ᵢ₁ approaching from the exterior 1250₁ of the secured area 1250₂ and wishing to gain access could drive towards the first wakeup antenna 310ᵢ₁ on the exterior of the secured area 1250₂. The first wakeup antenna 310ᵢ₁ could then reply with its wakeup pattern which could grant access based upon the program parameters and the access could then be logged in a database. When a vehicle wishing to exit the garage approaches the second wakeup antenna 310ᵢ₂ (which could be positioned in the interior area 1250₂, although not illustrated as such in FIG. 12) could activate the credential device 130ᵢ₂ which could reply with its identifier which could then grant exit access based upon the programmed parameters. The system could then log this event as an exit of the garage.

In some embodiments, additional sensors such as vehicle buried loop, magnetic field, or optical/microwave could be used to exclude people walking with a valid credential yet they are not in a vehicle. This could be useful for areas that need additional control to prevent residents or employees with credential devices from falsely activating the overhead garage door or gate by casually walking by. An example would be a resident is bringing refuse or recyclables to the garage and therefore the system does not need to open the garage or gate which could compromise security since there is no vehicle present.

### Dual Credential Device Authorization

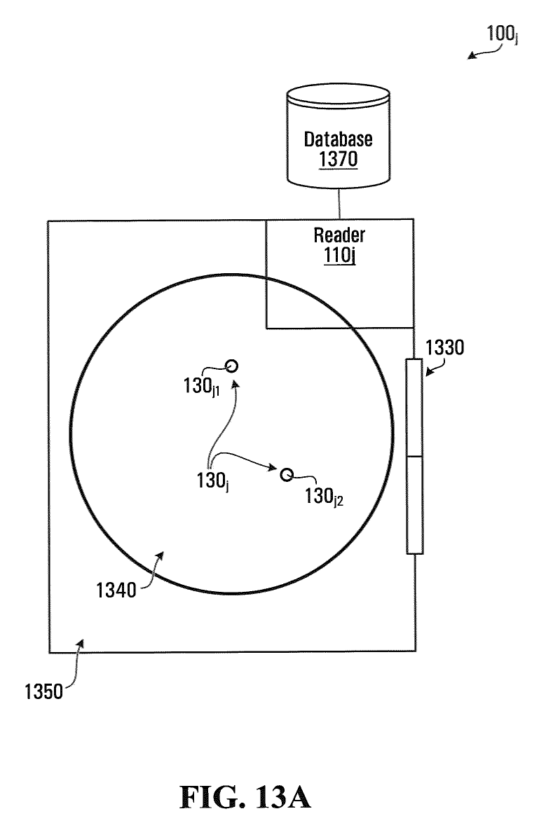

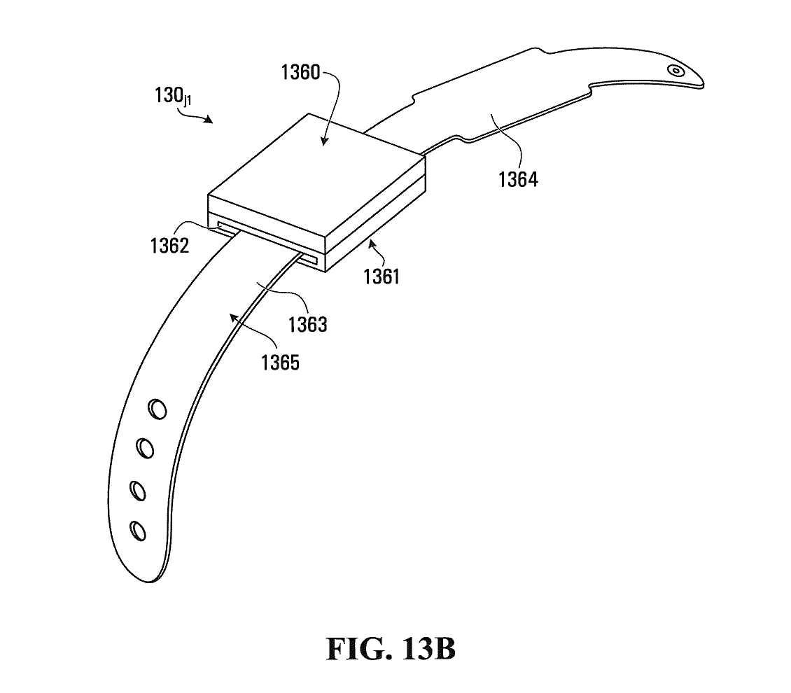

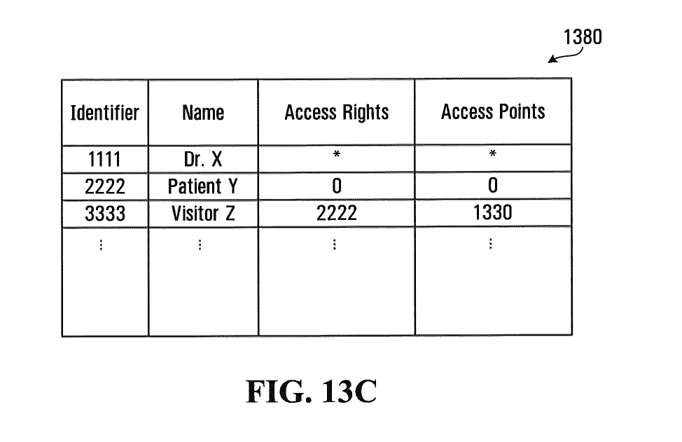

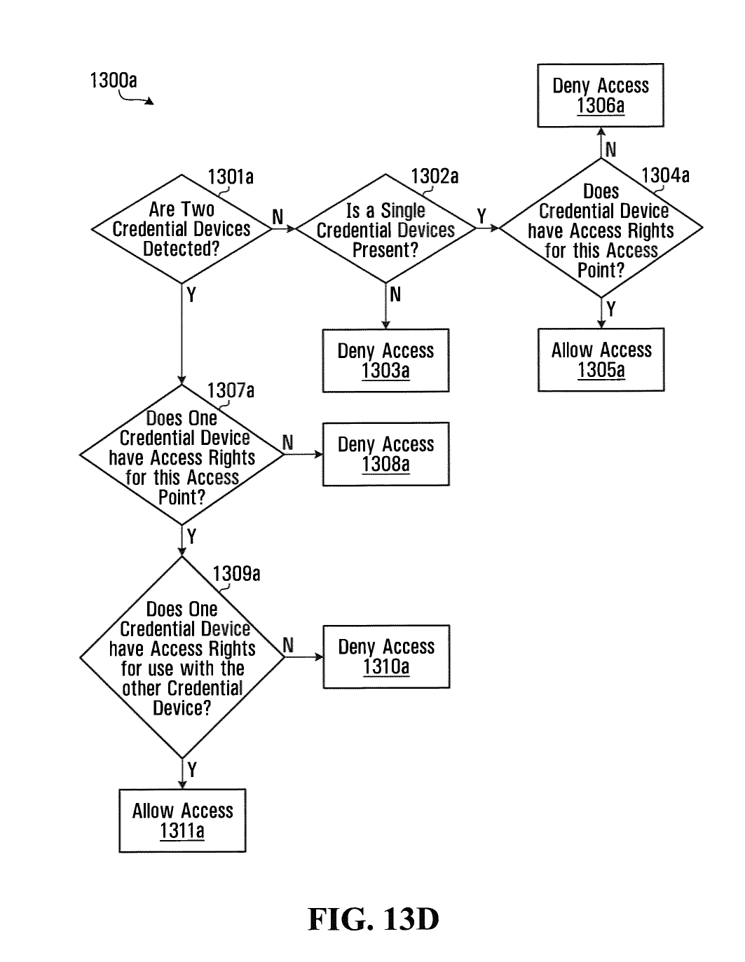

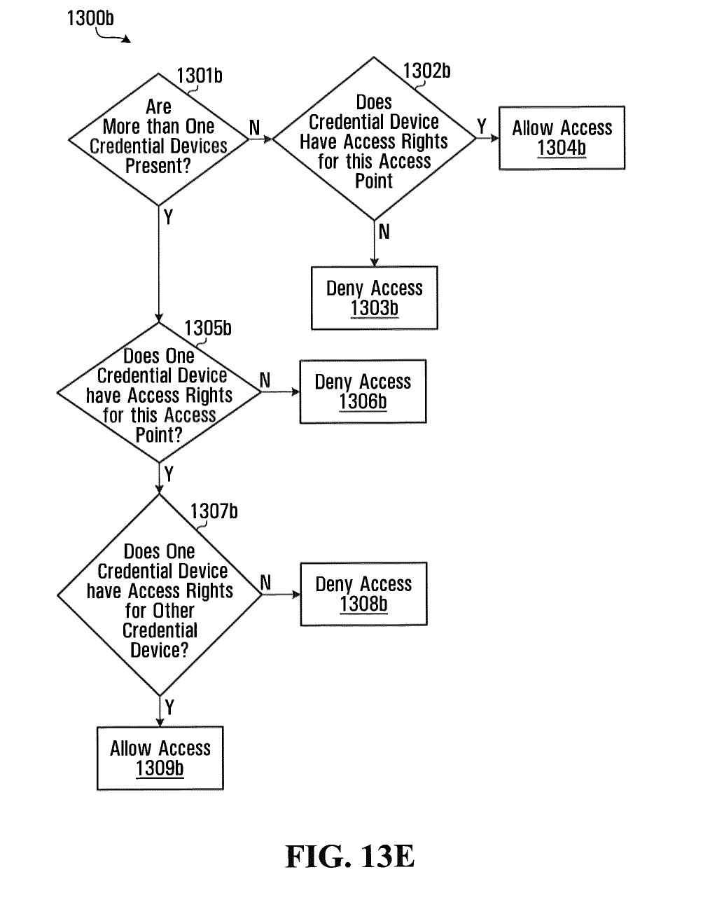

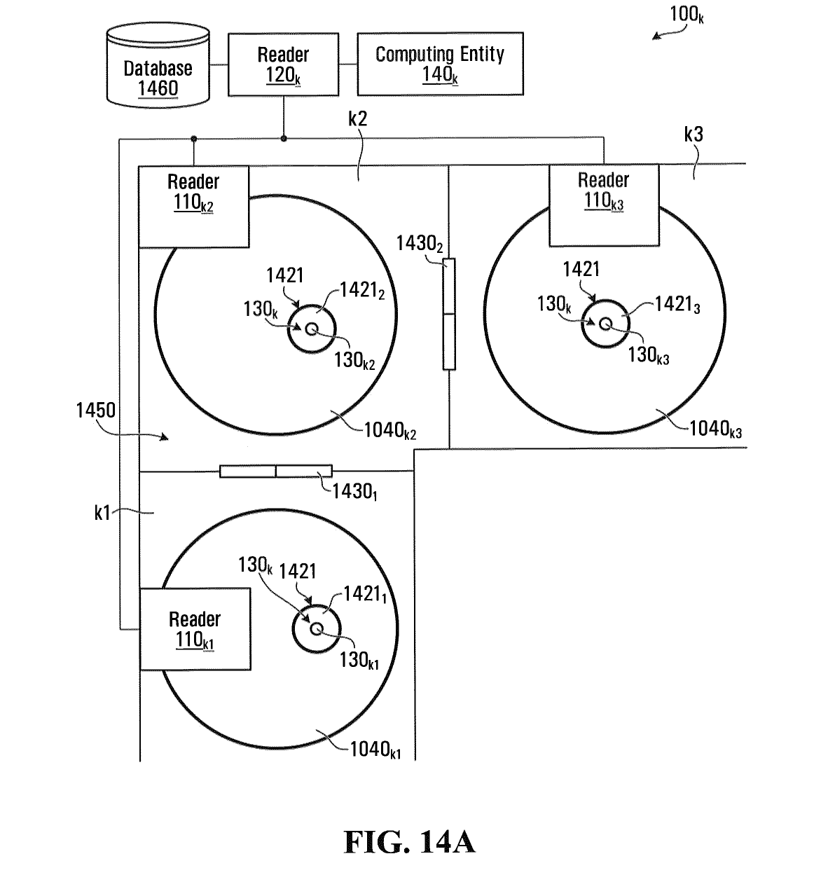

FIG. 13A illustrates an example of an access control system 100ⱼ which includes a reader 110ⱼ to be used with a plurality of credential device 130ⱼ. The access control system 100ⱼ is a specific non-limiting implementation of the access control system 100. Similarly, the reader 110ⱼ and the credential devices 130ⱼ are a specific non-limiting implementation of the reader 110 and the credential device 130, respectively.

The access control system 100ⱼ will now be discussed in the case of a wandering patient. In certain circumstances, it may be desirable to restrict access or to monitor the whereabouts of patients at hospitals and other facility where supervision is provided (e.g., nursing homes). As such, a patient may be provided with a credential device 130ⱼ₁ in the form of a molded wristband. In other cases, as illustrated in FIG. 13B, the credential device 130ⱼ₁ could have a bottom half 1361 and a top half 1360, where the top half 1360 houses the operational components of the credential device 130ⱼ₁ and the bottom half 1361 having a small rectangular tunnel 1362 that may accommodate a present hospital wrist band 1365 which have a narrow side 1363 which may slip through the tunnel 1362 and then be attached. The larger side 1364 of the identification wristband 1365 may be on the top of a patient's wrist, while the credential device 130ⱼ₁ may remain on the bottom of the wrist.

The reader 110ᵢ in this example is positioned near a door 1330. However, typically multiple readers could be used and be positioned at all exit doors and elevator cabs of a building. Typically, these doors and elevator cabs could not be locked and anyone would be free to enter and exit through these access points. However, if the patient with the credential device 130ⱼ₁ is not permitted to leave a particular floor or area, then the access control system 100ⱼ could be programmed to lock the door or stop the elevator from travelling if the patient is in the proximity of the exit chock point. In other words, the credential device 130ⱼ₁ blocks access to an access point that would be accessible if the person did not have the credential device 130ⱼ₁.

By way of example, if the patient with the credential device 130ⱼ₁ entered the field of range 1340 without being accompanied with the credential device 130ⱼ₂ the patient would not be permitted to gain access, as in this example the identifier of the credential device 130ⱼ₁ is restricted from gaining access as indicated in a database 1370 stored in computer readable memory of the reader 110ⱼ and/or controller 120 (not illustrated) which controls multiple readers in the building. FIG. 13C, illustrates the table 1380 stored in the database 1370 which lists the access rights for a plurality of credential devices 130ⱼ. For instance, if the credential device 130ⱼ₁ is assigned the identifier “2222” and the patient with the credential device 130ⱼ₁ attempts to exit the door 1330 without a second credential device present, then access could be denied as the patient has no access rights (as indicated by the 0) and cannot access any access points in the building (as indicated by the 0). However, if the patient was accompanied by a doctor having the credential device 130ⱼ₂, which has the identifier “1111”, then patient could accompany the doctor anywhere in the building as the doctor as access rights to accompany any of the identifiers (as indicated by the “*”) and can access any access points (as indicated by the “*”). By way of another example, if the patient was accompanied by a visitor having the credential device 130ⱼ₂, which now has the identifier “3333”, then patient could accompany the patient with the credential device 130ⱼ₁, as the visitors access rights allows for the credential device with the identifier “2222” to accompany it through the access point 1330. However, the access rights of the visitor credential device 130ⱼ₂, is limited to be used with a patient that has a credential device with an identifier “1111”, as such, if the visitor attempted to exit with a different patient having a identifier “4444” then the access point 1330 would be locked. Similarly, if the visitor credential device 130ⱼ₂, is limited to the access point 1330, as such, if the visitor attempted to exit a different access point then the different access point would be locked.

FIG. 13D illustrates an example method 1300ₐ which may be executed by the access control system 100ⱼ. At step 1301ₐ the reader 110ⱼ determines if two credential devices are in the field for range 1340. If not, then it is determined if a signal credential device is present at step 1302ₐ. If more than two credential devices are present, then at step 1303ₐ access is denied. However, if a single credential devices is present then at step 1304ₐ it is determined if the credential devices has access rights for this access point, which may include looking up the credential devices identifier in an access rights table. If so, then access granted at step 1305ₐ, if not, then access is denied at step 1306ₐ. However, if at step 1301ₐ two credential devices are detected, then at step 1307ₐ it is determined whether one of the credential devices has access rights for this access point. If not, then at step 1308ₐ access is denied. However, if so, then the method 1300ₐ proceeds to step 1309ₐ. At step 1309ₐ it is determined whether one of the credential devices has access rights for use with the other credential device. If not, then access is denied at step 1310ₐ, and if so, then at step 1311ₐ access is granted.

In the method 1300ₐ discussed above, the access point cannot be accessed if more than two credential devices are present in the field of range of the reader. However, in some circumstances it may be desirable for more than two credential devices to be in the field of range of the reader.

FIG. 13E illustrates an example method 1300_{b} which may be executed by the access control system 100ⱼ, which does not restrict access to the access point when more than two credential devices are in the field of range of the reader 110ⱼ. At step 1301_{b} the reader 110ⱼ determines if more than one credential device is in the field for range 1340. If not, then it is determined if the credential device has access rights for this access point at step 1302_{b}, which may include looking up the credential device's identifier in an access rights table. If so, then access is granted at step 1304_{b}, if not, then access is denied at step 1303_{b}. However, if at step 1301_{b} two or more credential devices are detected, then at step 1305_{b} it is determined whether one of the credential devices has access rights for this access point. If not, then at step 1306_{b} access is denied. However, if so, then the method 1300_{b} proceeds to step 1307_{b}. At step 1307_{b} it is determined whether one of the credential devices has access rights for use with all of the other credential devices. If not, then access is denied at step 1308_{b}, and if so, then at step 1309_{b} access is granted.

It is appreciated that the access control system 100ⱼ may allow for caregivers or visitors to be able to travel with the patient to other areas, depending on the access rights and that access control system 100ⱼ may be able to record the fact that a caregiver or visitor was present with a patient, and further readers throughout a facility may be able report the locations in real time of the patient and the caregiver or visitor.

Although the access control system 100ⱼ was discussed in terms of a wandering patient, the access control system 100ⱼ may equally apply in other application where a similar functionality is required.

### Schedule Monitoring

The access control system 100 may be implemented in some embodiments to monitor and track the location of users as a function of time. In these embodiments, if a user does not check in by entering (with his/her credential device 130) the field of range of a reader 110 by a specific time, such event (or lack thereof) can be recorded and an alert may also be transmitted to a monitoring center (e.g., the computing entity 140) or personnel.

### Example of a Guard Tour:

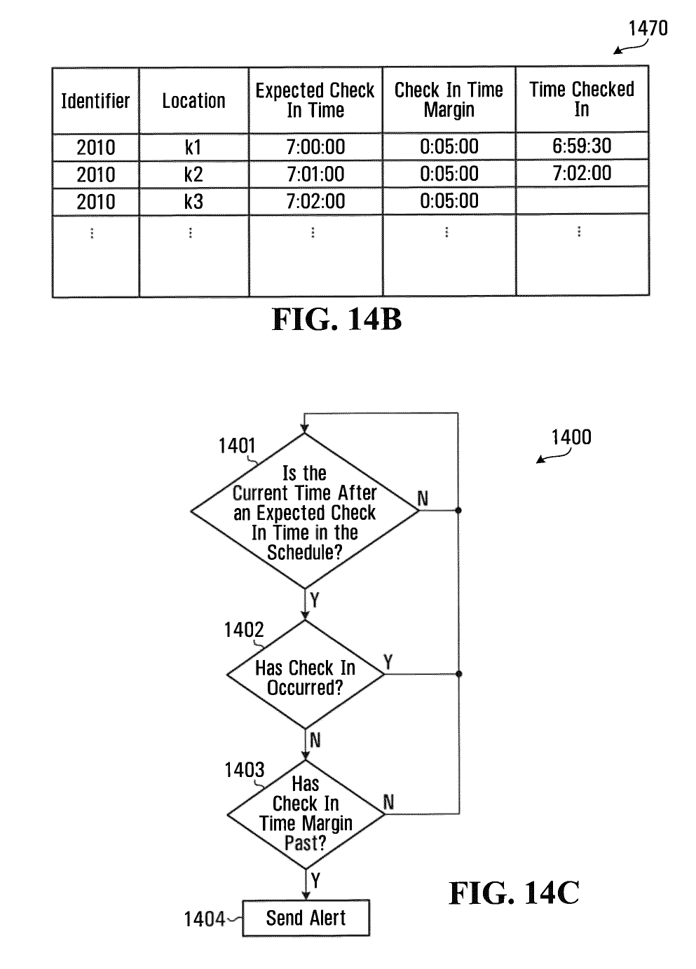

FIG. 14A illustrates an example of an access control system 100ₖ which includes a plurality of readers 110ₖ₁ 110ₖ₂ 110ₖ₃ to be used with a credential device 130ₖ. The access control system 100ₖ is a specific non-limiting implementation of the access control system 100. Similarly, the readers 110ₖ₁ 110ₖ₂ 110ₖ₃ and the credential device 130ₖ are a specific non-limiting implementation of the reader 110 and the credential device 130, respectively. In this example the plurality of readers is illustrated as three readers 110ₖ₁ 110ₖ₂ 110ₖ₃, which are connected to a controller 120ₖ which is connected to a computing entity 140ₖ. The controller 120ₖ is also connected to a database 1460, which may be stored in the memory 550 controller 120ₖ. Also, as illustrated, each readers 110ₖ₁ 110ₖ₂ 110ₖ₃ has a field of range 1040ₖ₁ 1040ₖ₂ 1040ₖ₃, respectively.

In this example, a guard 1421 is illustrated with a credential device 130ₖ at three different points in time t=1 (guard 1421₁, credential device 130ₖ₁), t=2 (guard 1421₂, credential device 130ₖ₂), t=3 (guard 1421₃, credential device 130ₖ₃), as the guard 1421 walks down the hallway 1450. As the guard 1421 enters with his/her credential device 130ₖ, each of the of the ranges 1040ₖ₁ 1040ₖ₂ 1040ₖ₃ of the respective readers 110ₖ₁ 110ₖ₂ 110ₖ₃, each reader records the identifier of the credential device 130ₖ and the time of the reading and then transmits this information to the controller 120ₖ.

FIG. 14B, illustrates a table 1470 stored in the database 1460 which lists the check in schedule for the guard 1421 with the credential devices 130ₖ which corresponds to the identifier “2010”. As illustrated, the table 1470 includes a listing of the identifier, the location, the expected check in time, the check time margin, and the actual time that check in occurs.

FIG. 14D illustrates an example method 1400 which may be executed by the access control system 100ₖ. At step 1401 it is determined whether the current time is after an expected check in time in the schedule 1470. If the current time is not after an expected check in time, step 1401 is repeated until the current time is after an expected check in time. If the current time is after an expected check in time, then at step 1402 it is determined whether check in has occurred or not. For instance, if the time is 7:00:01 and the guard 1421 passes the reader 110ₖ₁ at location K1 at 6:59:30, then at step 1402 it would be determined that check in has occurred and step 1401 is repeated. Then, for example, at time 7:01:30 steps 1401 and steps 1402 are repeated and it is determined that the guard 1421 has not past the reader 110ₖ₂ at location K2. Then at step 1403 it is checked to see if the check in time margin has past. In this example, as the current time is 7:01:30 and the check in time is 7:00:00 and the margin time is 0:05:00, the time margin is not past and the method goes back to step 1401. At step 1403 the method 1400 checks to see if the time margin has past. Now for example, if the current time is 7:07:01, and steps 1401 to 1403 are repeated, at step 1403 it would be determined that the guard has not yet checked in and the time margin has past and an alert would be sent at step 1404.

It is appreciated that the guard by using the credential device 130ₖ the tour of the guard may be reported and may be completely automated by the system. As such, failing to walk by hallways, office doors, exterior points, etc. in a scheduled manner as programmed by administrators and stored in the schedule 1470 may cause an automated signal to be generated at a guard station, or remote monitoring station.

Although in the example above, the readers 110ₖ₁ 110ₖ₂ 110ₖ₃ were in communication with the controller 120ₖ, in other embodiments the controller 120ₖ may be removed and the 110ₖ₁ 110ₖ₂ 110ₖ₃ communicate directly with the computing entity 140ₖ. In these other embodiments, the computing entity 140ₖ may then store the database 1460 in its computer readable memory.

Although the example above was given in the context of a guard tour, the embodiments of the example above may apply in other applications.

### Example of Elderly Activity Monitoring at Retirement Home:

The embodiments of the example above regarding the guard tour may similarly apply in the case of elderly activity monitoring at a retirement home. For example, each resident could be issued a credential device 130 which could monitor the activity and movements throughout the retirement home. The access control system 100 could then be able to determine the present location of a resident based upon reader 110 activity. For instance, each resident with mobility could have a schedule which expects the resident to go to a dining area at breakfast, lunch and dinner time. The access control system 100 software could then provide a management system (e.g. the computing entity 140) details as to the attendance (or lack thereof). The recorded events of attendance or absence could then be used for safety reasons and notify appropriate personnel if someone is absent. The recorded events of attendance could also be used for meal billing.

### Example of Elderly Activity Monitoring at Home:

The embodiments of the example above regarding the guard tour may similarly apply in the case of elderly activity monitoring at a personal home or residence. For example, each resident of the home could carry a credential device 130 that is in communication with one or more readers 110. These readers 110 could be installed, for example, either hardwired, or wireless in sleeping areas, kitchen, bath, laundry room, garage, basement, and patio, etc. The access control system 100 could record information such as movements and whereabouts of the resident. Programmed schedules tailored to the resident could monitor movement during the normal course of daily life and any deviations based on programmed criteria could send an alert to a loved one, or monitoring center.

Furthermore, the inclusion of a small button on the case of the credential device 130 may be provided for emergency assistance. As such, when the emergency button is pressed for a short programmed duration of time (e.g., 2 to 3 seconds) the credential device 130 may then send a notification the monitoring center. The motion sensor of the credential device 130 may also be assessed prior to determining if a notification should be sent to detect false alarms. Similarly, if the motion sensor does not detect motion for a specific period of time, then a notification may also be sent.

### Example of Prisoner Home Supervision:

The embodiments of the example above regarding the guard tour may similarly apply in the case of elderly activity monitoring prisoners under home arrest or supervision. For example, an at home prisoner could be monitored for presence via hardwired or wireless readers on the premise of the prisoner. Any deviation from standard programmed schedule parameters could result in an automated report being sent to those having authority, including a monitoring center.

### Alarm System Area Control

The access control system 100 may be integrated in to alarm systems with area controls in some embodiments. In these embodiments, the access control system 100 works with the alarm system and sensors of the alarm system to disable the alarm system for a specific area based on the credential device 130 being read by a reader 110 in the area under control.

### Example of a Guard Tour:

Continuing with the example illustrated in FIG. 14A, embodiments of the invention may include features for alarm system area control. For example, alarm systems of a building may have zones/partitions which comprise of single or multiple sensors (not illustrated) that detect movements, sounds such as glass breaking, opening of doors or windows, etc. Examples of each zone/partition could include, but not be limited to, are: a cafeteria, building entrance/lobby, shop area, administrative offices, gate, garage. As illustrated in FIG. 14A, the readers 110ₖ₁ 110ₖ₂ 110ₖ₃ are installed into the respective zones K1, K2 and K3 under partition control 1430₁ 1430₂.

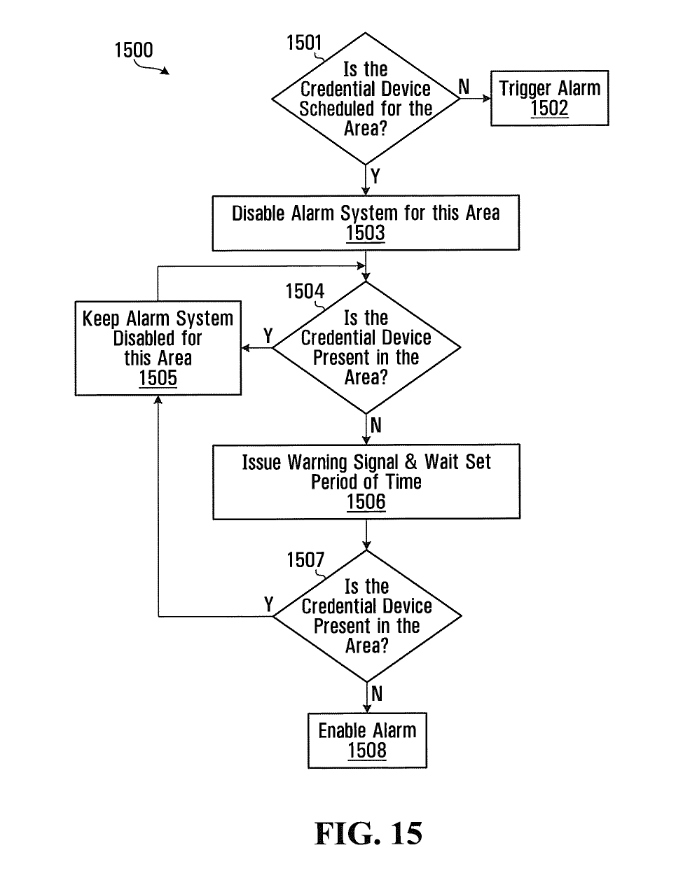

FIG. 15 illustrates an example method 1500 which may be executed by the access control system 100ₖ when an alarm system is under area control. At step 1501, it is first determined if the credential device 130ₖ is scheduled for this area. For example, as the guard 1421₁ with the credential device 130ₖ enters the area K1, a schedule in the database 1460 may be accessed to see if the guard 1421₁ has authority to be in this area and this specific time. If not, then at step 1502, the alarm of the alarm system is triggered. If so, then at step 1503 the alarm system is disabled for this specific area, which is K1 in this example. The disabling of the alarm system may be for a set period or time, or may be as long as the guard is present in field of range 1040ₖ₁ of the reader 130ₖ₁, or as long as the guard is present in the range of sensors of the alarm system. At step 1504 it is determined if the credential device is present in this area, which may include seeing if the guard is present in field of range 1040ₖ₁ of the reader 130ₖ₁ or whether the guard is present in the range of sensors of the alarm system. If it can be determined that the guard is present, then at step 1505 the alarm system is kept disabled for this area. However, if it is determined that the guard is not present, then at step 1506 a warning signal may be issued (which may be an audible tone, flashing light indicator or any other suitable signal) that the alarm system will be re-activated after a set period of time (e.g., 5 minutes, or any other suitable time). Then at step 1507, during this set period of time the access control system 100ₖ would wait to see if the credential device becomes present again in the area, which may include seeing if the guard is present in field of range 1040ₖ₁ of the reader 130ₖ₁ or whether the guard is present in the range of sensors of the alarm system. For example after hearing the audible tone the guard 1421 may walk back into the range or the reader 110ₖ₁ and/or sensor. In this case, the method goes back to step 1505 and the alarm system is kept disabled for this area. However, if the guard is no longer present, then the alarm system in re-enabled for this area at step 1508.

It is appreciated that the example above is not necessarily limited to the case of guard tour, but could apply to any person carrying a credential device and has scheduled authority to enter an area under alarm control.

### Example of Alarm System for Residential, Commercial or Industrial Use:

The embodiments of the example above regarding the guard tour and area control may similarly apply in the case of alarm systems for residential, commercial or industrial use. For example, the keypads or other components of the alarm system could be designed to include the reader 110 or the reader 110 could be connected to the alarm systems control panel for arming and disarming the alarm system in specific areas under control. For instance, the motion detectors or sensors in the building could be individually or in groups be disabled or bypasses when a person carrying a credential device 130 enters in field of range of one or more readers 110 that covers the area under alarm protection.

In the case of a resident at a home, the resident can arm the alarm system when going to sleep and the motion detectors in the unoccupied areas could then be active. If the resident with credential 130 goes for a glass of water in the kitchen the sensors leading to and in that area could be bypassed for a predetermined amount of time. Each time the reader 110 senses motion via an input connection from the motion sensor, it could verify if a valid credential 130 is still in the area, and thus extend the time.

### Interaction Between a Communication System, Such as a Telephone System and Access Control Devices

Present day large telephone systems such as those used in hospitals, offices, educational, manufacturing, and government buildings with multiple employees or departments are typically setup where each employee or department has an extension number. This extension number allows for a person calling a reception or an automated system to be able to reach the particular telephone or other communication device. When a person for example is working in his office, the phone assigned to him typically has an extension number which may allow for a caller to communicate directly with the person. In the event that the person is not at his office, then the caller has the option of leaving a voice message.

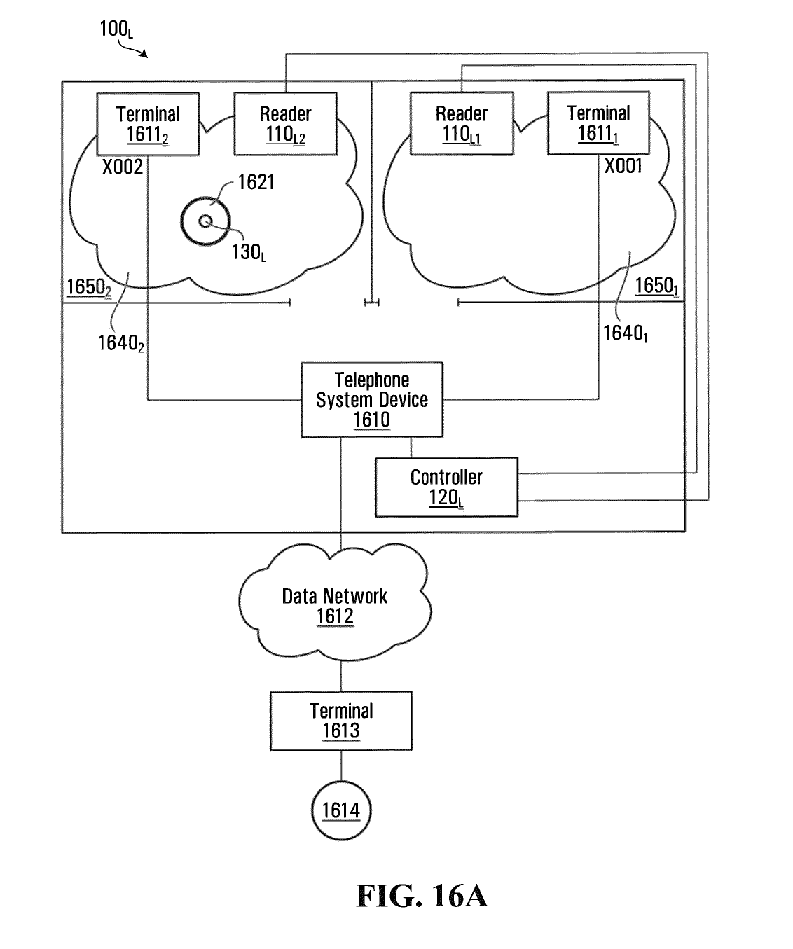

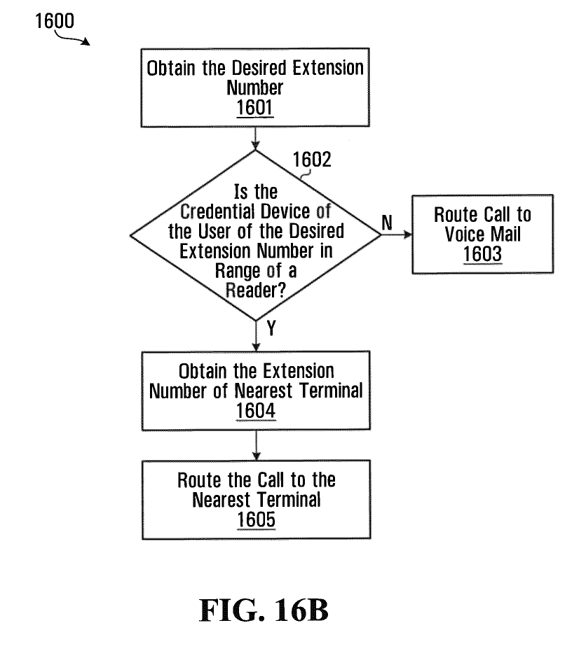

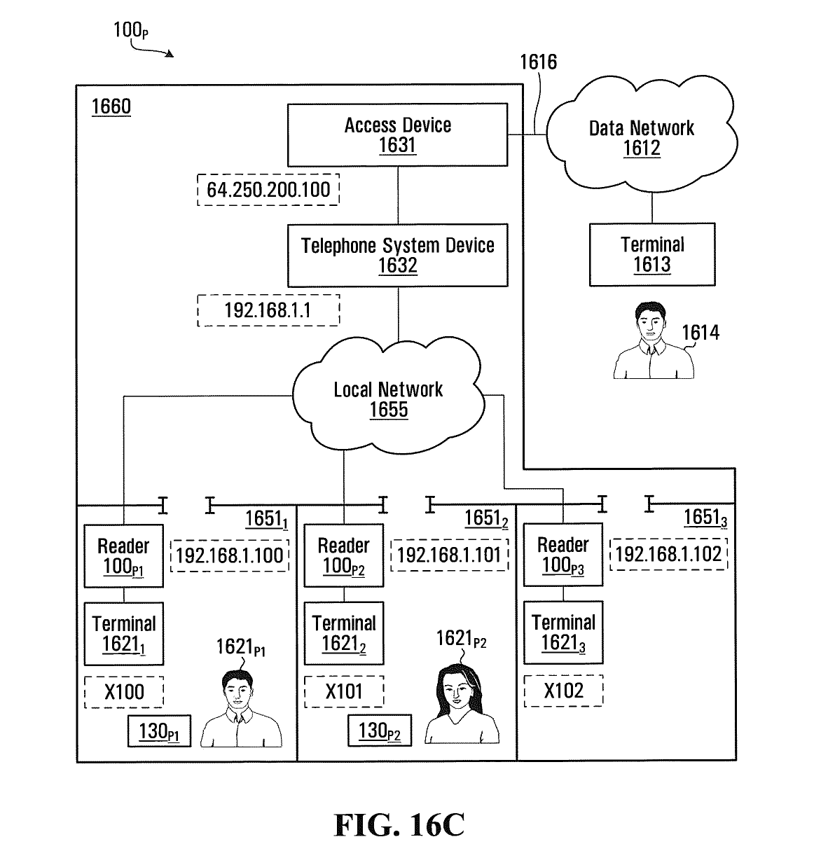

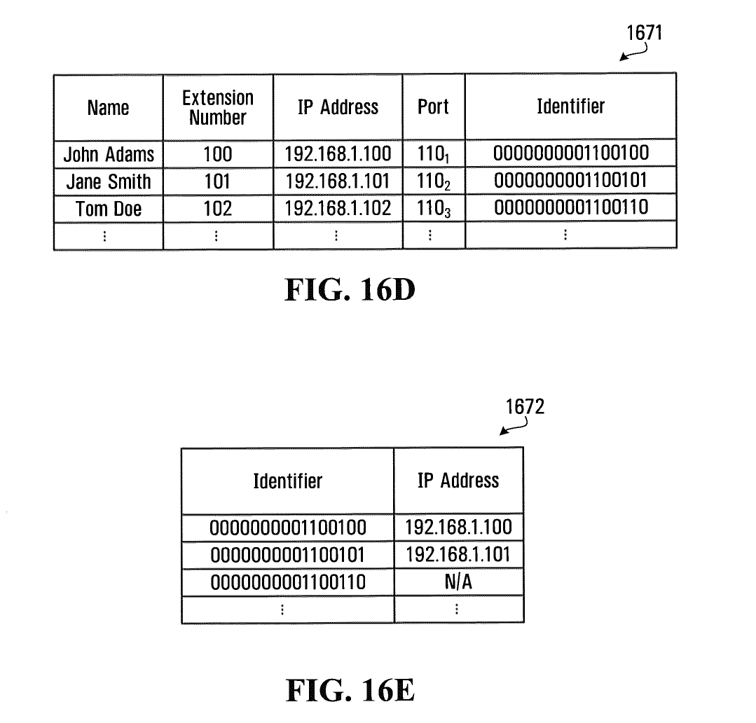

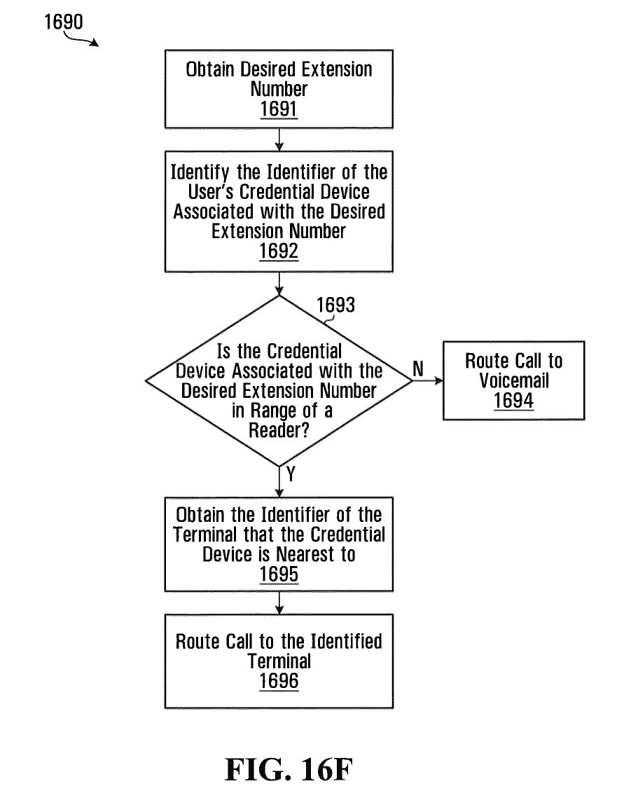

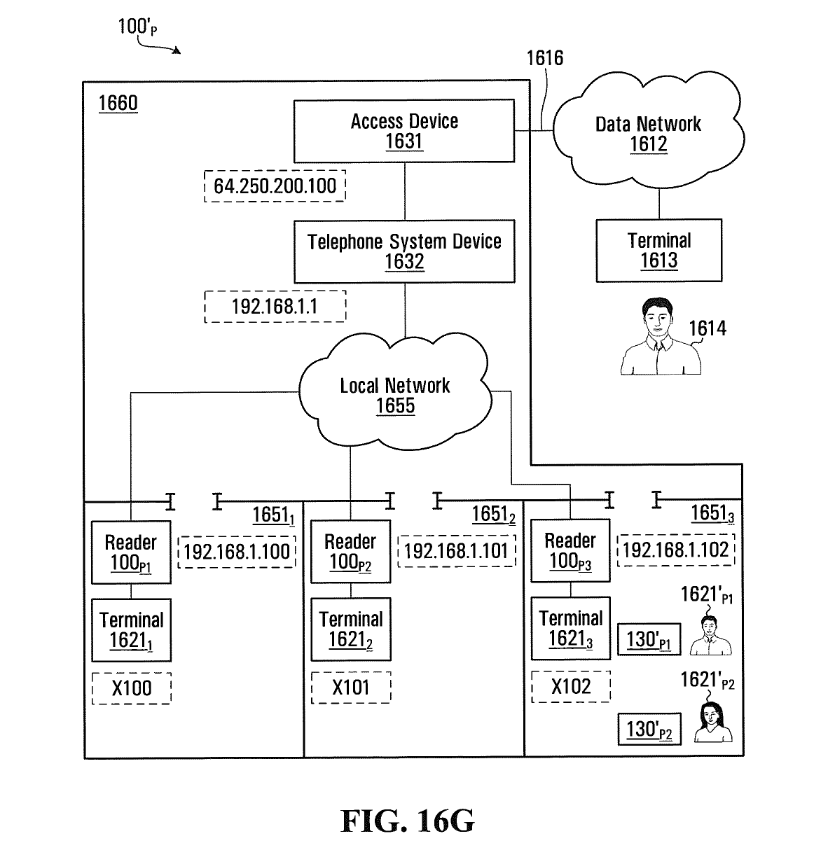

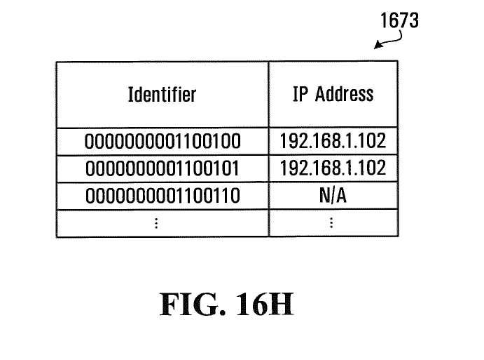

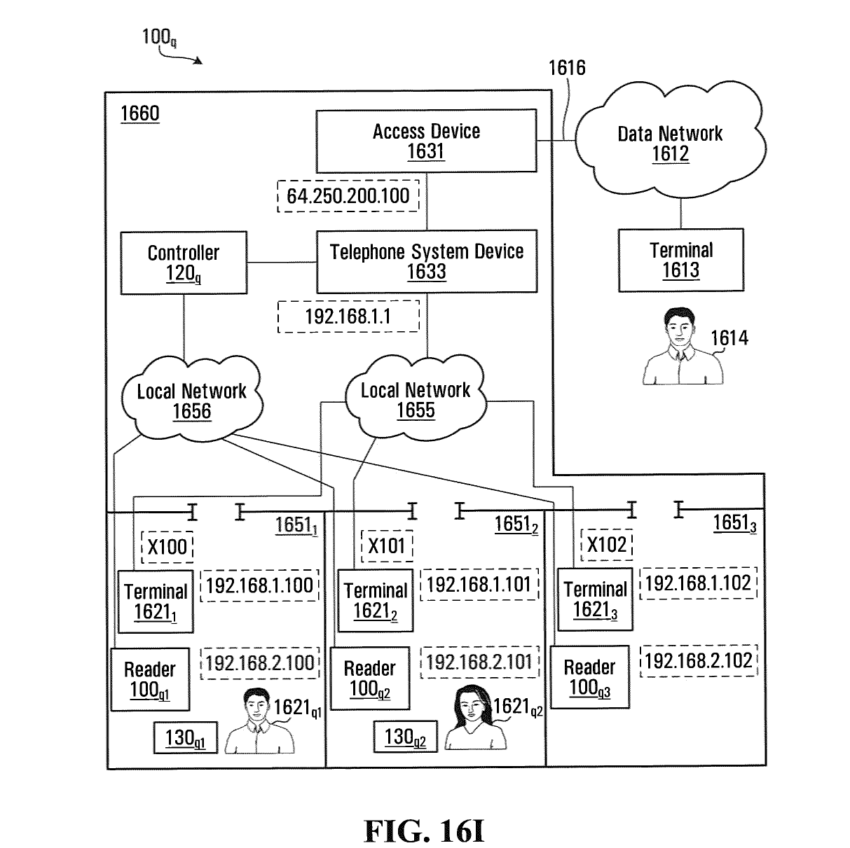

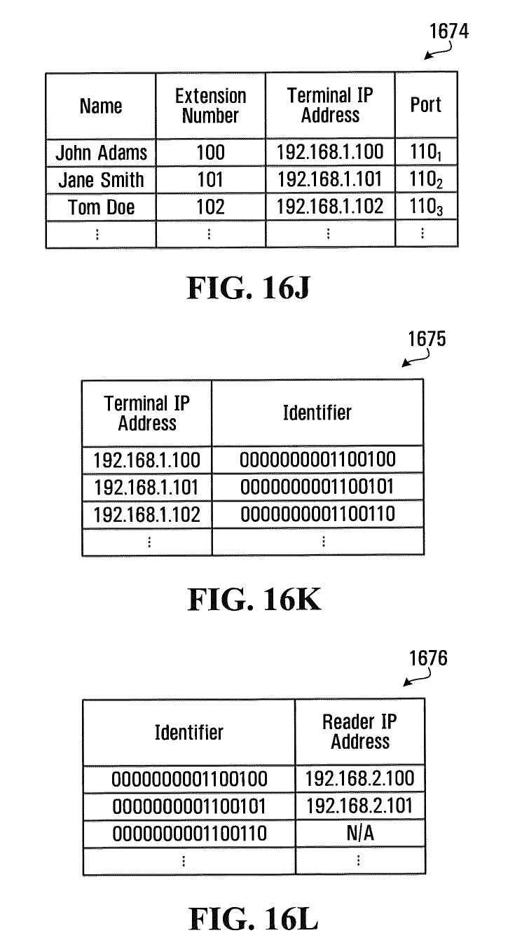

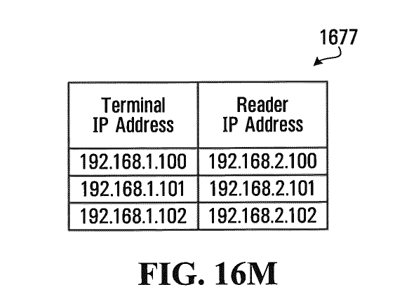

FIG. 16A illustrates an example of an access control system 100_{L} which is interfaced with a telephone system of a building, such as those used in hospitals, offices, educational, manufacturing, government buildings or any other suitable place. The access control system 100_{L} includes a controller 120_{L} which is connected to a plurality of readers. As illustrated the plurality of readers includes a first reader 110_{L1} and a second reader 110_{L1}. A telephony system device 1610 is illustrated as connected to the plurality of terminals, which includes a first terminal 1611₁ with extension number “x001” and a second terminal 1611₂ with extension number “x002”. In this example, the first terminal 1611₁ with extension number “x001 is associated with the user 1621, where the user 1621 has a credential device 130_{L}. The user 162 has an office 1650₁ where the user's terminal 1611₁ is located. The credential device 130_{L} is readable by a plurality of readers. As illustrated, the plurality of readers includes readers 110_{L1} 110_{L2}. As illustrated, the user 1621 is not in the first office 1650₁ and is also not in the field of range 1640₁. Instead, the user 1621 is in the second office 1650₂ and is also in the field of range 1640₂. The access control system 100_{L} is a specific non-limiting implementation of the access control system 100. Similarly, the readers 110_{L1} 110_{L2} and the credential device 130_{L} are a specific non-limiting implementation of the reader 110 and the credential device 130, respectively.

FIG. 16B illustrates an example method 1600 which may be executed by the access control system 100_{L}. At step 1601 of the method 1600, the desired extension number of a user is obtained. For instance, a user 1614 at a telephone terminal 1613 may make a call through a data network 1612 (which may be implemented as a telephone network) which is received at the telephone system device 1610. The telephone system device 1610 may be an automated system that asks the user 1614 for the extension number the user desires to reach or may be a receptionist that answers the call and then forwards the call on to the extension number that the user asked for. In the case that the telephone system device 1610 is an automated system, the desired extension number is communicated to the controller 120_{L}. In the case that the telephone system device 1610 is answered by the receptionist, the receptionist may then enter the desired extension number into the telephone system device 1610 or the controller 120_{L}. In this example, the user 1614 is interested in reaching the user with extension number “x001”. Then the access control system 100_{L} determines if the user 1621 is in range of a reader and the location of the user 1621. At step 1602, it is determined whether the credential device of the user of the desired extension number is in range of a reader. In this example, the user 1621 is in range 1640₂ of the reader 130_{L2}; however, if such was not the case, then the call would be routed to voice mail at step 1603. At step 1604 the extension number of the nearest terminal is obtained, in this case it is terminal 1611₂ with extension number “x002”. If this was the case where the user 1621 was in his/her office 1650₁, which is not the case, the call would have been routed to the terminal 1611₁ in the normal fashion. At step 1605 the call is routed to the nearest terminal, in this case it is it is terminal 1611₂. Then terminal 1611₂ may be alerted via sound and/or screen message that extension “x001” is ringing through. During this ringing cycle, the phone may display the identification of the caller as well as the recipient's name and phone number (or extension number). A further security layer may also be added in which the recipient would have to enter a code via the telephone keypad or other means. The code is compared to a list of stored codes and if a match is found between the code entered and the identity of the recipient, then the call is allowed to go through.

It is appreciated that the access control system 100_{L} may allow for real-time location of all users with a credential device in a building. As such, any incoming calls to a user can automatically be routed to the nearest terminal of the user or displays could be incorporated into reception areas, or security stations, that could indicate the whereabouts of all credentials in real time, allowing calls to be forwarded to the nearest terminal by the receptionist or security officer.

In the example illustrated in FIG. 16A, the user 1614 is illustrated external to the telephone network of the building; however, the user 1614 could be located within the building and the access control system 100_{L} could function in a similar manner.

FIG. 16C illustrates an example of an access control system 100_{P} which is interfaced with a telephone system of a premise or a building 1660, such as those used in hospitals, offices, educational, manufacturing, government buildings or any other suitable place. The access control system 100ₚ is a specific non-limiting implementation of the access control system 100. For the purpose of this example to be presented herein below, it is to be assumed that building 1660 is a subscriber of a telephone service, which is provided via an external data network 1612 over an access connection 1616. The external data network 1612 is any suitable data network that is suitable to satisfy the communication needs of the user(s) at the building. These communication needs may include exchange of data, telephony and the like. In a specific non-limiting embodiment, the external data network 1612 is the Internet or can comprise the Internet. However, in alternative embodiments, the external data network 1612 may comprise another type of public data network, a private data network, portion of the Public Switched Telephone Network (PSTN), a wireless data network and the like.

In an example non-limiting embodiment of the present invention, the access connection 1616 can be a copper twisted pair, over which higher-layer protocols allow for the exchange of packets (ex. an xDSL-based access link). In an alternative non-limiting embodiment, the access connection 1616 may comprise an Ethernet link, a fiber optic link (e.g., Fiber-to-the-Premise, Fiber-to-the-Curb, etc.), a wireless link (e.g., EV-DO, WiMax, WiFi, CDMA, TDMA, GSM, UMTS, and the like), coaxial cable link, etc., or a combination thereof. Generally speaking, the access connection 1616 may comprise any type of wireless, wired or optical connection that allows exchange of data between the building 1660 and the external data network 1612.

It should be noted that even though its depiction in FIG. 16C is greatly simplified, the external telephone network may comprise a number of network elements for facilitating exchange of data. Persons skilled in the art will readily appreciate various configurations possible for the network elements that make up the external data network 1612 and, as such, these network elements need not be described here in great detail.

The building 1660 may comprise an access device 1631 that facilitates exchange of data with the external data network 1612 via the access connection 1616. In some embodiments of the present invention, the access device 1612 may comprise a modem. Examples of modems that can be used include, but are not limited to, a cable modem, an xDSL modem and the like. In alternative embodiments of the present invention, which are particularly applicable where the access connection 1616 comprises Fiber-to-the-premise, the access device 1631 may comprise an Optical Network Terminal (ONT). Naturally, the type of the access device 1631 will depend on the type of the access connection 1616 employed.

The premise 1660 may comprise a number of communication terminals 1621₁ 1621₂ 1621₃ (e.g., communication clients or communication devices) coupled to the access device 1631 via a local network 1655 and a telephone system device 1632. Only three terminals 1621₁ 1621₂ 1621₃ are depicted, however, the invention is not limited to such a configuration. Generally speaking, the terminals may be implemented in hardware, software, firmware or a combination thereof. For the purposes of various examples to be presented herein below, the following non-limiting assumptions will be made:
the terminal 1621₁ comprises a VoIP or SIP phone located in a room 1651₁ associated with a user 1624ₚ₁, which goes by the name John Adams;
the terminal 1621₂ comprises a VoIP phone located in a room 1651₂ associated with a user 1624ₚ₂, which goes by the name Jane Smith; and
the terminal 1621₃ comprises a VoIP or SIP phone located in a room 1651₃ associated with a user not illustrated in FIG. 16C but goes by the name Tom Doe.

It should be understood that the premise or building 1660 may comprise a number of additional communication terminals that may include, but are not limited to, other VoIP phones, a wireless VoIP phone or SIP phone (such as, for example, a J2ME wireless phone), a Plain Old Telephone System (POTS) phone equipped with an Analog Terminal Adapter (ATA), other computing apparatuses executing soft clients, and the like. The number of communication terminals installed within the premise or building 1660 should not be limited. Put another way, the premise or building 1660 may comprise two or more communication terminals similar to the communication terminals 1621₁ 1621₂ 1621₃.

In the specific non-limiting embodiment depicted in FIG. 16C, the communication terminals 1621₁ 1621₂ 1621₃ are coupled to the access device 106 via respective readers 100ₚ₁ 100ₚ₂ 100ₚ₃. The readers 100ₚ₁ 100ₚ₂ 100ₚ₃ may include physical hardware such as: a data processor, communication module(s) (e.g., Ethernet, Wi-Fi or any other suitable module), computer readable memory for storage of information in one or more databases and one or more data buses for connecting the various pieces of hardware. For example, readers 100ₚ₁ 100ₚ₂ 100ₚ₃ may have two Ethernet ports, one to connect to the VoIP phone and the other to connect to the telephone system device 1632 via the local network 1655. In other cases, the readers 100ₚ₁ 100ₚ₂ 100ₚ₃ may have one or more Wi-Fi modules to connect to the VoIP phone and to connect to the telephone system device 1632 via the local network 1655. In Further cases, the readers 100ₚ₁ 100ₚ₂ 100ₚ₃ may have a combination of one or more Wi-Fi modules and one or more Ethernet ports to connect to the VoIP phone and to connect to the telephone system device 1632 via the local network 1655. In some embodiments, the readers 100ₚ₁ 100ₚ₂ 100ₚ₃ and the respective communication terminals 1621₁ 1621₂ 1621₃ may be implemented into a single device.

That is, a reader and a communication terminal may be implemented in a single hardware device or may be separate hardware devices, as illustrated in FIG. 16C.

In some non-limiting embodiments, the local data network 1655 may comprise an Ethernet-based network. In another non-limiting embodiment of the present invention, the local data network 1655 may comprise a wireless network (ex. a Wi-Fi based network, a Wi-Max based network, BlueTooth® based network and the like). It should be noted that any other type of local data network 1655 or a combination of the example networks can be used. As illustrated, a telephone system device 1632 is connected to the access device 1631 and mediates communications between the communication terminals between the communication terminals 1621₁ 1621₂ 1621₃ and the access device 1631. The telephone system device 1632 may comprise a wireless router, a wired router or a combined wireless/wired router or routing circuitry. The telephone system device 1632 may include physical hardware such as: a data processor, communication module(s) (e.g., Ethernet or Wi-Fi), computer readable memory for storage of information in one or more databases and one or more data buses for connecting the various pieces of hardware.

In some non-limiting embodiments of the present invention, the functionality of the access device 1631 and the telephone system device 132 may be embodied in a single device. In other non-limiting embodiments of the present invention, the functionality of the access device 1631 and/or the telephone system device 1632 may be integrated into one of the communication terminals 1621₁ 1621₂ 1621₃.

It should be understood that the infrastructure of FIG. 16C may comprise a number of additional communication terminals outside of the premise or building 1660, which are coupled to the external data network 1612. As a non-limiting example only, the infrastructure of FIG. 1 may comprise a communication terminal 1613 associated with another user (such as, for example, a user 1614). The communication terminal 1613 can be coupled to the data network 1612 via an access connection 1617. The communication terminal 1613 may comprise one or more of a VoIP phone, a POTS phone equipped with an Analog Terminal Adapter (ATA), a computing apparatus executing a soft client, and the like. The access connection 1617 may be substantially similar to the access connection 103. However, it should be understood that the access connection 1616 and the access connection 1617 need not be of the same type in every embodiment of the present invention.

For the purposes of facilitating exchange of data via the data network 1612, the telephone system device 1632 may be assigned a network address compatible with an addressing scheme of the data network 1612. In some embodiments of the present inventions, the network address can comprise an IPv4 address. In an alternative embodiment of the present invention, the network address can comprise an IPv6 address. In an alternative non-limiting embodiment of the present invention, the network address can comprise any other suitable type of a unique identifier, such as, for example, a media access control (MAC) address, a proprietary identifier and the like.

How the telephone system device 1632 is assigned a network address is not particularly limited. For example, in some non-limiting embodiments of the present invention, the telephone system device 1632 may be assigned a static network address. This static network address may be assigned to the telephone system device 1632 before the telephone system device 1632 prior to installation in the building, during an initial registration process or at another suitable time. In another non-limiting embodiment of the present invention, the telephone system device 1632 may be assigned a dynamic network address. For example, in a non-limiting scenario, a Dynamic Host Configuration Protocol (DHCP) server (not depicted) may be used to assign the dynamic network address (such as, for example, a dynamic IP address) to the telephone system device 1632. In alternative non-limiting embodiments of the present invention, the telephone system device 1632 can obtain its network address by establishing a PPPoE session with a provisioning server (not depicted). Other alternative implementations are, of course, possible. In an alternative non-limiting embodiment of the present invention, the access device 1631 may be assigned a network address.

Each of the communication terminals 1621₁ 1621₂ 1621₃ and/or the readers 100ₚ₁ 100ₚ₂ 100ₚ₃ can also be assigned a respective network address for the purposes of receiving and transmitting data via the telephone system device 1632, the access device 1631 and the data network 1612. For example, private network addresses may be used. In some embodiments of the present invention, each of the readers 100ₚ₁ 100ₚ₂ 100ₚ₃ and each of the communication terminals 1621₁ 1621₂ 1621₃ can be assigned what is called a “non-routable”, “local” or “private” network address. In these non-limiting embodiments, the private network addresses are used for the purposes of identifying the readers 100ₚ₁ 100ₚ₂ 100ₚ₃ within the local data network 1655 (which also may allow for the identifying the communication terminals 1621₁ 1621₂ 1621₃), while communication outside of the local network 1655 is implemented by using the aforementioned public network address assigned to the telephone system device 1632 (or, in some cases, the access device 1631). In some non-limiting embodiments, the telephone system device 1632 may be responsible for assigning private network addresses to the readers 100ₚ₁ 100ₚ₂ 100ₚ₃. In some non-limiting embodiments, the readers 100ₚ₁ 100ₚ₂ 100ₚ₃ may be responsible for assigning respective private network addresses to the communication terminals 1621₁ 1621₂ 1621₃. While in other non-limiting embodiments, the telephone system device 1632 may be responsible for assigning private network addresses to both the readers 100ₚ₁ 100ₚ₂ 100ₚ₃ and the communication terminals 1621₁ 1621₂ 1621₃. In further embodiments, the private network addresses can be assigned to the readers 100ₚ₁ 100ₚ₂ 100ₚ₃ and/or the communication terminals 1621₁ 1621₂ 1621₃ by a dedicated address server (not depicted) coupled to the local data network 1655 or to the external data network 1612. It is appreciated that the private network addresses may be used for the purposes of identifying the communication terminals 1621₁ 1621₂ 1621₃, the readers 100ₚ₁ 100ₚ₂ 100ₚ₃, or the communication terminals 1621₁ 1621₂ 1621₃ via the respective readers 100ₚ₁ 100ₚ₂ 100ₚ₃, within the local data network 1655. In other cases, public network addresses may be used. For example, the communication terminals 1621₁ 1621₂ 1621₃ and/or readers 100ₚ₁ 100ₚ₂ 100ₚ₃ can be assigned network addresses that are routable or, in other words, are visible to the data network 1612 and other devices connected thereto. The routable network addresses are sometimes also referred to as “global” or “public” network addresses. For example, if the data network 1612 implements an IPv6 address scheme, it is envisioned that each of the communication terminals 1621₁ 1621₂ 1621₃ and/or readers 100ₚ₁ 100ₚ₂ 100ₚ₃ may be assigned a unique public IP address.

In the specific non-limiting example depicted in FIG. 16C, each of the communication terminals 1621₁ 1621₂ 1621₃ can be assigned a private network address by the telephone system device 1632. For the sole purpose of simplifying the description to be presented herein below, it is assumed that both the private and the public network addresses are Internet Protocol (IP) addresses assigned according to the IPv4 protocol. However, it is expected that one of ordinary skilled in the art will easily adapt the teachings to be presented herein below to other addressing schemes.

Accordingly, the telephone system device 1632 may be assigned two IP addresses: a first IP address for the purposes of communicating with devices on the data network 1612 (i.e. a so-called “network facing interface” IP address) and a second IP address for the purposes of communicating with devices on the local data network 1655 (i.e. a so-called “premise facing interface” IP address). For example, the network facing interface IP address may be a public IP address “64.250.200.100”. The assignment of this public IP address can be done by the aforementioned DHCP server (not depicted) coupled to the data network 1612. The premise facing interface IP address may be a private IP address “192.168.1.1”. In an alternative non-limiting embodiment of the present invention, the network facing interface IP address may comprise a static public IP address.

The telephone system device 1632 can be responsible for assigning private IP addresses to the readers 100ₚ₁ 100ₚ₂ 100ₚ₃. For example, the readers 100ₚ₁ may be assigned a private IP address “192.168.1.100”, the readers 100ₚ₁ may be assigned a private IP address “192.168.1.101” and the readers 100ₚ₁ may be assigned a private IP address “192.168.1.102”. In this specific non-limiting example, each of the readers 100ₚ₁ 100ₚ₂ 100ₚ₃ is then responsible for assigning a private IP address to each of the respective communication terminals 1621₁ 1621₂ 1621₃. In these cases, the private IP address of each of the communication terminals 1621₁ 1621₂ 1621₃ would then be local to the respective readers 100ₚ₁ 100ₚ₂ 100ₚ₃. However, in other cases, telephone system device 1632 may be responsible for assigning private IP addresses to the communication terminals 1621₁ 1621₂ 1621₃.

As one skilled in the art will appreciate, in the specific embodiment depicted in FIG. 16C, the private IP addresses assigned to the readers 100ₚ₁ 100ₚ₂ 100ₚ₃, as well as the private IP address assigned to the premise facing interface of the telephone system device 1632, are only routable within the local data network 1655, while the public IP address assigned to the network facing interface of the telephone system device 1632 is routable within the data network 1612. Accordingly, in order to facilitate exchange of data between the readers 100ₚ₁ 100ₚ₂ 100ₚ₃, the communication terminals 1621₁ 1621₂ 1621₃ and the data network 1612, the telephone system device 1632 and/or readers 100ₚ₁ 100ₚ₂ 100ₚ₃ can be operable to implement a Network Address Translation (NAT) operation or, in other words, to translate the private IP addresses assigned to the communication terminals 1621₁ 1621₂ 1621₃ for the purposes of routing data packets to/from the communication terminals 1621₁ 1621₂ 1621₃ using the public IP address assigned to the telephone system device 1632.

NAT operation is known to those of skill in the art and, as such, no detailed description of the process will be presented here. However, for the benefit of the reader a brief overview will be presented. The telephone system device 1632 can be operable to receive a packet from one of the communication terminals 1621₁ 1621₂ 1621₃ (i.e. an outgoing packet) via the respective readers 100ₚ₁ 100ₚ₂ 100ₚ₃. For example, if a call or data communication session is taking place between the communication terminal 1621₁ via the reader 100ₚ₁, the reader 100ₚ₁ may perform a NAT operation whereby a source address of the received outgoing packet (which in this non-limiting example can be the private IP address of the communication terminal 1611₁ that originated the outgoing packet) is substituted with the IP address associated with the reader 100ₚ₁ and a port number that uniquely identifies the communication terminal 1621₁ which originated the outgoing packet. In other cases, the readers 100ₚ₁ 100ₚ₂ 100ₚ₃ may assign “local” or “private” addresses without the use of a NAT operation, as in these cases only a single communication terminal is connected to each respective reader. Regardless of how the reader 100ₚ₁ 100ₚ₂ 100ₚ₃ address the respective communication terminals 1621₁ 1621₂ 1621₃, it is appreciated that in this specific embodiment it may be possible for the telephone system device 1632 to communicate with one of the communication terminals 1621₁ 1621₂ 1621₃ with only knowing the IP address and port of the respective reader 100ₚ₁ 100ₚ₂ 100ₚ₃ (and in some cases with only knowing the respective reader's 100ₚ₁ 100ₚ₂ 100ₚ₃ IP address). For example, in a communication session between the communication terminal 1621₁ via the reader 100ₚ₁ the telephone system device 1632 in this case may communicate with only knowing the IP address and port of the reader 100ₚ₁ (and in some cases with only knowing the IP address of the reader 100ₚ₁). In some embodiments, the telephone system device 1632 may perform a NAT operation whereby a source address of the received outgoing packet (which in this non-limiting example can be the private IP address of one of readers 100ₚ₁ 100ₚ₂ 100ₚ₃ that originated the outgoing packet which may be via the respective communication terminals 1621₁ 1621₂ 1621₃) is substituted with the network facing interface IP address associated with the telephone system device 1632 and a port number that uniquely identifies one of the readers 100ₚ₁ 100ₚ₂ 100ₚ₃ which originated the outgoing packet. The telephone system device 1631 can further be operable to compile an internal mapping table 1671 (as illustrated in FIG. 16D). The internal mapping table 1671 correlates at least (i) an original source address (i.e. the private IP address of one of the readers 100ₚ₁ 100ₚ₂ 100ₚ₃ that has originated the outgoing packet) to (ii) a port number assigned to the respective one of the readers 100ₚ₁ 100ₚ₂ 100ₚ₃. In the specific non-limiting example of FIG. 16C, the internal mapping table 1671 correlates the private IP address of the reader 100ₚ₁ (i.e. 192.168.1.100) to a port 110₁, the private IP address of the reader 100ₚ₂ (i.e. 192.168.1.101) to a port 110₂, and the private IP address of the reader 100ₚ₂ (i.e. 192.168.1.102) to a port 110₃. Data maintained within the internal mapping table 1671 can allow the telephone system device 1632 to receive a packet destined for one of the communication terminals 1621₁ 1621₂ 1621₃ (i.e. an incoming packet addressed using the network facing interface IP address associated with the telephone system device 1632 and a port number associated with the one of the readers 100ₚ₁ 100ₚ₂ 100ₚ₃ to which the incoming packet is destined for) and using the internal mapping table 1671, the home gateway 110a can route the incoming packet to the intended destination (i.e. one of the communication clients 108a, 108b, 108c via the one of the readers 100ₚ₁ 100ₚ₂ 100ₚ₃). It is appreciated that although in this example the IP addresses stored in the internal mapping table 1671 corresponds to the IP addresses of the readers 100ₚ₁ 100ₚ₂ 100ₚ₃, it effectively corresponds to the respective IP addresses of the communication terminals 1621₁ 1621₂ 1621₃, as the communication terminals 1621₁ 1621₂ 1621₃ are connected to the respective readers 100ₚ₁ 100ₚ₂ 100ₚ₃ and the readers are able to address the communication terminals. The telephone system device 1632 and the readers 100ₚ₁ 100ₚ₂ 100ₚ₃, thereby, allow for two-way exchange of packets between one or more of the communication terminals 1621₁ 1621₂ 1621₃ with any other device on the external data network 1621 (such as, for example, the terminal 1614) or any other device in the local data network 1655. It should be noted that in an alternative non-limiting embodiment of the present invention, the internal mapping table 1671 can be maintained by another device accessible to telephone system device 1632. In other cases, the internal mapping table 1671 may store IP addresses of the communication terminals 1621₁ 1621₂ 1621₃.

FIG. 16D illustrates an internal mapping table 1671 which may be stored in computer readable memory in a database, which may be located in the telephone system device 1632. The internal mapping table 1671 in addition to being used to correlate at least an original source address to a port number of one of the readers 100ₚ₁ 100ₚ₂ 100ₚ₃ to facilitate communication with one of the communication terminals 1621₁ 1621₂ 1621₃, the internal mapping table 1671 also associates user names with extension numbers, with associated IP addresses, with associated port numbers, and with associated user identifiers of credential devices. In other words, the internal mapping table 1671 is used by the telephone system device 1632 to facilitate or route two-way communications internally and externally to the local data network 1655. Although in this example, the internal mapping table 1671 is illustrated as a single table, the person skilled in the art would understand that this table may be implemented in many forms including the use of multiple tables.

As illustrated in FIG. 16C a user 1624ₚ₁ which goes by the name John Adams is located within the room or office 1651₁, for the purpose of this example this room 1651₁ is John Adams's primary location (i.e., this is the user's 1624ₚ₁ office within the building). In the office 1651₁ associated with the user 1624ₚ₁ there is a terminal 1621₁ in the form a VoIP phone which may be identified by the extension number “x100”. The terminal 1621₁ is connected to the reader 100ₚ₁ which has the IP address 192.168.1.100 associated with it. For the purpose of this example, the terminal 1621₁ is the primary terminal of user 1624ₚ₁. The user 1624ₚ₁ is associated with a credential device 130ₚ₁ as the user 1624ₚ₁ may carry the credential device 130ₚ₁ with him to gain access to various parts of the building 1660. The credential device 130ₚ₁ in this example has the identifier (e.g., card number or user id) of “0000000001100100”.

Additionally, as illustrated in FIG. 16C a user 1624ₚ₂ which goes by the name Jane Smith is located within the room or office 1651₂, for the purpose of this example this room 1651₂ is Jane Smith's primary location (i.e., this is the user's 1624ₚ₂ office within the building). In the office 1651₂ associated with the user 1624ₚ₂ there is a terminal 1621₂ in the form a VoIP phone which may be identified by the extension number “x101”. The terminal 1621₂ is connected to the reader 100ₚ₂ which has the IP address 192.168.1.101 associated with it. For the purpose of this example, the terminal 1621₂ is the primary terminal of user 1624ₚ₂. The user 1624ₚ₂ is associated with a credential device 130ₚ₂ as the user 1624ₚ₂ may carry the credential device 130ₚ₂ with her to gain access to various parts of the building 1660. The credential device 130ₚ₂ in this example has the identifier (e.g., card number or user id) of “0000000001100101”.

Also, as illustrated in FIG. 16C, the office 1651₃ there is a terminal 1621₂ in the form a VoIP phone which may be identified by the extension number “x102”. The terminal 1621₃ is connected to the reader 100ₚ₃ which has the IP address 192.168.1.103 associated with it. Although not illustrated, the office 1651₃ is associated with the user with the name Tom Doe and Tom Doe has a credential device with the identifier (e.g., card number or user id) of “0000000001100110”. For the purpose of this example, the terminal 1621₃ is the primary terminal of Tom Doe.

When the access control system 100ₚ is configured the internal mapping table 1671 is setup which may be done via a registration process or at the time of the installation of the access control system 100ₚ. As illustrated in FIG. 16D, for each of the users John Adams, Jane Smith and Tom Doe the internal mapping table 1671 stores respective extension numbers, IP addresses of the readers, port number, and identifier (e.g., card number or user id) of the credential devices. It is appreciated that such a configuration may allow for the telephone system device to associate the IP addresses with the credential device identifiers to determine the primary terminal for each user. For example, the table 1671 may be used to determine that for John Adams (user 1621ₚ₁) with the identifier “0000000001100100” that the user's primary terminal is connected to the reader 100ₚ₁ with the IP address 192.168.1.100. Similarly, the table 1671 may be used to determine that for Jane Smith (user 1621ₚ₂) with the identifier “0000000001100101” that the user's primary terminal is connected to the reader 100ₚ₂ with the IP address 192.168.1.101. Furthermore, the table 1671 may be used to determine that for Tom Doe with the identifier “0000000001100110” that the user's primary terminal is connected to the reader 100ₚ₃ with the IP address 192.168.1.101.

In this example, the readers 110ₚ₁ 110ₚ₂ 110ₚ₃ and the credential devices 130ₚ₁ 130ₚ₂ are a specific non-limiting implementation of the reader 110 and the credential device 130, respectively. Similarly, the telephone system device 1632 may be in whole or in part a specific non-limiting implementation of the controller 120. Although the telephone system device 1632 is illustrated as a single device, it may actual be implemented by two separate devices, one that controls the telephony functionality and another that controllers the access control functionality. In the case that the telephone system device 1632 is implemented by two separate devices, one that controls the telephony functionality and another that controllers the access control functionality, the device that controllers the access control functionality may connect to the readers via a second network (e.g., Wi-Fi or Ethernet).

FIG. 16E illustrates an internal mapping table 1672 which may be used to keep track of the location of each of the credential devices 130ₚ₁ 130ₚ₂ by storing in a list the identifier of each credential device in association with an IP address of the nearest reader. As illustrated, the credential device 130ₚ₁ with the identifier “0000000001100100” is located in the office 1651₁ and is closest to the reader 100ₚ₁. Similarly, the credential device 130ₚ₂ with the identifier “0000000001100101” is located in the office 1651₂ and as such is closest to the reader 100ₚ₂. As such, the internal mapping table 1672 stores in real time the location of the credential device 130ₚ₁ with the identifier “0000000001100100” as being nearest to the reader 100ₚ₁ with the IP address 192.168.1.100 and the location of the credential device 130ₚ₂ with the identifier “0000000001100101” as being nearest to the reader with the IP address 192.168.1.101. As illustrated, the credential device with the identifier “0000000001100110” is not present in the building 1660 and no IP address is stored in association with the identifier “0000000001100110” in the internal mapping table 1672. It is appreciated that such a configuration of the access control system 100ₚ allows for the readers 100ₚ₁ 100ₚ₂ 100ₚ₃ to continuously read the credential devices 130ₚ₁ 130ₚ₂ to obtain the identifiers of the credential devices 130ₚ₁ 130ₚ₂ the obtained identifiers can then be transmitted back from the readers 100ₚ₁ 100ₚ₂ 100ₚ₃ to the telephone system device 1632. It is further appreciated that such a transmission of the identifiers of the credential devices 130ₚ₁ 130ₚ₂ from the readers 100ₚ₁ 100ₚ₂ 100ₚ₃ to the telephone system device 1632 may include the IP address of the reader that obtained the identifiers of the credential devices, such that the telephone system device 1632 can store a real-time table of the location of the credential device identifiers and corresponding IP addresses of the readers and/or communication terminals.

Although the internal mapping tables 1671 and 1672 are illustrated as two separate tables, in other cases, the internal mapping table may be a single table. It is appreciated that the telephone system device 1632 may function as both an access control system (e.g., a controller) and as a telephone call management and routing system, where one or more database are shared between the access control system and the telephone call management and routing system. Although the telephone system device 1632 is illustrated as a single device in FIG. 16C, in other cases the telephone system device may be more than once hardware device. For example, in some cases, the telephone system device 1632 may be a telephone call management and routing system device and an access controller system device which are configured such that these devices share one or more databases.

FIG. 16F illustrates a process 1690 which may be executed by the telephone system device 1632. At step 1691, a call is processed by the telephone system device 1632 to determine the desired extension number. For example, if a call is originating from the terminal 1621₂ within the building 1660, the user 1621ₚ₂ may simply pick up her VoIP phone (i.e., terminal 1621₂) and enter in the extension number “x100”, this entered in extension number would then be communicated to the telephone system device 1632. Then at step 1692, the identifier of the user's credential device associated with the desired extension number is identified. For example, the internal mapping table 1671 can be used to look up the credential device identifier (e.g., card number or user id) associated with the extension number “x100”, which in this case is “0000000001100100”. Then at step 1693 it is determined if the credential device associated with the desired extension number is in range of a reader. If the credential device is not in range of a reader, then the call is then routed to voicemail at step 1694. If the credential device is in range of a reader, then at step 1695 the identifier of the reader or terminal that the credential device is nearest to is obtained. For example, the obtained credential device identifier “0000000001100100” can then be looked up in the mapping table 1672 which keeps track of the location of each of the credential devices to obtain the IP address of the nearest in range reader, which in this case is 192.168.1.100. By way of another example, if the user 1621ₚ₂ had dialed the extension number “x102” (which is associated with the credential device identifier “0000000001100110”), then the call would be routed to voice mail because as illustrated in FIG. 16E, for this credential device identifier, there is no IP address stored in the table 1672, which indicates that the credential device is not in range of a reader (e.g., it is not in the building). Then at step 1696 the call can be routed to the identifier terminal. For example, the telephone system device 1632 would then route the call to the IP address 192.168.1.100 which could then be received at the communication terminal 1621₁.

FIG. 16G illustrates an example of an access control system 100′_{P} which correspond to the access control system 100ₚ of FIG. 16G but where the users 1621′ₚ₁ 1621′ₚ₂ with respective credential devices 130′ₚ₁ 130′ₚ₂ are located in the office 1651₃. The use of the prime (′) is to indicate that users 1621ₚ₁ 1621ₚ₂ with respective credential devices 130ₚ₁ 130ₚ₂ illustrated in FIG. 16C in the respective offices 1651₁ 1651₂ and are currently located in the office 1651₃ which is illustrated by the users 1621′ₚ₁ 1621′ₚ₂ with respective credential devices 130′ₚ₁ 130′ₚ₂.

By way of another example, the user 1614 with the terminal 1613 has a desire to call users 1621′ₚ₁. As such, the user 1614 may enter in an identifier of the user 1621′ₚ₁ or an identifier associated with telephony equipment at the premise 1660 (e.g., the telephone system device 1633) into the terminal 1613. Some non-limiting examples of the identifier of the user 1621′ₚ₁ may include, but are not limited to, a telephone number, a user account, a proprietary identifier, a network address and the like. In other cases the identifier of the user 1621′ₚ₁ comprises a Session Initiation Protocol (SIP) Universal Resource Identifier (URI) address assigned on a per user basis or, in other words, all communication terminals 1621₁ 1621₂ 1621₃ are associated with the different identifier; however, in other cases, all communication terminals 1621₁ 1621₂ 1621₃ registered to the same subscriber or premise 1660 are associated with the same identifier.

The address or identifier entered in to the terminal 1613 by the user 1621′ₚ₁ may comprise an indication of a public network address associated with an endpoint where the communication terminals are located (such as, for example, the building or premise 1660). A sub-address may also be used which comprises an identifier that may be used to uniquely identify a particular communication terminal within its local data network should this be the case. For example, the sub-address may comprise an indication of a port number of the telephone system device within the local data network 1655 associated with a particular reader or communication terminal. In an alternative non-limiting embodiment, the sub-address may comprise another suitable identifier, such as, for example, a private IP address. In an alternative non-limiting embodiment, the sub-address may comprise a value which represents a value derived on the basis of the port number of telephone system device 1632. In yet further non-limiting embodiments of the present invention, the sub-address may comprise an arbitrary value assigned by the telephone system device 1632. In alternative embodiments, which are particularly applicable where the communication terminals 1621₁ 1621₂ 1621₃ and 1613 can be assigned a public network address, the sub-address may comprise a default value or may be omitted. In the specific non-limiting example being presented herein, the access device 1631 prompts the user 1614 to enter in an extension number, and as such a sub-address may not be required. In other cases, the sub-address may be used by the telephone system device to determine which reader, terminal or terminal via a reader to route the call to.

After the user 1614 enters in an identifier or address in to terminal 1613 for the purpose of calling the user 1621′ₚ₁, an incoming call is received at the telephone system device 1632. In the context of this example, the process 1690 as may be executed by the telephone system device 1632 will now be discussed. At step 1691 the desired extension number is obtained. As noted above, the user may be prompted to enter in an extension number or the extension number may be determined based on the provided sub-address. In other words at step 1691 an identifier is obtained which corresponds directly or indirectly to a desired communication terminal. Then at step 1692 the identifier of the user's credential device is obtained which is associated with the identifier that corresponds directly or indirectly to the communication terminal that is desired to be obtained by the user 1614. For example, either the extension number “x100” or port number 110₁ is used to look up the credential device identifier stored in the internal mapping table 1671. In the context of this example, the identifier “0000000001100100” would then be obtained at step 1692. FIG. 16H illustrates an internal mapping table 1673 which may be used to keep track of the locations in real-time of each of the credential devices 130′ₚ₁ 130′ₚ₂ by storing in a list the identifier of the credential device in association with the IP address of the nearest reader. Then at step 1693 it would be determined that credential device 130′ₚ₁ associated with the identifier “0000000001100100” is in range of a reader as there is an IP address associated with said identifier in the internal mapping table 1673. At step 1695 the IP address 192.168.1.102 is obtained from the table 1673, as it corresponds to the nearest terminal that the credential device 130′ₚ₁ is to. The call can then be routed by the telephone system device 1632 to the terminal 1621₃ via the reader 100ₚ₃.

At the step where the call is routed to the identified terminal, if the terminal routed to is not the terminal that is the primary terminal of the user, additional security measures may take place at the reader or the terminal. For example, as the credential device identifier “0000000001100100” in table 1671 is associated with the IP address 192.168.1.100 (which corresponds to the primary IP address for user 1621′ₚ₁, based on the credential device) and the credential device identifier “0000000001100100” in table 1673 is associated with the IP address 192.168.1.102 (which corresponds to the current real-time location of the user 1621′ₚ₁, based on the location of the credential device), the telephone system device 1632 may then determine that the user 1621′ₚ₁ for which the incoming call is for is not nearest to his primary terminal (i.e., the user is not in his office 1651) and that additional security measure should take place at the reader 110ₚ₃ or the terminal 1621₃. For example, prior to the call being routed to the terminal 1621₃ (via the reader 100ₚ₃) a display on the terminal 1621₃ or the reader 100ₚ₃ may indicate that the call is destine for the user 1621′ₚ₁. For instance, the display may list the extension number of the user 1621′ₚ₁ (“x100”), the name of the user (John Adams) or any other suitable identifier to indicate to the users 1621′ₚ₁ 1621′ₚ₂ that the call is destine for the user 1621′ₚ₁. The user 1621′ₚ₁ may then authenticate himself to the terminal 1621₃ or the reader 100ₚ₃ by entering in an authorization code (e.g., an alpha-numeric code on a keypad located on the terminal 1621₃ or the reader 100ₚ₃). The authorization code may then be transmitted to the telephone system device 162 which may lookup the authorization code in a table such as the table 1671 (although not illustrated as such) or another table stored in a database in the computer readable memory of the telephone system device 1632 and compare the authorization code stored in the table and the authorization code received via the terminal 1621₃ or the reader 100ₚ₃ to make an access control decision (e.g., if the user is authorized to take the call route the call through to the terminal 1621₃, otherwise terminate the call to the terminal 1621₃ and optionally route the call to voice mail). In other cases, the access decision may be made at the reader 100ₚ₃ or the terminal 1621₃. For example, telephone system device 1632 may have transmitted the authorization code to either the reader 100ₚ₃ or the terminal 1621₃ which can then make a comparison with the access code entered in my the user 1621′ₚ₁.

In other embodiments, instead of the user entering in an authorization code to implement the additional security measures, the terminal 1621₃ or the reader 100ₚ₃ may determine based on RSSI signal strength the distance of the credential device 130′ₚ₁ to the terminal 1621₃ or the reader 100ₚ₃. For example, prior to the call being routed to the terminal 1621₃ (via the reader 100ₚ₃) a display on the terminal 1621₃ or the reader 100ₚ₃ may indicate that the call is destine for the user 1621′ₚ₁. For instance, the display may list the extension number of the user 1621′ₚ₁ (“x100”), the name of the user (John Adams) or any other suitable identifier to indicate to the users 1621′ₚ₁ 1621′ₚ₂ that the call is destine for the user 1621′ₚ₁. The user 1621′ₚ₁ may then authenticate himself to the terminal 1621₃ or the reader 100ₚ₃ by being with his credential device 130′ₚ₁ within a specific range of the terminal 1621₃ or the reader 100ₚ₃. For example, if the credential device 130′ₚ₁ is within a specific distance (e.g., 1 foot, 6 inches or any other suitable distance) from the terminal 1621₃ or the reader 100ₚ₃ then the call can be routed to the terminal 1621₃; however, if the call is attempted to be answered and the credential device 130′ₚ₁ is not within the specific distance, the call is not able to be received at the terminal 1621₃, is terminated and/or routed to voice mail. It is appreciated that in this case the reader 100ₚ₃ may read the credential device 130′ₚ₁ to obtain the identifier of the credential device 130′ₚ₁ and the identifier may then be transmitted to the telephone system device 1632 which may make the access control decision. In other cases, the access decision may be made at the reader 100ₚ₃ or the terminal 1621₃. For example, telephone system device 1632 may have transmitted the identifier of the credential device 130′ₚ₁ to either the reader 100ₚ₃ or the terminal 1621₃ which can then make a comparison with the obtained identifier of the credential device 130′ₚ₁.

In other embodiments, the additional security measures may take place in the form of the user shaking the credential device in a specific motion. For example, prior to the call being routed to the terminal 1621₃ (via the reader 100ₚ₃) a display on the terminal 1621₃ or the reader 100ₚ₃ may indicate that the call is destine for the user 1621′ₚ₁. For instance, the display may list the extension number of the user 1621′ₚ₁ (“x100”), the name of the user (John Adams) or any other suitable identifier to indicate to the users 1621′ₚ₁ 1621′ₚ₂ that the call is destine for the user 1621′ₚ₁. The user 1621′ₚ₁ may then authenticate himself to the terminal 1621₃ or the reader 100ₚ₃ by shaking his credential device 130′ₚ₁ in a specific pattern or motion. If the credential device 130′ₚ₁ is not shaken in the specific pattern or motion, the call cannot be answered at the terminal 1621₃ and may then be terminated and/or routed to voice mail. Similar to the cases before, the access control decision may be made at either the terminal 1621₃, the reader 100ₚ₃ or the telephone system device 1632.

It is appreciated that such a configuration may also allow for the Caller Line ID (CLID) information associated with a calling party to be displayed on a CUD-enabled display on either the terminal 1621₃ or the reader 100ₚ₃, as such the user 1621′ₚ₁ may review the CUD-enabled display prior to taking the call and may optionally push a button on the terminal 1621₃ or the reader 100ₚ₃ to indicate that the user 1621′ₚ₁ does not desire to take the call and the call should be routed to voicemail.

It is further appreciated that such a configuration may also allow for the user 1621′ₚ₁ to enable a do not follow me mode when the call is routed through to the terminal 1621₃ so that future calls will not be routed through to terminal 1621₃ or to other terminals 1621₂ in the building 1660 other than the user's primary terminal 1621₁. For example, the user 1621′ₚ₁ may push a button on the terminal 1621₃ or the reader 100ₚ₃ to indicate that the user 1621′ₚ₁ does not desire to receive calls outside of the user's primary terminal 1621₁. This indication could then be transmitted back from the terminal 1621₃ to the telephone system device 1632 which may then store this indication in a table of a database, which could then be checked prior to routing any calls to the terminals.

By way of another example, the do not follow me (do not disturb me) functionally of the access controller system 100′ₚ will be discussed. In this example the user 1614 with the terminal 1613 has a desire to call users 1621′ₚ₂. As such, the user 1614 may enter in an identifier or address into the terminal 1613 for the purpose of calling the user 1621′ₚ₁. After the user 1614 enters in an identifier or address into the terminal 1613 for the purpose of calling the user 1621′ₚ₁, and incoming call is received at the telephone system device 1633 similar to the case above, the process 1690 may be executed by the telephone system device 1632 in a similar fashion to that discussed above. However, in this example, the call is not routed to the terminal 1621₃ at step 1696 as the user 1621′ₚ₂ would not like to receive any incoming calls, as the user 1621′ₚ₂ has the desire to not be disturbed, which in this example was indicated prior to the incoming call for the user. In this case, prior to entering the room 1651₃ the user 1621ₚ₂ when located in room 1651₂ may push a button on the user's primary terminal 1621₂ to indicate to the telephone system device 1633 that any incoming calls should not follow the user 1621ₚ₂ to other terminals (e.g., 1621₁ or 1621₃) within the building 1660. The telephone system device 1633 may then store in a table (such as table 1671, although not illustrated; or any other suitable table) in a database that the user 1621ₚ₂ desires to not be disturbed when away from her primary terminal 1621₂. In this example when an incoming call is received for the user 1621ₚ₂ it is determined in the process 1690 that the nearest terminal is 1621₃ with the IP address 192.168.1.103 and that the credential device identifier of the user 1621′ₚ₂ is “0000000001100101”. As the IP address 192.168.1.103 corresponding to the nearest terminal 1621₃ is not the IP address corresponding to the primary terminal (i.e., terminal 1621₁ with corresponding IP address 192.168.1.101) associated with the user as indicated in table 1671, it can then further be determined whether the user 1621′ₚ₂ is in a do not follow me mode by further checking a table in a database to see where the user 1621′ₚ₂ with the identifier “0000000001100101” desires for calls not to be followed to other terminals within the building 1660 and in this case as the user 1621′ₚ₂ is in a do not follow me mode the call is not routed to the terminal 1621₃.

It is appreciated that such a configuration may allow for the do not follow me to be automatically disabled when the user 1621′ₚ₂ returns back to her office 1651₂ and the user's credential device 130ₚ₂ is in range of the reader 100ₚ₂. The reader 100ₚ₂ could then transmit an indication back to the telephone system device 1632 once the credential device 130ₚ₁ becomes in range of reader 100ₚ₁ and the telephone system device 1632 could update the table in the database that the do not follow me function is to be disabled.

In other cases, the do not follow me may be setup as a function of date and time. For example, the user 1621ₚ₂ may enter information into the telephone system device 1633 via one of the terminals or another computing entity that is able to connect to the telephone system device 1633 the specific dates and/or times that user wishes for calls not to follow him/her. In other cases, the telephone system device 1633 may receive information automatically from a scheduling program (e.g., Outlook, etc.) when the user has meetings and wishes for calls not to follower the user to other locations in the building 1660 (e.g., a boardroom or meeting room).

By way of another example, outgoing CLID follow me functionally of the access controller system 100′ₚ will be discussed. In this example, user 1621′ₚ₁ has a desire to place an outgoing call to the terminal 1613 from the terminal 1621₃ which is not the primary terminal 1621₁ of the user 1621′ₚ₁ while having the user's CLID information show-up on the CLID-enabled display of the terminal 1613. For example, when user 1621′ₚ₁ enters in an identifier or address of the terminal 1613 to place an outgoing call the terminal 1621₃ and/or the reader 100ₚ₃ may recognize that the user 1621′ₚ₁ is not the primary user of the terminal 1621₃. More specifically, the reader 100ₚ₃ may determine that the credential device 130′ₚ₁ is the nearest credential device to the reader 100ₚ₃ and that the credential device 130′ₚ₁ is associated with the user 1621′ₚ₁ having the identifier “0000000001100100” and this identifier is not the primary credential device identifier associated with the terminal 1621₃. As such, the terminal 1621₃ may prompt the user 1621′ₚ₁ to confirm that the user 1621′ₚ₁ would like to have the user's CLID displayed on the outgoing call. The user 1621′ₚ₁ can then select whether to have his CLID displayed on the outgoing call or not. For example, a table such as the table 1671 (although not illustrated as such) or another table stored in a database in the computer readable memory of the telephone system device 1632 may store the CLID information which can be added to the call. In other cases, the CLID information may be stored on the credential device and obtained by the reader 100ₚ₃ such that it's available on the terminal 1621₃ and the user can select to have the user's CLID information used as part of the outgoing call. In further cases, the terminal 1621₃ may prompt the user 1621′ₚ₁ to confirm that the user 1621′ₚ₁ would like to have the CLID information associated with terminal 1621₃ removed or to have the CLID information to remain present for the outgoing call. It is appreciated that the term outgoing call used in the example may mean an outgoing call external to the local network 1655 (i.e., to a terminal that is connected to the external data network 1612) or to calls internal to the local data network 1655. In other cases, the access control system 100ₚ can be configured such that the outgoing CLID follow me function is automatic and the users are not required to push any buttons on the terminal for the CLID follow me function to work.

FIG. 16I illustrates an example of an access control system 100_{q} which is a variant of the access control system 100ₚ. The access control system 100_{q} functions in a similar manner as the access control system 100ₚ. In this embodiment the controller 120_{q} is connected to the telephone system device 1633. In this specific example, the telephone system device 1633 is responsible for routing the calls within the local data network 1655 and the controller 120_{q} is responsible for making control decisions and passing the control decisions to the telephone system device 1633. The person of skill in the art would understand that features described regarding the telephone system device 1632 may be implemented in either the telephone system device 1633 or controller 120_{q}.

The telephone system device 1633 is a variant of the telephone system device 1632. As illustrated, the telephone system device 1633 is connected to the access device 1631 and to the local network 1655 which connects two or more terminals 1621₁ 1621₂ 1621₃ to the telephone system device 1633. The connection of and the communication between the terminals 1621₁ 1621₂ 1621₃, the telephone system device 1633 and the access device 1631 is similar to that discussed in the embodiment of FIG. 16C and as such is not disused in detail here. In this example, the function of the telephone system device 1633 is to route incoming calls to the telephone system device 1633 to the terminals 1621₁ 1621₂ 1621₃, route outgoing calls from the terminals 1621₁ 1621₂ 1621₃ to terminals connected to the external data network 1612, and to route calls between different terminals 1621₁ 1621₂ 1621₃ within the local network 1655. The telephone system device 1633 is connected to the controller 120_{q} such that the telephone system device 1633 and the controller 120_{q} can transmit and receive data between each other. For example, the telephone system device 1633 may transmit data to the controller 120_{q} regarding the routing of calls, information regarding incoming calls, information regarding outgoing calls, or any other suitable information. Furthermore, the controller 120_{q} may transmit data to the telephone system device 1633 regarding the control of calls, the routing of calls or any other suitable information. The controller 120_{q} is connected to the readers 100_{q1} 100_{q2} 100_{q3} so that the readers 100_{q1} 100_{q2} 100_{q3} can read the credential devices 130_{q1} 130_{q2} to obtain the identifiers of the credential devices 130_{q1} 130_{q2} and transmit the identifier information back to the controller 120_{q}. It is appreciated that such a configuration may allow for the controller to have information which corresponds to the location of each of the credential devices and hence the location of each of the users 1621_{q1} 1621_{q2} such that controller 120_{q} can send control commands to the telephone system device 1633 so that calls can be routed to the users accordingly.

FIG. 16J illustrates an internal mapping table 1674 which may be stored in computer readable memory in a database, which may be located in the telephone system device 1633. The internal mapping table 1674 in addition to being used to correlate at least an original source address to a port number of one of the readers 100ₚ₁ 100ₚ₂ 100ₚ₃ to facilitate communication with one of the communication terminals 1621₁ 1621₂ 1621₃. The table 1674 is similar to the table of 1671; however, table 1674 does not include the identifiers of the credential devices associated with the users. It is appreciated that the internal mapping table 1674 is used by the telephone system device 1634 to facilitate or route two-way communications internally and externally to the local data network 1655.

FIG. 16K illustrates an internal mapping table 1675 which may be stored in computer readable memory in a database, which may be located in the controller 120_{q}. The table 1675 stores a mapping of the primary terminals associated with credential device identifiers by mapping terminal IP addresses and the respective identifiers of credential devices in a table.

FIG. 16L illustrates an internal mapping table 1676 which may be stored in computer readable memory in a database, which may be located in the controller 120_{q}. The table 1676 stores a mapping of real-time position of the credential devices to readers by mapping the readers' IP addresses and the respective identifiers of credential devices in a table.

FIG. 16M illustrates an internal mapping table 1677 which may be stored in computer readable memory in a database, which may be located in the controller 120_{q}. The table 1677 stores a mapping of terminal in the same locations as readers by mapping the terminals' IP addresses and the respective readers' IP addresses.

It is appreciated that the tables 1675, 1676 and 1677 may be combined to form one or more tables, in some embodiments. It is appreciated that tables 1675, 1676 and 1677 may be used by the controller 120_{q} to make access control decisions and the controller 120_{q} can then communicate instructions or commands based on the access control decisions to the telephone system device 1633 which can then route the calls according to the received instructions or commands. It is also appreciated that the telephone system device 1633 and the controller 120_{g} may be configured in a way such that one or more databases are shared between the controller 120_{g} and the telephone system device 1633. More specifically, telephone system device 1633 and the controller 120_{g} may be configured for sharing one or more databases for maintaining access control to the local network 1655.

By way of an example, the access control system 100_{q} will be discussed in further detail. In this example, a user 1614 has a desire to call user 1621_{q2} and enters in an identifier for the building 1660. The telephone system device 1633 answers the call and prompts the user to enter in an extension number. The prompt may include the user 1614 listening to a directory listing of all available users and their extension numbers. The user 1614 then enters in the extension number “x101”. The telephone system device 1633 then determines that for extension “x101” that the terminal IP address is 192.168.1.100. The telephone system device 1633 then prior to routing the call sends this information to controller 120_{q}. The controller 120_{q} can then obtain the credential device identifier corresponding to the IP address 192.168.1.100 by using the IP address to lookup the credential device identifier in table 1675, which in this case is “0000000001100101”. Then the controller 120_{q} can then use the credential device identifier “0000000001100101” to obtain the IP address of the nearest reader by using the identifier and looking up the IP address in table 1676, which in this case is 192.168.2.101. Then the controller can determine which terminal corresponds to the reader's IP address by using the reader IP address 192.168.2.101 to lookup the terminal IP address in table 1677, which in this case is 192.168.1.101. The controller can then send a command to the telephone system device 1633 that the call is to be routed in to the terminal with the IP address 192.168.1.101. As this IP address is the same as the IP address that the call was originally for the call is not rerouted. However, if the IP address obtained by was different the telephone system device 1633 could then re-route that call to the different terminal based on the obtained IP address.

In embodiment illustrated in FIG. 16I, the controller 120_{q} is positioned external to the local network 1655. However, in other embodiments the controller 120_{q} may be positioned between the telephone system device 1633 and the local network 1655 such that the controller 120_{q} is part of the local network 1655 and can intercept the data packets corresponding to calls for the terminals and re-route the data packets corresponding to calls to other terminals according to the access control decisions made, such that an incoming call for one terminal can be re-routed to a different terminal based on the location of the user for which the call is destine for.

Although in the examples above extension numbers where used to identify the terminals, other identifiers may be used such a direct phone number, an IP address, SIP URIs, etc.

### Machinery & Equipment Safety

The reader 110 may be incorporated into machinery and equipment for safety reasons. For example, reader 110 could be incorporated into freight elevators, conveyor systems, cutting, welding, robotics, fork lifts, cranes, etc. Machinery and equipment such as those listed above typically have systems that protect the operators against injury. These injury prevention systems may include safety beams such as photoelectric barriers, laser ranging sensors, etc. Such injury prevention system could be modified to potentially extend safety measure to prevent unauthorized personnel. For instance, the operator of machinery and equipment may be give a credential device 130, and the machinery and equipment may be inoperable unless the credential device 130 is in range of the reader 110 and the requirements of the other injury prevention systems are met. It is appreciated that such systems may only allow authorized credential device holders to start and operate these machines, which may prevent an inexperienced person casual use of the machine.

### High Value Item Access Control

One or more credential device 130 may be used to monitor movement of high value items. For example, the one or more credential device 130 may be programmed for long range communication with the one or more readers 110. In this example, the credential device 130 could be attached to a high value item such as art work, or any other suitable item, such that any movement of the high value item would signal to the reader 110 such movement. In this case, the credential device's inertial motion sensor 495 could report any movements or jitters to the data processor 430 of the credential device which can then transmit an indication of the movements to the reader 110 via the credential device's communication module 420. The reader 110 could then trigger and alarm, move a security camera to the area for further view, and/or alert the authorities.

### Anti-Shoplifting Systems

The credential device 130 may be used to monitor movement of items in a store for anti-shoplifting measures. For example, the one or more credential device 130 may be programmed for long range communication with the one or more readers 110. Items in the store could be fitted with credential devices 130 that can be detected by one or more readers 110 when the items are brought in the vicinity of the store exit areas.

As each credential device 130 can be programmed with a unique identifier, a system programming of a scanned UPC code may be stored in the memory 450 of the credential device 130.

The credential device's inertial motion sensor 495 may also be used to report any movements or jitters to the data processor 430 of the credential device which can then transmit an indication of the movements to the reader 110 via the credential device's communication module 420. The reader 110 could then move a security camera to the area for further view on a monitor by security personnel.

The movement of the items on the shelf or through the store could also be tracked and stored in a database, which could then be used at a later time for analysis for marketing purposes.

### Time and Attendance

The access control system 100 may be used to record the times employees arrive at work, what time employees arrive at their workstation, the number of hours a day an employee remains at his/her workstation. For example an employee with a credential device 130 when arrives at his/her place of work (e.g., the entry door) one or more readers 110 may take a reading of the employees credential device, again when the employee arrives at his/her desk or workspace, one or more readers 110 may take another reading. Then as the employee leaves his/her workspace throughout the day one or more readers 110 may track the movement. The one or more readers 110 may store this information in a database in memory 550 of a central controller 120 or this information may be sent to a computing entity 140. For instance, the computing entity that the information is sent to may be a payroll or human resources computer system.

It is appreciated that the use of one or more readers 110 throughout a facility may allow for management to ensure that employees that carry their credential devices 130 are in their particular work areas. Furthermore, this system may allow for payroll to begin paying employees not upon arrival at the entry area/door, but when the employees are actually at their workstation.

### Monitoring of Personal Billing and Business Related Resources

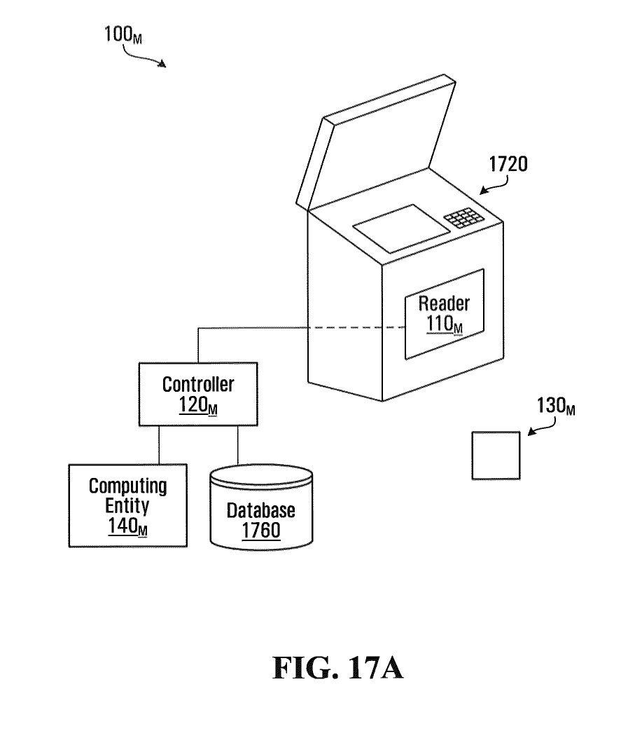

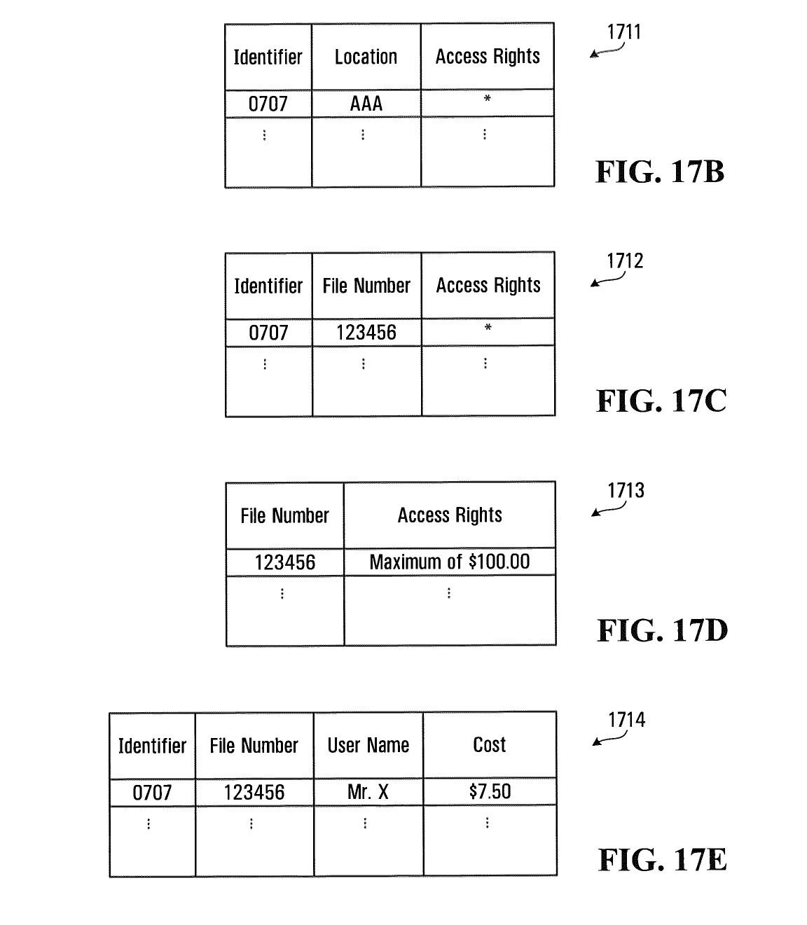

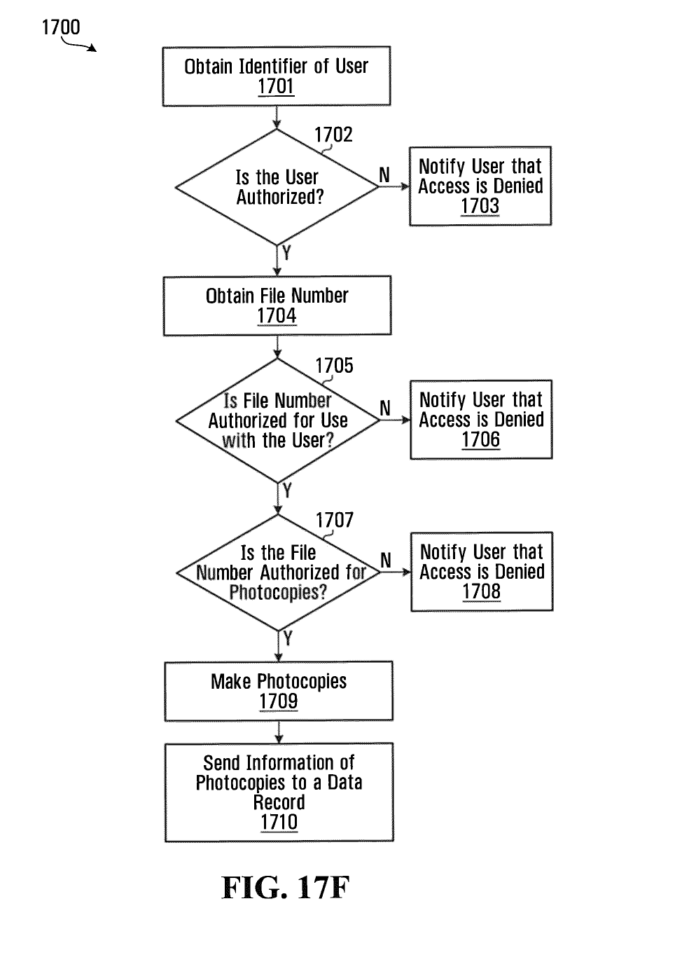

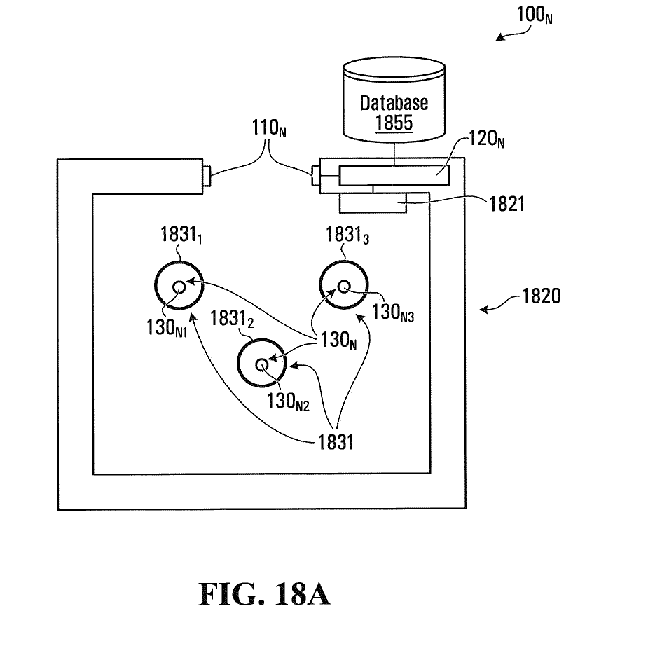

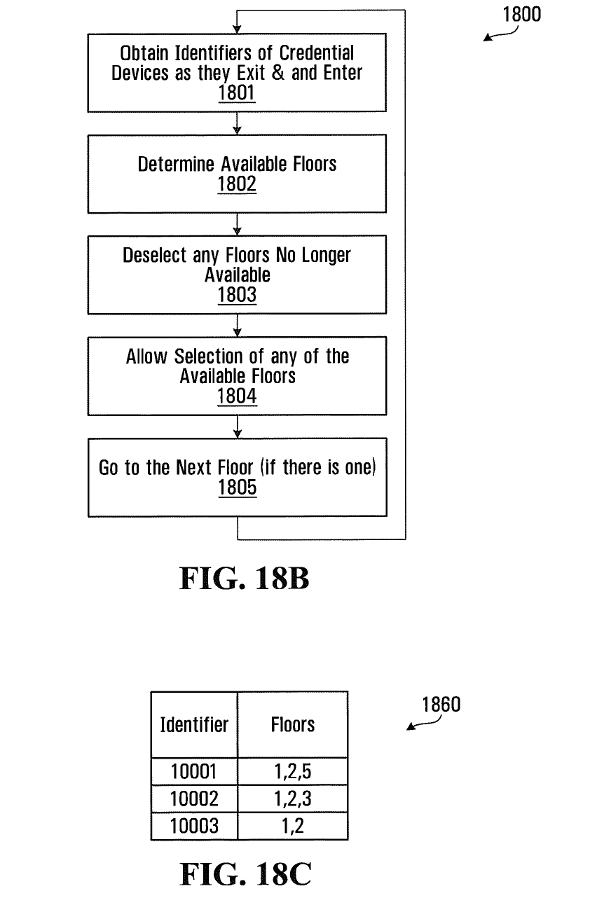

FIG. 17A illustrates an example of an access control system 100_{M} which may be used to monitor personal billing and/or business related resources. As illustrated, a photocopier 1720 which includes a postage meter (not illustrated) that may keep track of the number of photocopies done. The photocopier's postage meter is connected to the reader 110_{M} which is connected to a controller 120_{M} which may be connected to a computing entity 140_{M}. The access control system 100_{M} is a specific non-limiting implementation of the access control system 100. Similarly, the reader 110_{M}, the credential device 130_{M}, and the computing entity 140_{M} are a specific non-limiting implementation of the reader 110, the credential device 130 and the computing entity 140, respectively.

In this example a database 1760 is in the computer readable memory 550 of the controller 120_{M}. However, in other cases the database may be in computer readable memory at the reader 110_{M} or the computing entity 140_{M}. The database 1760 stores one or more tables. FIGS. 17B, 17C, 17D, and 17E are examples of respective tables 1711 1712 1713 1714 which may be stored in the database 1760.

### Example 1: User's Credential Device & Enter File Number

FIG. 17F illustrates an example method 1700 which may be executed by the access control system 100_{M}. At step 1701 the identifier of the user wishing to use the photocopier is obtained. By way of example, the user “Mr. X” wants to do some photocopying and has the credential device 130_{M} which has the identifier “0707”. Mr. X. may then approach the photocopier 1720 which is located at location “AAA” and Mr. X's credential device 130_{M} is then read by the reader 110_{M}. The reader 110_{M} and credential device 130_{M} may be programmed such that they only communicate with each other at a very short range (e.g., 1 to 2 feet). When Mr. X with the credential device 130_{M} approaches the reader 110_{M} the reader 110_{M} obtains the identifier from the credential device 130_{M} (step 1701). Then at step 1702 it is determines if the user (Mr. X) is authorized to use the photocopier (at location “AAA”), which may including checking a database table 1711 (as illustrated in FIG. 17B) to determine if the user associated with the identifier is able to use the photocopier 1720. As illustrated in FIG. 17B, as Mr. X's identifier “0707” has unlimited access to photocopier at the location “AAA”, as indicated by the “*” in the access rights column. On the other hand, if the user did not have access rights, then at step 1703 the user would be notified that access is denied, which may be done by a display on the photocopier 1720. Then at step 1704 the file number is obtained. In this example, the user (Mr. X) is prompted by a display on the photocopier 1720 to enter a file number (“123456”). Once the file number is obtained, then at step 1705 it is determined if the file number is authorized for use with the user. In this example, the database table 1712 (as illustrated in FIG. 17C) may be checked to determine if the file number (123456) is authorized to be worked on (i.e., photocopied) by the user (Mr. X). As illustrated in FIG. 17C the record in the table 1712 indicates that the identifier “0707” (which corresponds to Mr. X's credential device 130_{M}) has unlimited access to file “123456”, as indicated by the “*” in the access rights column. As such, the method 1700 proceeds to step 1707; however, if access would have been denied, then at step 1706, the user would be notified that access is denied (similar to step 1703). Then at step 1707 it is determined whether the file number is authorized for photocopies. In this example, the database table 1713 (as illustrated in FIG. 17D) may be checked to determine if the file number (123456) is authorized to for photocopies. As illustrated in FIG. 17D the file number “123456” is authorized for up to $100.00 in photocopies. As such, the method then proceeds to step 1709 and the user (Mr. X) is able to make photocopies. On the other hand, if the file was not authorized for photocopies, then at step 1708 the user would be notified that access is denied (similar to step 1703 and step 1706). At step 1709 the user can make photocopies in accordance with the access rights, which in this example is up to $100.00. Once the user is done making photocopies, the use may push a button or simply walk away from the photocopier 1720, which indicates that the user is done with the photocopier 1720. Then at step 1710 the information regarding the number of photocopies made and/or cost, the identifier of the credential device and the file number are then sent to be stored in a data record, such as illustrated in FIG. 17E. In this example, the postage meter of the photocopier 1720 may communicate the number of copies and/or the cost of the copies (e.g., $7.50) to the reader 110_{M} and reader 110_{M} communicates this information along with the identifier and file number to the controller 120_{M}, which may then store this information in the database 1760.

### Example 2: User's Credential Device Also Stores File Number

This second example functions identically to the first example. However, instead of the user (Mr. X) manually entering in a file number at step 1704, the credential device 110_{M} is also programmed to store the file number and when the reader 110_{M} obtains the identifier of the credential device 110_{M} it also obtains the file number.

### Example 3: Two Credential Devices—One for the User and One for the File Number

This third example functions identically to the first example. However, instead of the user (Mr. X) manually entering in a file number at step 1704, a second credential device is provided which stores the file number. In this case, the reader 110_{M} obtains the file number from the second credential device. It is appreciated that the second credential device may be attached to a file and the user (Mr. X) can place the file in range of the reader to obtain the file number.

It is appreciated that in these examples that the photocopier 1720 and the controller 120ₘ may be configured in a way such that one or more databases are shared between the controller 120ₘ and the photocopier 1720. More specifically, the photocopier 1720 and the controller 120ₘ may be configured for sharing a database for maintaining access control to the photocopier and for maintaining records of photocopier usage.

### Filing Systems

The access control system 100 may be used for automatic filing which may incorporate one or more readers 110 in a file room, file cabinets, and file cabinet drawers. The credential device in the form of an active RFID UHF tags could be attached to each client file folder, and those authorized to retrieve such folders could be given a credential device 130 that when presented near the file storage room will grant access. After entry into the storage area, only the cabinets that the person authorized to gain access could be electronically unlatched. As files are removed or added from the individual drawers, the one or more readers 110 in each drawer monitor the presence or absence of all folders. If for example a clerk has removed one or more folders, the system could record the event.

### Elevator

FIG. 18A illustrates an example of an access control system 100_{N} in an elevator 1820 which includes a controller 120_{N} connected to a reader 110_{N} to be used with a plurality of credential device 130_{N}. The access control system 100_{N} is a specific non-limiting implementation of the access control system 100. Similarly, the controller 120_{N}, the reader 110_{N} and the credential devices 130_{N} are a specific non-limiting implementation of the controller 120, the reader 110 and the credential device 130, respectively.

In this example, the reader 110_{N} is configured to read the credential devices 130_{N} as people 1831 carrying the credential devices 130_{N} enter the elevator 1820. For instance, the reader 110_{N} may be connected or interfaces with the elevator optical sensors or optical barriers of the elevator 1820. The reader 110_{N} then communicates with a controller 120_{N} which is interfaced to the control panel 1821 (e.g., floor selector) of the elevator 1820 to enable and disable the selection of floors.

As illustrated in FIG. 18A, three people 1831₁ 1831₂ 1831₃ each have respective credential devices 130_{N1} 130_{N2} 130_{N3}, which have access rights to different floors in a building. FIG. 18C illustrates an access rights table 1800 which may be stored in the database 1855 which may be located in the controller 120_{N}. In this example, it is assumed that the credential devices 130_{N1} 130_{N2} 130_{N3} have respective identifiers “10001”, “10002” and “10003”. Then, according to the table 1860, the first person 1831₁ has access to floors “1”, “2” and “5”, the second person 1831₂ have access to floors “1”, “2” and “3” and the third person 1831₃ has access to floors “1” and “2”.

FIG. 18B illustrates an example method 1800 which may be executed by the access control system 100_{N}. At step 1801, as the people 1831 enter and exit the elevator 1820 the reader 110_{N} reads the credential devices 130_{N} and obtains the identifiers of said credential devices 130_{N}. In this example, it is assumed that the elevator 1820 is on the floor “1” to start and all three people 1831₁ 1831₂ 1831₃ enter the elevator 1820 at this floor. As such, in this example, at step 1801 the identifiers “10001”, “10002” and “10003” are obtained. Then at step 1802 the available floors are determined. In this example the table 1860 is accessed and the available floors are obtained which includes floors “1”, “2”, “3” and “5” (i.e., all available for the group of people 1831). At step 1803 any floors that are no longer available are deselected. In this example, as no one was previously in the elevator, there would be no floors selected on the elevator's control panel 1821 and as such no floors would need to be deselected. Then at step 1804 the people 1831 are allowed to select floors by pushing the respective floors button on the control panel 1821. In this example, person 1831₁ pushes floor “2”, person 1831₂ pushes floor “3” and person 1831₃ pushes floor “5”. At this step, if one of the people would have pushed the button for floor “4” the button would not be selected, as the floor was not in the list of floors available to the people 1831 in the elevator 1820 and as such this button is not active for engagement with the people 1831. At step 1805, the elevator goes to the next floor that was selected (if there is one). In this example as the elevator is on floor “1” it would then go to floor “2” next. Then, the method goes back to step 1801. At this step, the identifiers of credential devices 130_{N} of the people entering and exiting the elevator are obtained. In this example, person 1831₁ exits the elevator 1820 on floor “2” and the reader 110_{N} obtains the identifier “10001”. The controller 120_{N} would then be able to calculate this inventory of the credential device(s) and determine which credential device(s) are present and which are no longer present. In this case it is determined that the credential devices with identifiers “10002” and “10003” are present. Then at step 1803 it would be determined that floor “5” is no longer available to the current people in the elevator 1820 and that floor “5” should be deselected. As such, in this example the elevator will no longer travel to floor “5” (i.e., access is no longer granted to this floor). At this stage as the credential 130_{N1} which had access to floor “5” is no longer in the elevator 1820 and an alert to security could be made that one or more persons are still travelling in the elevator and this could indicate that one or more persons intends to exit on another floor which may not be permitted while access for other person(s) may have been authorized. Then the elevator 1820 would go to floor “3” and the person 1803₂ can then exit the elevator 1820. Now if the person 1803₂ was to get off at floor “3” then security can be notified, an alarm may be triggered and/or the event may be logged in a database, as the person 1803₂ does not have access rights to floor “3”.

In the example above the reader 110_{N} was positioned on the door to track the people 1831 entering and exiting the elevator 1820. In other cases, the reader 110_{N} could be positioned in the cab of the elevator 1820 and when the door of the elevator 1820 closes an inventory of the credential devices 130_{N} in the elevator 1820 could be done. This may ensure that the credential devices 130_{N} that pass the optical barrier of the elevator door are still in the elevator. It is appreciated that by connecting to the access control system 100_{N} to the barrier beam to sense that the elevator door interlock is now in a locked position, the reader 110_{N} can take an inventory of the credential devices present including determine which credential(s) are present and which are no longer present and this information can then be used to control the elevator call buttons.

In the example above the reader 110_{N} and the controller 130_{N} are illustrated as two separate devices; however, in other embodiments the functionality of the reader 110_{N} and the controller 130_{N} discussed above may be implemented in a single device.

Integration with Camera

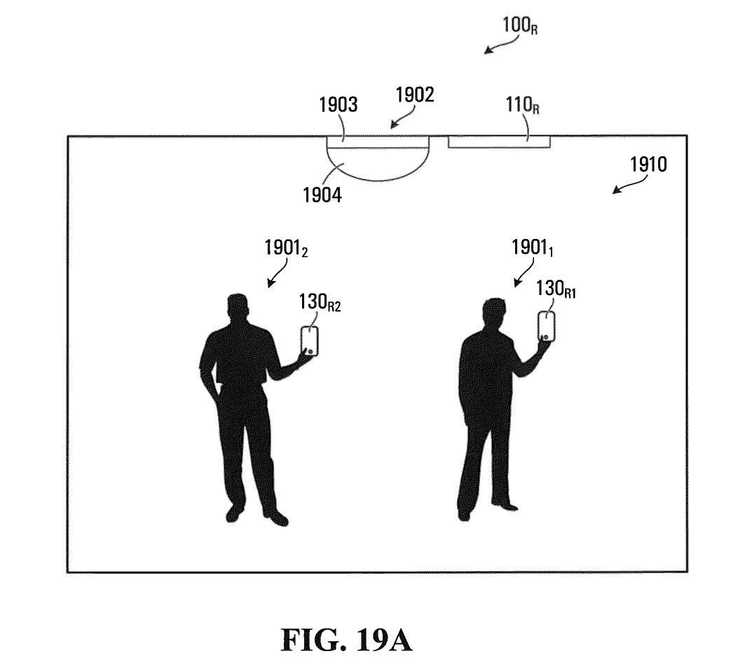

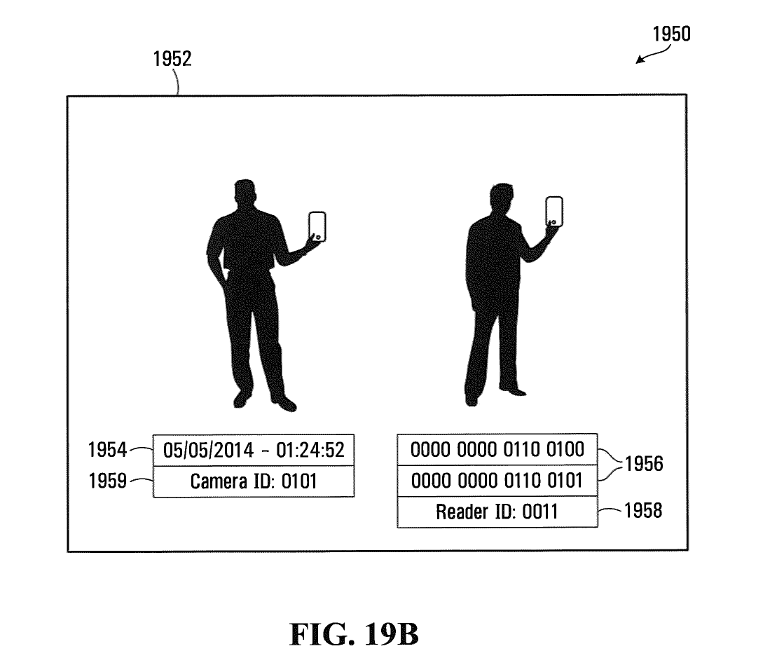

FIG. 19A illustrates an example of an access control system 100_{R} in an area 1910 which includes a camera 1902 connected to a reader 110_{R} to be used with a plurality of credential devices 130_{R}. The access control system 100_{R} is a specific non-limiting implementation of the access control system 100. Similarly, the reader 110_{N} and the credential devices 130_{N} are specific non-limiting implementation of the reader 110 and the credential device 130, respectively. Although not illustrated, the access control system 100_{R} may include the controller 120. In this example only a single reader 110_{R} and single camera 1902 is illustrated; however, it is appreciated that the control system 100_{R} may include a plurality of readers 110_{R} and cameras 1902.

In this example, the reader 110_{R} is configured to detect and read the credential devices 130_{R1} 130_{R2} as people 1901₁ 1901₂ carrying respective credential devices 130_{R1} 130_{R2} are present in the area 1910. The reader 110_{R} is connected and/or is configured to interface with the camera 1902. For example, there may be a duplex communication path between the reader 110_{N} and the camera 1902 so that data may be exchanged between the two devices. It is appreciated that such a configuration may allow for credential recognition, as well as, direction based upon the wake up pattern, as well as, video images.

In specific non-limiting examples of implementation, the camera 1902 is an immersive video camera with 360 degree range of vision such as those provided by ImmerVision. The camera 1902 includes a camera module 1903 and a lens 1904. In general, the lens 1904 captures images and then provides them in a digital form to the camera module 1903 such that the captured images are storable as electronic image data. Typically, the camera module 1903 is connected to a camera system (not illustrated) such as a server which can store the image data and can be accessed by a user via a computing entity (e.g., computer, mobile phone, tablet, etc.).

The reader 110_{R} is configured such that upon reading one or more of the credential devices 130_{R1} 130_{R2}, the reader 110_{R} is able to communicate an output of the credential device's information (e.g., identifier of the credential device) which may then be written or embedded into the image data corresponding to the camera 1902 in proximity to the reader 110_{R} at that time instance. FIG. 19B illustrates an example image 1950 of electronic image data 1952. As shown, the image data 1952 includes various data fields, such as: a time field 1954 for storing the time that the image was captured; a camera identifier field 1959 (and/or a field that indicates the location of the camera 1902) for storing an identifier and/or location of the camera 1902; a credential identifier field 1956 for storing one or more identifiers of the credential devices 130_{R1} 130_{R2} within proximity to the camera 1902 and as determined by being read by the reader 110_{R}; and a reader identifier field 1956 (and/or a field that indicates the location of the reader 110_{R}) for storing an identifier and/or location of the reader 110_{R}. In the example where the ImmerVision video technology is used, the various data written to the image data 1952 may include writing the identifier of the credential device 130_{R1} 130_{R2} to the OR codes of every video frame in the video system.

As shown in FIG. 19C, a method 1960 may be performed by the access control system 100_{R}. At step 1962, reader 110_{R} obtains the identifiers from the credential devices 130_{R1} 130_{R2} present in the field of range of the reader 110_{R}. The reader 110_{R} then transmits the identifiers (0000000001100100 and 0000000001100101) corresponding to the credential devices 130_{R1} 130_{R2}. The reader 110_{R} in this example also transmits its identifier (0011). The camera module 1903 receives the identifiers of the credential devices 130_{R1} 130_{R2} and the identifier of the reader 110_{R}. At step 1964, the camera module 1903 writes the identifiers of the credential devices 130_{R1} 130_{R2} and the identifier of the reader 110_{R} into the fields of the image data 1952 associated with the time instance that the image data 1952 was captured and the credential devices 130_{R1} 130_{R2} were read by the reader 110_{R}. It is appreciated that such a configuration may allow for the identifiers of the credential devices 130_{R1} 130_{R2} in range of the reader 110_{R} and the camera 1902 to be written to each frame of the image data 1952 captured by the camera 1902.

Other than the reader 110_{R} sending credential information to the camera module 1902, the camera module 1902 could communicate information to the reader 110_{R} such as motion and direction of persons or objects that are not outfitted with a credential device 130_{R}. The information may then be used to create alarm notification messages to the security control room or monitoring station. For example, as shown in FIG. 19E, access control system 100_{R} may perform the method 1980. At step 1982, the camera module 1902 may process the image data 1952 to determine if a person is present. If the camera module 1902 determines that a person is present, then the camera module 1903 may transmit a signal to the reader 110_{R} to indicate the presence of a person or that a wake-up signal should be transmitted to determine if the person present is carrying a credential device 130_{R}. Then at step 1974, the reader 110_{R} may transmit a wake-up signal and/or attempt to read any credential devices 130_{R1} 130_{R2} in proximity to the reader 110_{R}. If, no credential devices 130_{R} are in proximity to the reader 110_{R}, then the access control system 100_{R} may trigger an alert or an alarm. If the reader 110_{R} does obtain an identifier from one or more credential devices 130_{R}, then the access control system 100_{R} may accordingly grant or deny access or track the movement of the one or more credential devices 130_{R}. It is appreciated that such a configuration may allow for the reader 110_{R} to only transmit a wake-up signal after the camera module 1903 detects that there is motion present within range of the camera 1902 and/or reader 110_{R}.

This embodiment may be combined with the other embodiments presented throughout this document. For example, a patient with a credential device 130_{R} could be tracked by the access control system 100_{R}. In particular, the credential device 130_{R} of the patient may be read by each of the plurality of readers 110_{R} is a building as the patient moves throughout the building. Each of the plurality of cameras 1902 in the building is associated with at least one reader 110_{R} such that the current and historical location information of the patient is stored in association with video image data based on the identifier of the patient's credential device 130_{R}. An operator of the access control system 100_{R} may be able to query the access control system 100_{R} to search all travels of a specific patient based on the credential history and/or current location. As shown in FIG. 19D, a method 1970 may be performed by the access control system 100_{R}. At step 1972, the access control system 100_{R} receives a request for image and/or location information associated with a credential device 130_{R} and/or identifier. For example, an operator may query the system based on a patient's name or identifier which has a corresponding credential identifier. The query may include a time range of interest, such as the current time or a historic range of time. The access control system 100_{R} processes the image data 1952 corresponding to the time range specified by comparing the identifier to the image data records for the time range. At step 1974, the access control system 100_{R} then provides the image data 1952 that correspond to the identifier for the time range specified. This may include the image data 1952 being displayed on a screen on the computing entity of the operator. Therefore, it may be possible for a search for the credential device 130_{R} from the recorded image data 1952 which may immediately produce all historical video of activities related to the credential device 130_{R}. Security may then be able to ascertain the last known location as well as review all video.

The area 1910 may include a room, corridor, hallway, office, elevator, entry/exit point, storage room, file storage, parking garage, construction site entry/exit point, or any other suitable location. In particular, the reader 110_{R} and/or camera 1902 may be installed on the ceiling, wall, or any other suitable surface of the area 1910. In some embodiments, the camera 1902 may be installed on a vehicle.

The reader 110_{R} and camera 1902 may in some embodiment be integrated in one small unobtrusive dome housing. In other embodiments, the reader 110_{R} may be interconnected by existing networks to a camera system in which the camera 1902 is interfaced and connected thereto.

It is appreciated that access control system 100_{R} with video surveillance may be of benefit to security and management as well as providing a higher level of safety for employees, and visitors of monitored areas.

### Mesh Network of Readers

The access control system 100 in some embodiments may be configures such that the readers 110 become part of a mesh network that could be installed throughout a facility, residence, or other location. In these embodiments, each reader 110 could have a communication path to the other readers in radio range. In this topology, only one or perhaps a few readers could be directly connected (e.g., via Wi-Fi or wired paths) with a network (which may include the network on which the controller 120 and/or computing entity 140, in the form of a server computer, is connected to) and the other readers could intercommunicate and pass on information such as access control, alarm status, sensor status through the mesh network until the information arrives on the Wi-Fi or wired network. By using a mesh network, for example, based on spread spectrum proprietary communication in a desirable band in which communication through common construction materials and other obstacles may be overcome, the mesh network of readers may allow for greater range than an ordinary Wi-Fi network or readers.

Certain additional elements that may be needed for operation of some embodiments have not been described or illustrated as they are assumed to be within the purview of those of ordinary skill in the art. Moreover, certain embodiments may be free of, may lack and/or may function without any element that is not specifically disclosed herein.

Any feature of any embodiment discussed herein may be combined with any feature of any other embodiment discussed herein in some examples of implementation.

Although various embodiments and examples have been presented, this was for the purpose of describing, but not limiting, the invention. Various modifications and enhancements will become apparent to those of ordinary skill in the art and are within the scope of the invention, which is defined by the appended claim(s).

1. A retrofit access control device for interfacing with a legacy access control system having a legacy access control device that controls access to at least one access point, the legacy access control device being configured to interface with a legacy credentials device according to a first protocol to obtain from the legacy credentials device credentials information, the retrofit access control system comprising:
a. a reader configured for interfacing according to a second protocol with a retrofit credentials device to obtain from the retrofit credentials device credentials information, the first protocol being such that a legacy access control device cannot interface with the retrofit credentials device to obtain credentials information, the second protocol being such that the reader cannot interface with the legacy credentials device to obtain credentials information from the legacy credentials device;
b. a processor for processing the credentials information obtained from the retrofit credentials device to generate an access signal compatible with the legacy access control system.

2. The retrofit access control device as defined in claim 1, wherein the legacy access control device includes a legacy reader communicating with a legacy controller, the processor being configured to communicate with the legacy controller, the access signal being configured such that it can be processed by the legacy controller.

3. The retrofit access control device as defined in claim 1, wherein the legacy access control device includes a legacy reader, the processor being configured to communicate with the legacy reader, the access signal being configured such that it can be processed by the legacy reader.

4. The retrofit access control device as defined in claim 1, wherein processing the credentials information obtained from the retrofit credentials device includes determining if the retrofit credentials device is authorized to obtain access to the access point.

5. The retrofit access control device as defined in claim 4, wherein the retrofit access control device further comprises a database storing a list of authorized identifiers and wherein determining if the retrofit credentials device is authorized to obtain access to the access point includes comparing the identifier to the list of authorized identifiers.

6. The retrofit access control device as defined in claim 5, wherein the retrofit credentials device is authorized to obtain access to the access point when the identifier is contained in the list of authorized identifiers.

7. The retrofit access control device as defined in claim 3, wherein the retrofit credentials device is unable to obtain access to the access point when the identifier is not contained in the list of authorized identifiers.

8. The retrofit access control device as defined in claim 3, wherein the processor is configured to wirelessly communicate with the legacy reader.

9. The retrofit access control device as defined in claim 8, wherein the access signal emulates a signal of a legacy credentials device configured to communicate with the legacy reader.

10. The retrofit access control device as defined in claim 2, wherein the processor is configured for wired communicate with the legacy controller.

11. The retrofit access control device as defined in claim 10, wherein the access signal emulates a signal of the legacy reader configured to communicate with the legacy controller.

12. The retrofit access control device as defined in claim 10, wherein the access signal is configured to be transmitted in Wiegand or RS-485 format.

13. The retrofit access control device as defined in claim 1, wherein the retrofit credentials device is unreadable by legacy access control device.

14. (canceled)

15. (canceled)

16. (canceled)

17. (canceled)

18. (canceled)

19. (canceled)

20. (canceled)

21. (canceled)

22. The retrofit access control device as defined in claim 1, wherein the retrofit access control device is configured to provide a camera module with the credentials information, wherein the camera module is configured to write at least some of the credentials information in frames of image data captured by the camera module.

23. (canceled)

24. (canceled)

25. (canceled)

26. (canceled)

27. The retrofit access control device as defined in claim 2, wherein the legacy controller is configured for processing the access signal to make an access control decision to grant or deny access to the access point.

28. The retrofit access control device as defined in claim 2, wherein the legacy access control system includes a computing entity for interfacing with the legacy controller, wherein the computing entity is configured for making an access control decision to grant or deny access to the access point.

29. (canceled)

30. A method for interfacing with a legacy access control system, the legacy access control system having a legacy access control device that controls access to at least one access point, the legacy access control device being configured to communicate with a legacy credentials device according to a first protocol to obtain from the legacy credentials device credentials information, the method comprising:
a. communicating according to a second protocol with a retrofit credentials device to obtain from the retrofit credentials device credentials information, the first protocol being such that a legacy access control device cannot communicate with the retrofit credentials device to obtain credentials information, the second protocol being such that the reader cannot communicate with the legacy credentials device to obtain credentials information from the legacy credentials device;
b. processing the credentials information obtained from the retrofit credentials device to generate an access signal compatible with the legacy access control system.

31. The method of claim 30, wherein the legacy access control device includes a legacy reader communicating with a legacy controller and the method further comprises communicating the access signal to the legacy reader.

32. The method of claim 30, wherein the legacy access control device includes a legacy controller and the method further comprises communicating the access signal to the legacy controller.

33. A method for retrofitting a legacy access control system with a new access control device, the legacy access control system having a legacy access control device that controls access to at least one access point, the legacy access control device being configured to interface with a legacy credentials device according to a first protocol to obtain from the legacy credentials device credentials information, the new access control device including a reader configured for interfacing according to a second protocol with a new credentials device to obtain from the new credentials device credentials information, the first protocol being such that a legacy access control device cannot interface with the new credentials device to obtain credentials information, the second protocol being such that the reader of the new access control device cannot interface with the legacy credentials device to obtain credentials information from the legacy credentials device, the new access control device further including a processor for processing credentials information obtained from the new credentials device, the processor having an output, the method comprising:
a. connecting the output of the processor to an input of the legacy access control device, the input configured to accept an input signal derived from an interaction between the legacy access control device and the legacy credentials device, the input signal conveying credentials information derived from the legacy credentials device;
b. in response to an interaction between the new access control device and the new credentials device according to the second protocol, outputting a signal which conveys credentials information derived from the new credentials device, the signal being configured such that it can be accepted by the input.

34. (canceled)

35. (canceled)

36. (canceled)

37. (canceled)

38. (canceled)
